(19) United States
(12) Patent Application Publication
(10) Pub. No.: US 2021/0022343 A1
(43) Pub. Date: Jan. 28, 2021

(54) FUNGICIDAL COMBINATIONS

(71) Applicant: UPL LTD, Haldia (IN)

(72) Inventors: Vicente Amadeu Gongora, Ituverava (BR); Carlos Eduardo Fabri, Ituverava (BR); Carlos Alberto de Paiva Pellicer, Ituverava (BR); Jaidev Rajnikant Shroff, Dubai (AE); Vikram Rajnikant Shroff, Dubai (AE)

(21) Appl. No.: 17/040,871

(22) PCT Filed: Mar. 25, 2019
(86) PCT No.: PCT/IB2019/052393

§ 371 Date: Sep. 23, 2020

(30) Foreign Application Priority Data
Mar. 26, 2018 (IN) 201831011127

(51) Int. Cl. A01N 43/653; A01N 43/54; A01N 43/40; A01N 37/34; A01N 37/44

(52) U.S. Cl. CPC A01N 43/653; A01N 43/54; A01N 37/44; A01N 37/34; A01N 43/40

(57) ABSTRACT

Disclosed herein is a fungicidal combination comprising at least one azole fungicide; at least one multisite contact fungicide; and at least a third systemic fungicide.

### TECHNICAL FIELD

The present invention relates to a combination of fungicides. More specifically, the present invention relates to fungicidal combinations comprising an azole fungicide for controlling a broad spectrum of fungal diseases.

### BACKGROUND OF THE INVENTION

Fungicides are an integral and important tool yielded by farmers to control diseases, as well as to improve yields and quality of the crops. There are various fungicides that have been developed over the years with many desirable attributes such as specificity, systemicity, curative and eradicant action and high activity at low use rates.

The azole fungicides are, by themselves, known for controlling fungal diseases and combating pests and weeds in the agricultural environment, and/or for preparing a fungicide useful in the treatment of seeds, foliar and/or soil diseases against attacks of pests in plants.

Fluconazole, an azole fungicide, has IUPAC name 2-(2,4-Difluorophenyl)-1,3-di(1H-1,2,4-triazol-1-yl)-2-propanol, and is represented by following structure:

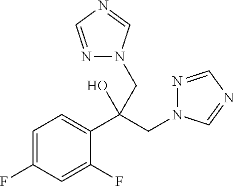 [SMILES: OC(Cn1cncn1)(Cn1cncn1)c1ccc(F)cc1F]

Fluconazole is used to prevent and treat variety of fungal and yeast infections in humans. It belongs to a class of pharmaceutical drugs called azole antifungals. It works by stopping the growth of certain types of fungus.

Fluconazole is a first-generation triazole antifungal medication. It differs from earlier azole antifungals (such as ketoconazole) in that its structure contains a triazole ring instead of an imidazole ring. While the imidazole antifungals are mainly used topically, fluconazole and certain other triazole antifungals are preferred when systemic treatment is required because of their improved safety and predictable absorption when administered orally.

Fluconazole's spectrum of activity includes most Candida species (but not Candida krusei or Candida glabrata), Cryptococcus neoformans, some dimorphic fungi, and dermatophytes, among others.

US 20080287299 teaches use of fluconazole and other imidazole and/or triazole derivatives for controlling fungus diseases and combating pests and weeds in the agricultural environment.

The use of fluconazole in agriculture is not yet properly explored. There is elaborate knowledge on the medical use of fluconazole in humans but knowledge about use of fluconazole for agrochemical use is very limited. There is still need in the art to check for different molecules having wide spectrum activity in combatting disease on plants.

The prior art does not teach the use of fluconazole with any other fungicides, herbicides and/or insecticides.

There is still the need to create more effective means in the area of agrochemical agents for combating pests on plants.

The embodiments of the present invention are elaborated further:

### One or More Advantages of the Present Invention

Therefore, embodiments of the present invention may provide combinations of fungicides that possess an enhanced efficacy over the individual fungicides used in isolation.

Another object of the present invention is to provide a fungicidal combination that causes an enhanced greening of the crops to which it is administered.

Another object of the present invention is to provide a fungicidal combination that causes late senescence to the crop to which it is applied thereby resulting into an increasing yield of the crop.

Yet another object of the present invention is to provide a fungicidal combination that results into reduced fungal disease incidence in the crops to which it is applied.

Another object of the present invention is to provide a fungicidal combination that results into a synergistic complementation of the fungicidal efficacy of the fungicides that are co-applied.

Another objective of the present invention is to provide methods of applying said azole fungicides in combination with other agrochemically active fungicides in the control of diseases/insects/mites/nematodes and weeds, particularly foliar and/or soil diseases.

Another object of the present invention is to provide a fungicidal combination that achieves increased yield in the crops to which it is applied.

Some or all these and other objects of the invention are can be achieved by way of the invention described hereinafter.

### DESCRIPTION OF DRAWINGS

FIG. 1: Images of Petridish showing the development of colony of ALTERNARIA SOLANI with fluconazole and its combinations as per example 1.

FIG. 2: Images of Petridish showing the development of colony of COLLETOTRICHUM CAPSICI with fluconazole and its combinations as per example 2.

FIG. 3: Images of Petridish showing the development of colony of RHIZOCTONIA SOLANI with fluconazole and its combinations as per example 3.

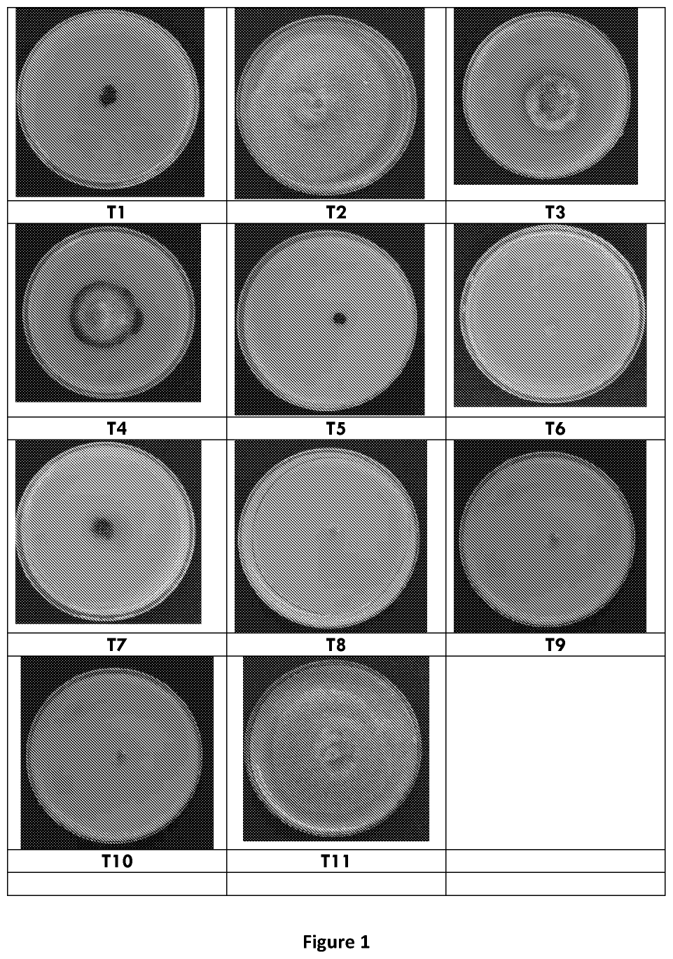

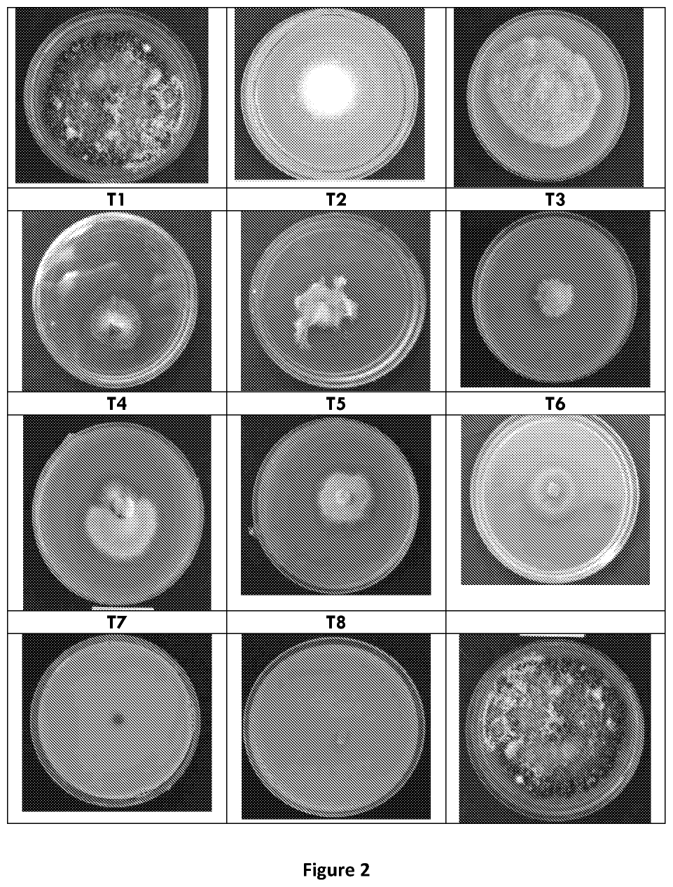

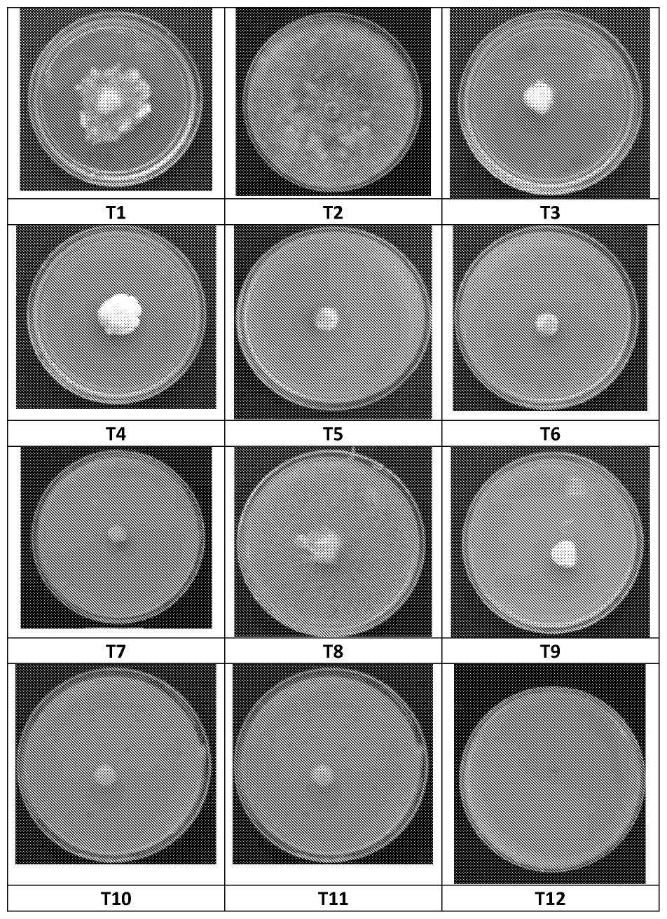

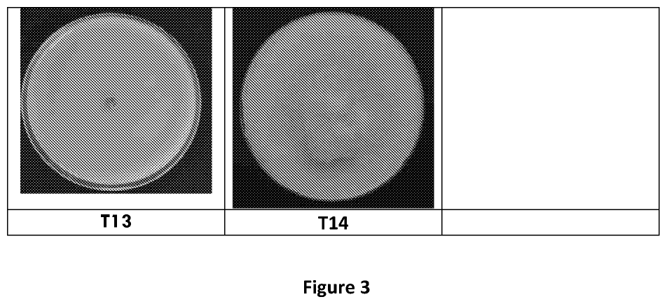

### SUMMARY OF THE INVENTION

Thus, an aspect of the present invention can provide a fungicidal combination comprising:
a) at least one azole fungicide, the azole fungicide being an imidazole fungicide or a triazole fungicide, wherein:
   said imidazole fungicide is selected from the group consisting of bifonazole, butoconazole, clotrimazole, econazole, fenticonazole, isoconazole, ketoconazole, luliconazole, miconazole, omoconazole, oxiconazole, sertaconazole, sulconazole and tioconazole;
   said triazole fungicide is selected from albaconazole, efinaconazole, epoxiconazole, fluconazole, isavuconazole, itraconazole, posaconazole, propiconazole, ravuconazole, terconazole, voriconazole, mefentrifluconazole and Ipfentrifluconazole;
b) at least one multisite contact fungicide; and
c) at least a third systemic fungicide.

Another aspect of the present invention can provide fungicidal compositions comprising:
a) at least one azole fungicide, the azole fungicide being an imidazole fungicide or a triazole fungicide, wherein:
   said imidazole fungicide is selected from the group consisting of bifonazole, butoconazole, clotrimazole, econazole, fenticonazole, isoconazole, ketoconazole, luliconazole, miconazole, omoconazole, oxiconazole, sertaconazole, sulconazole and tioconazole;
   said triazole fungicide is selected from albaconazole, efinaconazole, epoxiconazole, fluconazole, isavuconazole, itraconazole, posaconazole, propiconazole, ravuconazole, terconazole, voriconazole, mefentrifluconazole and Ipfentrifluconazole;
   and
b) at least one multisite contact fungicide; and
c) at least a third systemic fungicide.

A method of controlling fungi at a locus, said method comprising applying to the locus at which said fungal control is desired, a fungicidal combination comprising:
a) at least one azole fungicide, the azole fungicide being an imidazole fungicide or a triazole fungicide, wherein:
   said imidazole fungicide is selected from the group consisting of bifonazole, butoconazole, clotrimazole, econazole, fenticonazole, isoconazole, ketoconazole, luliconazole, miconazole, omoconazole, oxiconazole, sertaconazole, sulconazole and tioconazole;
   said triazole fungicide is selected from albaconazole, efinaconazole, epoxiconazole, fluconazole, isavuconazole, itraconazole, posaconazole, propiconazole, ravuconazole, terconazole, voriconazole, mefentrifluconazole and Ipfentrifluconazole;
   and
b) at least one multisite contact fungicide; and
c) at least a third systemic fungicide.

### DETAILED DESCRIPTION

The term ‘disease control’ as used herein denotes control and prevention of a disease. Controlling effects include all deviation from natural development, for example: killing, retardation, decrease of the fugal disease. The term ‘plants’ refers to all physical parts of a plant, including seeds, seedlings, saplings, roots, tubers, stems, stalks, foliage and fruits. The term “locus” of a plant as used herein is intended to embrace the place on which the plants are growing, where the plant propagation materials of the plants are sown or where the plant propagation materials of the plants will be placed into the soil. The term “plant propagation material” is understood to denote generative parts of a plant, such as seeds, vegetative material such as cuttings or tubers, roots, fruits, tubers, bulbs, rhizomes and parts of plants, germinated plants and young plants which are to be transplanted after germination or after emergence from the soil. These young plants may be protected before transplantation by a total or partial treatment by immersion. The term “agriculturally acceptable amount of active” refers to an amount of an active that kills or inhibits the plant disease for which control is desired, in an amount not significantly toxic to the plant being treated.

There is limited information on agricultural use of azole fungicides, particularly when used in combination with other agrochemically active fungicides. It has surprisingly been found that the addition of a multisite contact fungicide and at least a third systemic fungicide to an azole fungicide resulted in surprising and unexpected advantages. It was surprising that the addition of a multisite contact fungicide and at least a third systemic fungicide to an azole fungicide resulted in an enhancement of the efficacy, and a surprising reduction in fungal disease incidence. It has further been found that the addition of a multisite contact fungicide and at least a third systemic fungicide to an azole fungicide and application of these combinations during the flowering stage of the crop delayed the senescence in the crop to which they were applied, which led to better greening in the crop thereby increasing the level of photosynthesis occurring within the plant, thereby leading to a greater yield from the crop to which they were applied.

Thus, an aspect of the present invention can provide a fungicidal combination comprising:
a) at least one azole fungicide, the azole fungicide being an imidazole fungicide or a triazole fungicide, wherein:
   said imidazole fungicide is selected from the group consisting of bifonazole, butoconazole, clotrimazole, econazole, fenticonazole, isoconazole, ketoconazole, luliconazole, miconazole, omoconazole, oxiconazole, sertaconazole, sulconazole and tioconazole;
   said triazole fungicide is selected from albaconazole, efinaconazole, epoxiconazole, fluconazole, isavuconazole, itraconazole, posaconazole, propiconazole, ravuconazole, terconazole, voriconazole, mefentrifluconazole and Ipfentrifluconazole;
b) at least one multisite contact fungicide; and
c) at least a third systemic fungicide.

In an embodiment, the multi-site fungicide is selected from the group consisting of dithiocarbamates, phthalimides, chloronitriles, inorganic fungicides, sulfamides, bis-guanidines, triazines, quinones, quinoxalines, dicoarboxamides and mixtures thereof.

In an embodiment, the multi-site fungicide is selected from the class of dithiocarbamate fungicides selected from asamobam, asomate, azithiram, carbamorph, cufraneb, cuprobam, disulfiram, ferbam, metam, nabam, tecoram, thiram, urbacide, ziram, dazomet, etem, milneb, mancopper, mancozeb, maneb, metiram, polycarbamate, propineb and zineb.

In an embodiment, the multi-site fungicide is a phthalimide fungicide selected from captan, captafol and folpet.

In an embodiment, the multi-site fungicide is a chloronitrile fungicide such as chlorothalonil.

In an embodiment, the multi-site fungicide is a sulfamide fungicide selected from dichlofluanid and tolylfluanid.

In an embodiment, the multi-site fungicide is a bis-guanidine fungicide selected from guazatine and iminoctadine.

In an embodiment, the multi-site fungicide is a triazine fungicide selected from anilazine.

In an embodiment, the multi-site fungicide is a quinone fungicide selected from dithianon.

In an embodiment, the multi-site fungicide is a quinoxaline fungicide selected from quinomethionate and chlorquinox.

In an embodiment, the multi-site fungicide is a dicarboxamide fungicide selected from fluoroimide.

In an embodiment, the multi-site fungicide is an inorganic fungicide selected from copper fungicides including copper (II) hydroxide, copper oxychloride, copper (II) sulfate, basic copper sulfate, Bordeaux mixture, copper salicylate C₇H₄0₃.Cu, cuprous oxide CU₂O; or sulphur.

Thus, an aspect of the present invention can provide a fungicidal combination comprising:
a) at least one azole fungicide, the azole fungicide being an imidazole fungicide or a triazole fungicide, wherein:
   said imidazole fungicide is selected from the group consisting of bifonazole, butoconazole, clotrimazole, econazole, fenticonazole, isoconazole, ketoconazole, luliconazole, miconazole, omoconazole, oxiconazole, sertaconazole, sulconazole and tioconazole;
   said triazole fungicide is selected from albaconazole, efinaconazole, epoxiconazole, fluconazole, isavuconazole, itraconazole, posaconazole, propiconazole, ravuconazole, terconazole, voriconazole, mefentrifluconazole and Ipfentrifluconazole;
b) at least one multisite contact fungicide, said multi-site fungicide being selected from the group consisting of dithiocarbamates, phthalimides, chloronitriles, inorganic fungicides, sulfamides, bis-guanidines, triazines, quinones, quinoxalines, dicoarboxamides and mixtures, wherein:
   the dithiocarbamate fungicide is selected from the group consisting of asamobam, asomate, azithiram, carbamorph, cufraneb, cuprobam, disulfiram, ferbam, metam, nabam, tecoram, thiram, urbacide, ziram, dazomet, etem, milneb, mancopper, mancozeb, maneb, metiram, polycarbamate, propineb and zineb;
   the phthalimide fungicide is selected from the group consisting of captan, captafol and folpet;
   the chloronitrile fungicide is chlorothalonil;
   the sulfamide fungicide is dichlofluanid or tolylfluanid;
   the bis-guanidine fungicide is selected from the group consisting of guazatine and iminoctadine;
   the triazine fungicide is anilazine;
   the quinone fungicide is dithianon;
   the quinoxaline fungicide is selected from the group consisting of quinomethionate and chlorquinox;
   the dicarboxamide fungicide is fluoroimide;
   the inorganic fungicide is a copper fungicide selected from the group consisting of copper (II) hydroxide, copper oxychloride, copper (II) sulfate, basic copper sulfate, Bordeaux mixture, copper salicylate C₇H₄0₃.Cu, cuprous oxide CU₂O; and
   sulphur; and
c) at least a third systemic fungicide.

In a preferred embodiment, the preferred azole fungicide is fluconazole, mefentrifluconazole or ipfentrifluconazole.

Thus, in this embodiment, the present invention can provide a fungicidal combination comprising:
a) fluconazole;
b) at least one multisite contact fungicide, said multi-site fungicide being selected from the group consisting of dithiocarbamates, phthalimides, chloronitriles, inorganic fungicides, sulfamides, bis-guanidines, triazines, quinones, quinoxalines, dicoarboxamides and mixtures, wherein:
   the dithiocarbamate fungicide is selected from the group consisting of asamobam, asomate, azithiram, carbamorph, cufraneb, cuprobam, disulfiram, ferbam, metam, nabam, tecoram, thiram, urbacide, ziram, dazomet, etem, milneb, mancopper, mancozeb, maneb, metiram, polycarbamate, propineb and zineb;
   the phthalimide fungicide is selected from the group consisting of captan, captafol and folpet;
   the chloronitrile fungicide is chlorothalonil;
   the sulfamide fungicide is dichlofluanid or tolylfluanid;
   the bis-guanidine fungicide is selected from the group consisting of guazatine and iminoctadine;
   the triazine fungicide is anilazine;
   the quinone fungicide is dithianon;
   the quinoxaline fungicide is selected from the group consisting of quinomethionate and chlorquinox;
   the dicarboxamide fungicide is fluoroimide;
   the inorganic fungicide is a copper fungicide selected from the group consisting of copper (II) hydroxide, copper oxychloride, copper (II) sulfate, basic copper sulfate, Bordeaux mixture, copper salicylate C₇H₄0₃.Cu, cuprous oxide CU₂O; and
   sulphur; and
c) at least a third systemic fungicide.

Thus, in this embodiment, the present invention can provide a fungicidal combination comprising:
a) mefentrifluconazole;
b) at least one multisite contact fungicide, said multi-site fungicide being selected from the group consisting of dithiocarbamates, phthalimides, chloronitriles, inorganic fungicides, sulfamides, bis-guanidines, triazines, quinones, quinoxalines, dicoarboxamides and mixtures, wherein:
   the dithiocarbamate fungicide is selected from the group consisting of asamobam, asomate, azithiram, carbamorph, cufraneb, cuprobam, disulfiram, ferbam, metam, nabam, tecoram, thiram, urbacide, ziram, dazomet, etem, milneb, mancopper, mancozeb, maneb, metiram, polycarbamate, propineb and zineb;
   the phthalimide fungicide is selected from the group consisting of captan, captafol and folpet;
   the chloronitrile fungicide is chlorothalonil;
   the sulfamide fungicide is dichlofluanid or tolylfluanid;
   the bis-guanidine fungicide is selected from the group consisting of guazatine and iminoctadine;
   the triazine fungicide is anilazine;
   the quinone fungicide is dithianon;
   the quinoxaline fungicide is selected from the group consisting of quinomethionate and chlorquinox;
   the dicarboxamide fungicide is fluoroimide;
   the inorganic fungicide is a copper fungicide selected from the group consisting of copper (II) hydroxide, copper oxychloride, copper (II) sulfate, basic copper sulfate, Bordeaux mixture, copper salicylate C₇H₄0₃.Cu, cuprous oxide CU₂O; and
   sulphur; and
c) at least a third systemic fungicide.

Thus, in this embodiment, the present invention can provide a fungicidal combination comprising:
a) ipfentrifluconazole;
b) at least one multisite contact fungicide, said multi-site fungicide being selected from the group consisting of dithiocarbamates, phthalimides, chloronitriles, inorganic fungicides, sulfamides, bis-guanidines, triazines, quinones, quinoxalines, dicoarboxamides and mixtures, wherein:
   the dithiocarbamate fungicide is selected from the group consisting of asamobam, asomate, azithiram, carbamorph, cufraneb, cuprobam, disulfiram, ferbam, metam, nabam, tecoram, thiram, urbacide, ziram, dazomet, etem, milneb, mancopper, mancozeb, maneb, metiram, polycarbamate, propineb and zineb;
   the phthalimide fungicide is selected from the group consisting of captan, captafol and folpet;
   the chloronitrile fungicide is chlorothalonil;
   the sulfamide fungicide is dichlofluanid or tolylfluanid;
   the bis-guanidine fungicide is selected from the group consisting of guazatine and iminoctadine;
   the triazine fungicide is anilazine;
   the quinone fungicide is dithianon;
   the quinoxaline fungicide is selected from the group consisting of quinomethionate and chlorquinox;
   the dicarboxamide fungicide is fluoroimide;
   the inorganic fungicide is a copper fungicide selected from the group consisting of copper (II) hydroxide, copper oxychloride, copper (II) sulfate, basic copper sulfate, Bordeaux mixture, copper salicylate C₇H₄0₃.Cu, cuprous oxide CU₂O; and
   sulphur; and
c) at least a third systemic fungicide.

In an embodiment, the third fungicides in the combinations with an azole fungicide may be selected from nucleic acid synthesis inhibitor, cytoskeleton and motor protein inhibitors, amino acids and protein synthesis inhibitors, respiration process inhibitors, signal transduction inhibitors, lipid synthesis and membrane integrity distruptors, sterol biosynthesis inhibitors, melanin synthesis inhibitors, cell wall biosynthesis inhibitors, melanin synthesis inhibitor in cell wall, host plant defence inductors, fungicides with unknown modes of action, fungicide with no classification, biologicals with multiple mode of action.

Thus, in an embodiment, the nucleic acid synthesis inhibitor fungicides may be selected from acylalanines such as benalaxyl, benalaxyl-M (kiralaxyl), furalaxyl, metalaxyl, metalaxyl-M (mefenoxam), oxazolidinones such as oxadixyl, butyrolactones such as ofurace, hydroxy-(2-amino-) pyrimidines such as bupirimate, dimethirimol, ethirimol, isoxazoles such as hymexazole, isothiazolones such as octhilinone, carboxylic acids such as oxolinic acid.

In an embodiment, the cytoskeleton and motor protein inhibitors may be benzimidazoles such as benomyl, carbendazim, fuberidazole, thiabendazole, thiophanates such as thiophanate, thiophanate-methyl, N-phenyl carbamates such as diethofencarb, toluamides such as zoxamide, thiazole carboxamides such as ethaboxam, phenylureas such as pencycuron, benzamides such as fluopicolide, cyanoacrylates such as phenamacril.

In an embodiment, the respiration process inhibitor fungicides may be selected from pyrimidinamines such diflumetorim, pyrazole-5-carboxamides such as tolfenpyrad, SDHI such as benodanil, flutolanil, mepronil, isofetamid, fluopyram, fenfuram, carboxin, oxycarboxin, thifluzamide, benzovindiflupyr, bixafen, fluindapyr, fluxapyroxad, furametpyr, inpyrfluxam, isopyrazam, penflufen, penthiopyrad, sedaxane, isoflucypram, pydiflumetofen, boscalid and pyraziflumid; strobilurins such as azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, di moxystrobin, fenaminostrobin, metominostrobin, trifloxystrobin, famoxadone, fluoxastrobin, fenamidone, pyribencarb and mixtures thereof, oxazolidine-diones such as famoxadone, Imidazolinones such as fenamidone, benzyl-carbamates such as pyribencarb, N-methoxy-(phenyl-ethyl)-pyrazole-carboxamides such as Pyrimidinamines such as diflumetorim, cyano-imidazole such as cyazofamid, sulfamoyl-triazole such as amisulbrom, picolinamides such as fenpicoxamid dinitrophenyl crotonates such as binapacryl, meptyldinocap, dinocap, 2,6-dinitro-anilines such as fluazinam, pyr.-hydrazones such as ferimzone, tri-phenyl tin compounds such as fentin acetate, fentin chloride, fentin hydroxide, thiophene-carboxamides such as silthiofam, triazolo-pyrimidylamine such as ametoctradin.

In an embodiment, amino acids and protein synthesis inhibitor fungicides may be selected from anilino-pyrimidines such as cyprodinil, mepanipyrim, pyrimethanil, antibiotic fungicides such as blasticidin-S, kasugamycin, streptomycin, oxytetracycline and the like.

In an embodiment, signal transduction inhibitor fungicides may be selected from aryloxyquinolines such as quinoxyfen, quinazolinones such as proquinazid, phenylpyrroles such as fenpiclonil, fludioxonil, dicarboximides such as chlozolinate, dimethachlone, iprodione, procymidone and vinclozolin.

In an embodiment, the third fungicide may be selected from lipid synthesis and membrane integrity distruptors such as phosphoro-thiolates such as edifenphos, Iprobenfos, pyrazophos, dithiolanes such as isoprothiolane, aromatic hydrocarbons such as biphenyl, chloroneb, dicloran, quintozene (PCNB), tecnazene (TCNB), tolclofos-methyl and the like, 1,2,4-thiadiazoles such as etridiazole, carbamates such as iodocarb, propamocarb, prothiocarb and the like.

Thus in an embodiment, the sterol biosynthesis inhibitors may be selected from triazoles such as azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, Ipconazole, metconazole, myclobutanil, penconazole, Propiconazole, simeconazole, tebuconazole, tetraconazole, triadimefon, triadimenol, triticonazole, prothioconazole, piperazines such as triforine, pyridines such as pyrifenox, pyrisoxazole, pyrimidines such as fenarimol, nuarimol imidazoles such as imazalil, oxpoconazole, pefurazoate, prochloraz, triflumizole, morpholines such as aldimorph, dodemorph, fenpropimorph, tridemorph and the like, piperidines such as fenpropidin, piperalin, spiroketal-amines such as spiroxamine, hydroxyanilides such as fenhexamid, amino-pyrazolinones such as fenpyrazamine, thiocarbamates such as pyributicarb, allylamines such as naftifine, terbinafine and mixtrues thereof.

In an embodiment, cell wall biosynthesis inhibitor fungicides may be selected from peptidyl pyrimidine nucleoside fungicides such as polyoxin, cinnamic acid amides such as dimethomorph, flumorph, pyrimorph, valinamide carbamates such as benthiavalicarb, iprovalicarb, valifenalate, mandelic acid amides such as mandipropamid and mixtures thereof.

In an embodiment, melanin synthesis inhibitor fungicide may be selected from isobenzo-furanone such as fthalide, pyrrolo-quinolinones such as pyroquilon, triazolobenzo-thiazoles such as tricyclazole, cyclopropane-carboxamides such as carpropamid, carboxamides such as diclocymet, propionamides such as fenoxanil, trifluoroethyl-carbamates such as tolprocarb, and mixtures thereof.

In an embodiment, host plant defence inductors fungicides may be selected from benzo-thiadiazoles such as acibenzolar-S-methyl, benzisothiazoles such as probenazole, thiadiazole-carboxamides such as tiadinil, isotianil, polysaccharides such as laminarin, and mixtures thereof.

In an embodiment, the additional third fungicide with unknown mode of action may be selected from cyanoacetamide-oximes such as cymoxanil, ethyl phosphonates such as foestyl-Al, phophorous acid and salts, phthalamic acids such as teclofthalam, benzotriazines such as triazoxide, benzene-sulphonamides such as flusulfamide, pyridazinones such as diclomezine, thiocarbamates such as methasulfocarb, phenyl-acetamides such as cyflufenamid, aryl-phenyl-ketones such as metrafenone, pyriofenone, guanidines such as dodine, cyano-methylene-thiazolidines such as flutianil, pyrimidinone-hydrazones such as ferimzone, piperidinyl-thiazole-isoxazolines such as oxathiapiprolin, 4-quinolyl-acetates such as tebufloquin, tetrazolyloximes such as picarbutrazox, glucopyranosyl antibiotics such as validamycin, fungicides such as mineral oil, organic oils, potassium bicarbonate and mixtures thereof.

In another embodiment, the ergosterol biosynthesis inhibitors may be selected from prothioconazole, tebuconazole, hexaconazole, cyroconazole or epoxiconazole.

In an embodiment, the fungicide may be a Quinone outside (Qo) inhibitor fungicide selected from azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, di moxystrobin, fenaminostrobin, metominostrobin, trifloxystrobin, famoxadone, fluoxastrobin, fenamidone, pyribencarb and mixtures thereof.

In an embodiment, the Quinone outside (Qo) inhibitor fungicide may be selected from azoxystrobin, picoxystrobin, kresoxim-methyl, pyraclostrobin and trifloxystrobin.

Thus, in an embodiment, the present invention can provide a fungicidal combination comprising:
a) fluconazole;
b) at least one multisite contact fungicide, said multi-site fungicide being selected from the group consisting of dithiocarbamates, phthalimides, chloronitriles, inorganic fungicides, sulfamides, bis-guanidines, triazines, quinones, quinoxalines, dicoarboxamides and mixtures, wherein:
   the dithiocarbamate fungicide is selected from the group consisting of asamobam, asomate, azithiram, carbamorph, cufraneb, cuprobam, disulfiram, ferbam, metam, nabam, tecoram, thiram, urbacide, ziram, azomet, etem, milneb, mancopper, mancozeb, maneb, metiram, polycarbamate, propineb and zineb;
   the phthalimide fungicide is selected from the group consisting of captan, captafol and folpet;
   the chloronitrile fungicide is chlorothalonil;
   the sulfamide fungicide is dichlofluanid or tolylfluanid;
   the bis-guanidine fungicide is selected from the group consisting of guazatine and iminoctadine;
   the triazine fungicide is anilazine;
   the quinone fungicide is dithianon;
   the quinoxaline fungicide is selected from the group consisting of quinomethionate and chlorquinox;
   the dicarboxamide fungicide is fluoroimide;
   the inorganic fungicide is a copper fungicide selected from the group consisting of copper (II) hydroxide, copper oxychloride, copper (II) sulfate, basic copper sulfate, Bordeaux mixture, copper salicylate C₇H₄0₃.Cu, cuprous oxide CU₂O; and
   sulphur; and
c) at least a third systemic fungicide selected from a quinone outside inhibitor, quinone inside inhibitor, demthylation inhibitor, and succinate dehydrogenase inhibitor; wherein:
   (i) the quinone outside inhibitor is selected from fenamidone, famoxadone, and a strobilurin fungicide selected from the group consisting of azoxystrobin, mandestrobin, coumoxystrobin, enoxastrobin, flufenoxystrobin, pyraoxystrobin, dimoxystrobin, enestrobin, fluoxastrobin, kresoxim-methyl, metominostrobin, orysastrobin, picoxystrobin, pyrametostrobin, triclopyricarb, fenaminstrobin, pyraclostrobin and trifloxystrobin;
   (ii) the demethylation inhibitor is selected from triflumizole, triforine, pyridinitrile, pyrifenox, fenarimol, nuarimol, triarimol and a conazole fungicide selected from the group consisting of climbazole, clotrimazole, imazalil, oxpoconazole, prochloraz, prochloraz-manganese, triflumizole, azaconazole, bitertanol, bromuconazole, cyproconazole, diclobutrazol, difenoconazole, diniconazole, diniconazole-M, epoxiconazole, etaconazole, fenbuconazole, fluotrimazole, fluquinconazole, flusilazole, flutriafol, furconazole, furconazole-cis, hexaconazole, imibenconazole, ipconazole, metconazole, myclobutanil, pencoconazole, propiconazole, prothioconazole, quinconazole, simeconazole, tebuconazole, tetraconazole, mefentrifluconazole, triadimefon, triadimenol, triticonazole, uniconazole, perfurazoate and uniconazole-P;
   (iii) the quinone inside inhibitor selected from cyazofamid and amisulbrom; and
   (iv) a succinate dehydrogenase inhibitor selected from the group consisting of benodanil, flutolanil, mepronil, fluopyram, fenfuram, carboxin, oxycarboxin, thifluzamide, bixafen, fluxapyroxad, furametpyr, isopyrazam, penflufen, penthiopyrad, sedaxane, Aminopyrifen and boscalid.

In an embodiment, the multisite fungicide is selected from the group consisting of mancozeb, folpet, tribasic copper sulfate, chlorothalonil, sulphur, Captan, Propineb, Maneb, Thiram, and Zineb.

Thus, in an embodiment, the present invention can provide a fungicidal combination comprising:
a) mefentrifluconazole;
b) at least one multisite contact fungicide, said multi-site fungicide being selected from the group consisting of dithiocarbamates, phthalimides, chloronitriles, inorganic fungicides, sulfamides, bis-guanidines, triazines, quinones, quinoxalines, dicoarboxamides and mixtures, wherein:
   the dithiocarbamate fungicide is selected from the group consisting of asamobam, asomate, azithiram, carbamorph, cufraneb, cuprobam, disulfiram, ferbam, metam, nabam, tecoram, thiram, urbacide, ziram, dazomet, etem, milneb, mancopper, mancozeb, maneb, metiram, polycarbamate, propineb and zineb;
   the phthalimide fungicide is selected from the group consisting of captan, captafol and folpet;
   the chloronitrile fungicide is chlorothalonil;
   the sulfamide fungicide is dichlofluanid or tolylfluanid;
   the bis-guanidine fungicide is selected from the group consisting of guazatine and iminoctadine;
   the triazine fungicide is anilazine;
   the quinone fungicide is dithianon;
   the quinoxaline fungicide is selected from the group consisting of quinomethionate and chlorquinox;
   the dicarboxamide fungicide is fluoroimide;
   the inorganic fungicide is a copper fungicide selected from the group consisting of copper (II) hydroxide, copper oxychloride, copper (II) sulfate, basic copper sulfate, Bordeaux mixture, copper salicylate C₇H₄0₃.Cu, cuprous oxide CU₂O; and
   sulphur; and
c) at least a third systemic fungicide selected from a quinone outside inhibitor, quinone inside inhibitor, demthylation inhibitor, and succinate dehydrogenase inhibitor; wherein:
   (i) the quinone outside inhibitor is selected from fenamidone, famoxadone, and a strobilurin fungicide selected from the group consisting of azoxystrobin, mandestrobin, coumoxystrobin, enoxastrobin, flufenoxystrobin, pyraoxystrobin, dimoxystrobin, enestrobin, fluoxastrobin, kresoxim-methyl, metominostrobin, orysastrobin, picoxystrobin, pyrametostrobin, triclopyricarb, fenaminstrobin, pyraclostrobin and trifloxystrobin;
   (ii) the demethylation inhibitor is selected from triflumizole, triforine, pyridinitrile, pyrifenox, fenarimol, nuarimol, triarimol and a conazole fungicide selected from the group consisting of climbazole, clotrimazole, imazalil, oxpoconazole, prochloraz, prochloraz-manganese, triflumizole, azaconazole, bitertanol, bromuconazole, cyproconazole, diclobutrazol, difenoconazole, diniconazole, diniconazole-M, epoxiconazole, etaconazole, fenbuconazole, fluotrimazole, fluquinconazole, flusilazole, flutriafol, furconazole, furconazole-cis, hexaconazole, imibenconazole, ipconazole, metconazole, myclobutanil, pencoconazole, propiconazole, prothioconazole, quinconazole, simeconazole, tebuconazole, tetraconazole, triadimefon, triadimenol, triticonazole, uniconazole, perfurazoate and uniconazole-P;
   (iii) the quinone inside inhibitor selected from cyazofamid and amisulbrom; and
   (iv) a succinate dehydrogenase inhibitor selected from the group consisting of benodanil, flutolanil, mepronil, fluopyram, fenfuram, carboxin, oxycarboxin, thifluzamide, bixafen, fluxapyroxad, furametpyr, isopyrazam, penflufen, penthiopyrad, sedaxane, Aminopyrifen and boscalid.

Thus, in an embodiment, the present invention can provide a fungicidal combination comprising:
a) Ipfentrifluconazole;
b) at least one multisite contact fungicide, said multi-site fungicide being selected from the group consisting of dithiocarbamates, phthalimides, chloronitriles, inorganic fungicides, sulfamides, bis-guanidines, triazines, quinones, quinoxalines, dicoarboxamides and mixtures, wherein:
   the dithiocarbamate fungicide is selected from the group consisting of asamobam, asomate, azithiram, carbamorph, cufraneb, cuprobam, disulfiram, ferbam, metam, nabam, tecoram, thiram, urbacide, ziram, dazomet, etem, milneb, mancopper, mancozeb, maneb, metiram, polycarbamate, propineb and zineb;
   the phthalimide fungicide is selected from the group consisting of captan, captafol and folpet;
   the chloronitrile fungicide is chlorothalonil;
   the sulfamide fungicide is dichlofluanid or tolylfluanid;
   the bis-guanidine fungicide is selected from the group consisting of guazatine and iminoctadine;
   the triazine fungicide is anilazine;
   the quinone fungicide is dithianon;
   the quinoxaline fungicide is selected from the group consisting of quinomethionate and chlorquinox;
   the dicarboxamide fungicide is fluoroimide;
   the inorganic fungicide is a copper fungicide selected from the group consisting of copper (II) hydroxide, copper oxychloride, copper (II) sulfate, basic copper sulfate, Bordeaux mixture, copper salicylate C₇H₄0₃.Cu, cuprous oxide CU₂O; and
   sulphur; and
c) at least a third systemic fungicide selected from a quinone outside inhibitor, quinone inside inhibitor, demthylation inhibitor, and succinate dehydrogenase inhibitor; wherein:
   (i) the quinone outside inhibitor is selected from fenamidone, famoxadone, and a strobilurin fungicide selected from the group consisting of azoxystrobin, mandestrobin, coumoxystrobin, enoxastrobin, flufenoxystrobin, pyraoxystrobin, dimoxystrobin, enestrobin, fluoxastrobin, kresoxim-methyl, metominostrobin, orysastrobin, picoxystrobin, pyrametostrobin, triclopyricarb, fenaminstrobin, pyraclostrobin and trifloxystrobin;
   (ii) the demethylation inhibitor is selected from triflumizole, triforine, pyridinitrile, pyrifenox, fenarimol, nuarimol, triarimol and a conazole fungicide selected from the group consisting of climbazole, clotrimazole, imazalil, oxpoconazole, prochloraz, prochloraz-manganese, triflumizole, azaconazole, bitertanol, bromuconazole, cyproconazole, diclobutrazol, difenoconazole, diniconazole, diniconazole-M, epoxiconazole, etaconazole, fenbuconazole, fluotrimazole, fluquinconazole, flusilazole, flutriafol, furconazole, furconazole-cis, hexaconazole, imibenconazole, ipconazole, metconazole, myclobutanil, pencoconazole, propiconazole, prothioconazole, quinconazole, simeconazole, tebuconazole, tetraconazole, triadimefon, triadimenol, triticonazole, uniconazole, perfurazoate and uniconazole-P;
   (iii) the quinone inside inhibitor selected from cyazofamid and amisulbrom; and
   (iv) a succinate dehydrogenase inhibitor selected from the group consisting of benodanil, flutolanil, mepronil, fluopyram, fenfuram, carboxin, oxycarboxin, thifluzamide, bixafen, fluxapyroxad, furametpyr, isopyrazam, penflufen, penthiopyrad, sedaxane, Aminopyrifen and boscalid.

Thus, in an embodiment, the present invention can provide a fungicidal combination comprising:
a. fluconazole;
b. at least one multisite contact fungicide, said multi-site fungicide being selected from the group consisting of mancozeb, folpet, tribasic copper sulfate, chlorothalonil, sulphur, Captan, Propineb, Maneb, Thiram, and Zineb;
c. at least a third systemic fungicide selected from a quinone outside inhibitor, quinone inside inhibitor, demthylation inhibitor, and succinate dehydrogenase inhibitor; wherein:
   (i) the quinone outside inhibitor is selected from fenamidone, famoxadone, and a strobilurin fungicide selected from the group consisting of azoxystrobin, mandestrobin, coumoxystrobin, enoxastrobin, flufenoxystrobin, pyraoxystrobin, dimoxystrobin, enestrobin, fluoxastrobin, kresoxim-methyl, metominostrobin, orysastrobin, picoxystrobin, pyrametostrobin, triclopyricarb, fenaminstrobin, pyraclostrobin and trifloxystrobin;
   (ii) the demethylation inhibitor is selected from triflumizole, triforine, pyridinitrile, pyrifenox, fenarimol, nuarimol, triarimol and a conazole fungicide selected from the group consisting of climbazole, clotrimazole, imazalil, oxpoconazole, prochloraz, prochloraz-manganese, triflumizole, azaconazole, bitertanol, bromuconazole, cyproconazole, diclobutrazol, difenoconazole, diniconazole, diniconazole-M, epoxiconazole, etaconazole, fenbuconazole, fluotrimazole, fluquinconazole, flusilazole, flutriafol, furconazole, furconazole-cis, hexaconazole, imibenconazole, ipconazole, metconazole, myclobutanil, pencoconazole, propiconazole, prothioconazole, quinconazole, simeconazole, tebuconazole, tetraconazole, triadimefon, triadimenol, triticonazole, uniconazole, perfurazoate and uniconazole-P;
   (iii) the quinone inside inhibitor selected from cyazofamid and amisulbrom; and
   (iv) a succinate dehydrogenase inhibitor selected from the group consisting of benodanil, flutolanil, mepronil, fluopyram, fenfuram, carboxin, oxycarboxin, thifluzamide, bixafen, fluxapyroxad, furametpyr, isopyrazam, penflufen, penthiopyrad, sedaxane and boscalid.

In an embodiment, the present invention can provide a fungicidal combination comprising:
a) fluconazole;
b) at least one multisite contact fungicide, said multi-site fungicide being selected from the group consisting of mancozeb, folpet, tribasic copper sulfate, chlorothalonil, sulphur, Captan, Propineb, Maneb, Thiram, and Zineb;
c) at least one quinone outside inhibitor selected from fenamidone, famoxadone, and a strobilurin fungicide selected from the group consisting of azoxystrobin, mandestrobin, coumoxystrobin, enoxastrobin, flufenoxystrobin, pyraoxystrobin, dimoxystrobin, enestrobin, fluoxastrobin, kresoxim-methyl, metominostrobin, orysastrobin, picoxystrobin, pyrametostrobin, triclopyricarb, fenaminstrobin, pyraclostrobin and trifloxystrobin.

In an embodiment, the present invention can provide a fungicidal combination comprising:
a) mefentrifluconazole;
b) at least one multisite contact fungicide, said multi-site fungicide being selected from the group consisting of mancozeb, folpet, tribasic copper sulfate, chlorothalonil, sulphur, Captan, Propineb, Maneb, Thiram, and Zineb;
c) at least one quinone outside inhibitor selected from fenamidone, famoxadone, and a strobilurin fungicide selected from the group consisting of azoxystrobin, mandestrobin, coumoxystrobin, enoxastrobin, flufenoxystrobin, pyraoxystrobin, dimoxystrobin, enestrobin, fluoxastrobin, kresoxim-methyl, metominostrobin, orysastrobin, picoxystrobin, pyrametostrobin, triclopyricarb, fenaminstrobin, pyraclostrobin and trifloxystrobin.

In an embodiment, the present invention can provide a fungicidal combination comprising:
a) Ipfentrifluconazole;
b) at least one multisite contact fungicide, said multi-site fungicide being selected from the group consisting of mancozeb, folpet, tribasic copper sulfate, chlorothalonil, sulphur, Captan, Propineb, Maneb, Thiram, and Zineb;
c) at least one quinone outside inhibitor selected from fenamidone, famoxadone, and a strobilurin fungicide selected from the group consisting of azoxystrobin, mandestrobin, coumoxystrobin, enoxastrobin, flufenoxystrobin, pyraoxystrobin, dimoxystrobin, enestrobin, fluoxastrobin, kresoxim-methyl, metominostrobin, orysastrobin, picoxystrobin, pyrametostrobin, triclopyricarb, fenaminstrobin, pyraclostrobin and trifloxystrobin.

In an embodiment, the present invention can provide a fungicidal combination comprising:
a) fluconazole;
b) at least one multisite contact fungicide, said multi-site fungicide being selected from the group consisting of mancozeb, folpet, tribasic copper sulfate, chlorothalonil, sulphur, Captan, Propineb, Maneb, Thiram, and Zineb;
c) at least one demethylation inhibitor selected from triflumizole, triforine, pyridinitrile, pyrifenox, fenarimol, nuarimol, triarimol and a conazole fungicide selected from the group consisting of climbazole, clotrimazole, imazalil, oxpoconazole, prochloraz, prochloraz-manganese, triflumizole, azaconazole, bitertanol, bromuconazole, cyproconazole, diclobutrazol, difenoconazole, diniconazole, diniconazole-M, epoxiconazole, etaconazole, fenbuconazole, fluotrimazole, fluquinconazole, flusilazole, flutriafol, furconazole, furconazole-cis, hexaconazole, imibenconazole, ipconazole, metconazole, myclobutanil, pencoconazole, propiconazole, prothioconazole, quinconazole, simeconazole, tebuconazole, tetraconazole, triadimefon, triadimenol, triticonazole, uniconazole, perfurazoate and uniconazole-P.

In an embodiment, the present invention can provide a fungicidal combination comprising:
a) mefentrifluconazole;
b) at least one multisite contact fungicide, said multi-site fungicide being selected from the group consisting of mancozeb, folpet, tribasic copper sulfate, chlorothalonil, sulphur, Captan, Propineb, Maneb, Thiram, and Zineb;
c) at least one demethylation inhibitor selected from triflumizole, triforine, pyridinitrile, pyrifenox, fenarimol, nuarimol, triarimol and a conazole fungicide selected from the group consisting of climbazole, clotrimazole, imazalil, oxpoconazole, prochloraz, prochloraz-manganese, triflumizole, azaconazole, bitertanol, bromuconazole, cyproconazole, diclobutrazol, difenoconazole, diniconazole, diniconazole-M, epoxiconazole, etaconazole, fenbuconazole, fluotrimazole, fluquinconazole, flusilazole, flutriafol, furconazole, furconazole-cis, hexaconazole, imibenconazole, ipconazole, metconazole, myclobutanil, pencoconazole, propiconazole, prothioconazole, quinconazole, simeconazole, tebuconazole, tetraconazole, triadimefon, triadimenol, triticonazole, uniconazole, perfurazoate and uniconazole-P.

In an embodiment, the present invention can provide a fungicidal combination comprising:
a) Ipfentrifluconazole;
b) at least one multisite contact fungicide, said multi-site fungicide being selected from the group consisting of mancozeb, folpet, tribasic copper sulfate, chlorothalonil, sulphur, Captan, Propineb, Maneb, Thiram, and Zineb;
c) at least one demethylation inhibitor selected from triflumizole, triforine, pyridinitrile, pyrifenox, fenarimol, nuarimol, triarimol and a conazole fungicide selected from the group consisting of climbazole, clotrimazole, imazalil, oxpoconazole, prochloraz, prochloraz-manganese, triflumizole, azaconazole, bitertanol, bromuconazole, cyproconazole, diclobutrazol, difenoconazole, diniconazole, diniconazole-M, epoxiconazole, etaconazole, fenbuconazole, fluotrimazole, fluquinconazole, flusilazole, flutriafol, furconazole, furconazole-cis, hexaconazole, imibenconazole, ipconazole, metconazole, myclobutanil, pencoconazole, propiconazole, prothioconazole, quinconazole, simeconazole, tebuconazole, tetraconazole, triadimefon, triadimenol, triticonazole, uniconazole, perfurazoate and uniconazole-P.

In an embodiment, the present invention can provide a fungicidal combination comprising:
a) fluconazole;
b) at least one multisite contact fungicide, said multi-site fungicide being selected from the group consisting of mancozeb, folpet, tribasic copper sulfate, chlorothalonil, sulphur, Captan, Propineb, Maneb, Thiram, and Zineb; and
c) at least one succinate dehydrogenase inhibitor selected from the group consisting of benodanil, flutolanil, mepronil, fluopyram, fenfuram, carboxin, oxycarboxin, thifluzamide, bixafen, fluxapyroxad, furametpyr, isopyrazam, penflufen, penthiopyrad, sedaxane and boscalid.

In an embodiment, the present invention can provide a fungicidal combination comprising:
a) mefentrifluconazole;
b) at least one multisite contact fungicide, said multi-site fungicide being selected from the group consisting of mancozeb, folpet, tribasic copper sulfate, chlorothalonil, sulphur, Captan, Propineb, Maneb, Thiram, and Zineb; and
c) at least one succinate dehydrogenase inhibitor selected from the group consisting of benodanil, flutolanil, mepronil, fluopyram, fenfuram, carboxin, oxycarboxin, thifluzamide, bixafen, fluxapyroxad, furametpyr, isopyrazam, penflufen, penthiopyrad, sedaxane and boscalid.

In an embodiment, the present invention can provide a fungicidal combination comprising:
a) Ipfentrifluconazole;
b) at least one multisite contact fungicide, said multi-site fungicide being selected from the group consisting of mancozeb, folpet, tribasic copper sulfate, chlorothalonil, sulphur, Captan, Propineb, Maneb, Thiram, and Zineb; and
c) at least one succinate dehydrogenase inhibitor selected from the group consisting of benodanil, flutolanil, mepronil, fluopyram, fenfuram, carboxin, oxycarboxin, thifluzamide, bixafen, fluxapyroxad, furametpyr, isopyrazam, penflufen, penthiopyrad, sedaxane and boscalid.

In the exemplary combinations tabulated below, the term “Fungicide A” means Fluconazole, Mefentrifluconazole or Ipfentrifluconazole.

In the exemplary combinations tabulated below, the term “Fungicide B” means at least one, and preferably individually each one of the fungicides selected from mancozeb (B1), folpet (B2), copper salt e.g. tribasic copper sulfate (TBCS (B3)), chlorothalonil (B4), sulphur (B5), Captan (B6), Propineb (B7), Maneb (B8), Thiram (B9), Zineb (B10) as being specifically combined herein with the remaining fungicides.

In the exemplary combinations tabulated below, the term “Fungicide C” means at least one, and preferably individually each one of the fungicides selected from isopyrazam (C1), benzovindiflupyr (C2), penthiopyrad (C3), boscalid (C4), IR9792 (fluindapyr (C5)), bixafen (C6), fluxapyroxad (C7), furametpyr (C8), penflufen (C9), 3-difluoromethyl-N-(7-fluoro-1, 1, 3-trimethyl-4-indanyl)-I-methyl-4-pyrazolecarboxamide (C10), sedaxane (C11), benodanil (C12), flutolanil (C13), mepronil (C14), isofetamid (C15), fluopyram (C16), fenfuram (C17), carboxin (C18), oxycarboxin (C19), thifluzamide (C20), pydiflumetofen (C21); isofetamid (C22) cyproconazole (C24), difenoconazole (C25), epoxiconazole (C26), hexaconazole (C27), tebuconazole (C28), tetraconazole (C29), prothioconazole (C30), metalaxyl (C31), metalaxyl-M (C32), benomyl (C33), carbendazim (C34), thiophanate-methyl (C35), zoxamide (C36), fluopicolide (C37), phenamacril (C38), cyazofamid (C39), amisulbrom (C40), tricyclazole (C41), oxathiapiprolin (C42), and picarbutrazox (C43), azoxystrobin (C44), picoxystrobin (C45), pyraclostrobin (C46), kresoxim-methyl (C47), trfloxystrobin (C48), Aminopyrifen(C49), Inpyrfluxam(C50), Pyridachlometyl(C51), Fluopimomide(C52),Ipflufenoquin(C53), Metyltetraprole(C54), Florylpicoxamid(C55), Pyrapropoyne(C56), Fluindapyr(C57), Isoflucypram(C58), Fenpicoxamid(C59), Dichlobentiazox(C60), Ipfentrifluconazole(C61), Quinofumelin(062), Mefentrifluconazole (C63).

| Sr | | | |
|---|---|---|---|
| No. | A | B | C |
| 1. | Fluconazole | mancozeb | isopyrazam |
| 2. | Fluconazole | Folpet | isopyrazam |
| 3. | Fluconazole | Copper salts | isopyrazam |
| 4. | Fluconazole | chlorothalonil | isopyrazam |
| 5. | Fluconazole | sulphur | isopyrazam |
| 6. | Fluconazole | Captan | isopyrazam |
| 7. | Fluconazole | Propineb | isopyrazam |
| 8. | Fluconazole | Maneb | isopyrazam |
| 9. | Fluconazole | Thiram | isopyrazam |
| 10. | Fluconazole | Zineb | isopyrazam |
| 11. | Fluconazole | mancozeb | benzovindiflupyr |
| 12. | Fluconazole | Folpet | benzovindiflupyr |
| 13. | Fluconazole | Copper salts | benzovindiflupyr |
| 14. | Fluconazole | chlorothalonil | benzovindiflupyr |
| 15. | Fluconazole | sulphur | benzovindiflupyr |
| 16. | Fluconazole | Captan | benzovindiflupyr |
| 17. | Fluconazole | Propineb | benzovindiflupyr |
| 18. | Fluconazole | Maneb | benzovindiflupyr |
| 19. | Fluconazole | Thiram | benzovindiflupyr |
| 20. | Fluconazole | Zineb | benzovindiflupyr |
| 21. | Fluconazole | mancozeb | penthiopyrad |
| 22. | Fluconazole | Folpet | penthiopyrad |
| 23. | Fluconazole | Copper salts | penthiopyrad |
| 24. | Fluconazole | chlorothalonil | penthiopyrad |
| 25. | Fluconazole | sulphur | penthiopyrad |
| 26. | Fluconazole | Captan | penthiopyrad |
| 27. | Fluconazole | Propineb | penthiopyrad |
| 28. | Fluconazole | Maneb | penthiopyrad |
| 29. | Fluconazole | Thiram | penthiopyrad |
| 30. | Fluconazole | Zineb | penthiopyrad |
| 31. | Fluconazole | mancozeb | Fentine Hydroxide |
| 32. | Fluconazole | Folpet | Fentine Hydroxide |
| 33. | Fluconazole | Copper salts | Fentine Hydroxide |
| 34. | Fluconazole | chlorothalonil | Fentine Hydroxide |
| 35. | Fluconazole | sulphur | Fentine Hydroxide |
| 36. | Fluconazole | Captan | Fentine Hydroxide |
| 37. | Fluconazole | Propineb | Fentine Hydroxide |
| 38. | Fluconazole | Maneb | Fentine Hydroxide |
| 39. | Fluconazole | Thiram | Fentine Hydroxide |
| 40. | Fluconazole | Zineb | Fentine Hydroxide |
| 41. | Fluconazole | mancozeb | boscalid |
| 42. | Fluconazole | Folpet | boscalid |
| 43. | Fluconazole | Copper salts | boscalid |
| 44. | Fluconazole | chlorothalonil | boscalid |
| 45. | Fluconazole | sulphur | boscalid |
| 46. | Fluconazole | Captan | boscalid |
| 47. | Fluconazole | Propineb | boscalid |
| 48. | Fluconazole | Maneb | boscalid |
| 49. | Fluconazole | Thiram | boscalid |
| 50. | Fluconazole | Zineb | boscalid |
| 51. | Fluconazole | mancozeb | Fluindapyr |
| 52. | Fluconazole | Folpet | Fluindapyr |
| 53. | Fluconazole | Copper salts | Fluindapyr |
| 54. | Fluconazole | chlorothalonil | Fluindapyr |
| 55. | Fluconazole | Sulphur | Fluindapyr |
| 56. | Fluconazole | Captan | Fluindapyr |
| 57. | Fluconazole | Propineb | Fluindapyr |
| 58. | Fluconazole | Maneb | Fluindapyr |
| 59. | Fluconazole | Thiram | Fluindapyr |
| 60. | Fluconazole | Zineb | Fluindapyr |
| 61. | Fluconazole | mancozeb | bixafen |
| 62. | Fluconazole | Folpet | bixafen |
| 63. | Fluconazole | Copper salts | bixafen |
| 64. | Fluconazole | chlorothalonil | bixafen |
| 65. | Fluconazole | sulphur | bixafen |
| 66. | Fluconazole | Captan | bixafen |
| 67. | Fluconazole | Propineb | bixafen |
| 68. | Fluconazole | Maneb | bixafen |
| 69. | Fluconazole | Thiram | bixafen |
| 70. | Fluconazole | Zineb | bixafen |
| 71. | Fluconazole | mancozeb | fluxapyroxad |
| 72. | Fluconazole | Folpet | fluxapyroxad |
| 73. | Fluconazole | Copper salts | fluxapyroxad |
| 74. | Fluconazole | chlorothalonil | fluxapyroxad |
| 75. | Fluconazole | sulphur | fluxapyroxad |
| 76. | Fluconazole | Captan | fluxapyroxad |
| 77. | Fluconazole | Propineb | fluxapyroxad |
| 78. | Fluconazole | Maneb | fluxapyroxad |
| 79. | Fluconazole | Thiram | fluxapyroxad |
| 80. | Fluconazole | Zineb | fluxapyroxad |
| 81. | Fluconazole | mancozeb | furametpyr |
| 82. | Fluconazole | Folpet | furametpyr |
| 83. | Fluconazole | Copper salts | furametpyr |
| 84. | Fluconazole | chlorothalonil | furametpyr |
| 85. | Fluconazole | sulphur | furametpyr |
| 86. | Fluconazole | Captan | furametpyr |
| 87. | Fluconazole | Propineb | furametpyr |
| 88. | Fluconazole | Maneb | furametpyr |
| 89. | Fluconazole | Thiram | furametpyr |
| 90. | Fluconazole | Zineb | furametpyr |
| 91. | Fluconazole | mancozeb | penflufen |
| 92. | Fluconazole | Folpet | penflufen |
| 93. | Fluconazole | Copper salts | penflufen |
| 94. | Fluconazole | chlorothalonil | penflufen |
| 95. | Fluconazole | sulphur | penflufen |
| 96. | Fluconazole | Captan | penflufen |
| 97. | Fluconazole | Propineb | penflufen |
| 98. | Fluconazole | Maneb | penflufen |
| 99. | Fluconazole | Thiram | penflufen |
| 100. | Fluconazole | Zineb | penflufen |
| 101. | Fluconazole | mancozeb | 3-difluoromethyl-N- |
| | | | (7-fluoro-1,1,3- |
| | | | trimethyl-4-indanyl)- |
| | | | l-methyl-4- |
| | | | pyrazolecarboxamide |
| 102. | Fluconazole | Folpet | 3-difluoromethyl-N- |
| | | | (7-fluoro-1,1,3- |
| | | | trimethyl-4-indanyl)- |
| | | | l-methyl-4- |
| | | | pyrazolecarboxamide |
| 103. | Fluconazole | Copper salts | 3-difluoromethyl-N- |
| | | | (7-fluoro-1,1,3- |
| | | | trimethyl-4-indanyl)- |
| | | | l-methyl-4- |
| | | | pyrazolecarboxamide |
| 104. | Fluconazole | chlorothalonil | 3-difluoromethyl-N- |
| | | | (7-fluoro-1,1,3- |
| | | | trimethyl-4-indanyl)- |
| | | | l-methyl-4- |
| | | | pyrazolecarboxamide |
| 105. | Fluconazole | sulphur | 3-difluoromethyl-N- |
| | | | (7-fluoro-1,1,3- |
| | | | trimethyl-4-indanyl)- |
| | | | l-methyl-4- |
| | | | pyrazolecarboxamide |
| 106. | Fluconazole | Captan | 3-difluoromethyl-N- |
| | | | (7-fluoro-1,1,3- |
| | | | trimethyl-4-indanyl)- |
| | | | l-methyl-4- |
| | | | pyrazolecarboxamide |
| 107. | Fluconazole | Propineb | 3-difluoromethyl-N- |
| | | | (7-fluoro-1,1,3- |
| | | | trimethyl-4-indanyl)- |
| | | | l-methyl-4- |
| | | | pyrazolecarboxamide |
| 108. | Fluconazole | Maneb | 3-difluoromethyl-N- |
| | | | (7-fluoro-1,1,3- |
| | | | trimethyl-4-indanyl)- |
| | | | l-methyl-4- |
| | | | pyrazolecarboxamide |
| 109. | Fluconazole | Thiram | 3-difluoromethyl-N- |
| | | | (7-fluoro-1,1,3- |
| | | | trimethyl-4-indanyl)- |
| | | | l-methyl-4- |
| | | | pyrazolecarboxamide |
| 110. | Fluconazole | Zineb | 3-difluoromethyl-N- |
| | | | (7-fluoro-1,1,3- |
| | | | trimethyl-4-indanyl)- |
| | | | l-methyl-4- |
| | | | pyrazolecarboxamide |
| 111. | Fluconazole | mancozeb | sedaxane |
| 112. | Fluconazole | Folpet | sedaxane |
| 113. | Fluconazole | Copper salts | sedaxane |
| 114. | Fluconazole | chlorothalonil | sedaxane |
| 115. | Fluconazole | sulphur | sedaxane |
| 116. | Fluconazole | Captan | sedaxane |
| 117. | Fluconazole | Propineb | sedaxane |
| 118. | Fluconazole | Maneb | sedaxane |
| 119. | Fluconazole | Thiram | sedaxane |
| 120. | Fluconazole | Zineb | sedaxane |
| 121. | Fluconazole | mancozeb | benodanil |
| 122. | Fluconazole | Folpet | benodanil |
| 123. | Fluconazole | Copper salts | benodanil |
| 124. | Fluconazole | chlorothalonil | benodanil |
| 125. | Fluconazole | sulphur | benodanil |
| 126. | Fluconazole | Captan | benodanil |
| 127. | Fluconazole | Propineb | benodanil |
| 128. | Fluconazole | Maneb | benodanil |
| 129. | Fluconazole | Thiram | benodanil |
| 130. | Fluconazole | Zineb | benodanil |
| 131. | Fluconazole | mancozeb | flutolanil |
| 132. | Fluconazole | Folpet | flutolanil |
| 133. | Fluconazole | Copper salts | flutolanil |
| 134. | Fluconazole | chlorothalonil | flutolanil |
| 135. | Fluconazole | sulphur | flutolanil |
| 136. | Fluconazole | Captan | flutolanil |
| 137. | Fluconazole | Propineb | flutolanil |
| 138. | Fluconazole | Maneb | flutolanil |
| 139. | Fluconazole | Thiram | flutolanil |
| 140. | Fluconazole | Zineb | flutolanil |
| 141. | Fluconazole | mancozeb | mepronil |
| 142. | Fluconazole | Folpet | mepronil |
| 143. | Fluconazole | Copper salts | mepronil |
| 144. | Fluconazole | chlorothalonil | mepronil |
| 145. | Fluconazole | sulphur | mepronil |
| 146. | Fluconazole | Captan | mepronil |
| 147. | Fluconazole | Propineb | mepronil |
| 148. | Fluconazole | Maneb | mepronil |
| 149. | Fluconazole | Thiram | mepronil |
| 150. | Fluconazole | Zineb | mepronil |
| 151. | Fluconazole | mancozeb | isofetamid |
| 152. | Fluconazole | Folpet | isofetamid |
| 153. | Fluconazole | Copper salts | isofetamid |
| 154. | Fluconazole | chlorothalonil | isofetamid |
| 155. | Fluconazole | sulphur | isofetamid |
| 156. | Fluconazole | Captan | isofetamid |
| 157. | Fluconazole | Propineb | isofetamid |
| 158. | Fluconazole | Maneb | isofetamid |
| 159. | Fluconazole | Thiram | isofetamid |
| 160. | Fluconazole | Zineb | isofetamid |
| 161. | Fluconazole | mancozeb | fluopyram |
| 162. | Fluconazole | Folpet | fluopyram |
| 163. | Fluconazole | Copper salts | fluopyram |
| 164. | Fluconazole | chlorothalonil | fluopyram |
| 165. | Fluconazole | sulphur | fluopyram |
| 166. | Fluconazole | Captan | fluopyram |
| 167. | Fluconazole | Propineb | fluopyram |
| 168. | Fluconazole | Maneb | fluopyram |
| 169. | Fluconazole | Thiram | fluopyram |
| 170. | Fluconazole | Zineb | fluopyram |
| 171. | Fluconazole | mancozeb | fenfuram |
| 172. | Fluconazole | Folpet | fenfuram |
| 173. | Fluconazole | Copper salts | fenfuram |
| 174. | Fluconazole | chlorothalonil | fenfuram |
| 175. | Fluconazole | sulphur | fenfuram |
| 176. | Fluconazole | Captan | fenfuram |
| 177. | Fluconazole | Propineb | fenfuram |
| 178. | Fluconazole | Maneb | fenfuram |
| 179. | Fluconazole | Thiram | fenfuram |
| 180. | Fluconazole | Zineb | fenfuram |
| 181. | Fluconazole | mancozeb | carboxin |
| 182. | Fluconazole | Folpet | carboxin |
| 183. | Fluconazole | Copper salts | carboxin |
| 184. | Fluconazole | chlorothalonil | carboxin |
| 185. | Fluconazole | sulphur | carboxin |
| 186. | Fluconazole | Captan | carboxin |
| 187. | Fluconazole | Propineb | carboxin |
| 188. | Fluconazole | Maneb | carboxin |
| 189. | Fluconazole | Thiram | carboxin |
| 190. | Fluconazole | Zineb | carboxin |
| 191. | Fluconazole | mancozeb | oxycarboxin |
| 192. | Fluconazole | Folpet | oxycarboxin |
| 193. | Fluconazole | Copper salts | oxycarboxin |
| 194. | Fluconazole | chlorothalonil | oxycarboxin |
| 195. | Fluconazole | sulphur | oxycarboxin |
| 196. | Fluconazole | Captan | oxycarboxin |
| 197. | Fluconazole | Propineb | oxycarboxin |
| 198. | Fluconazole | Maneb | oxycarboxin |
| 199. | Fluconazole | Thiram | oxycarboxin |
| 200. | Fluconazole | Zineb | oxycarboxin |
| 201. | Fluconazole | mancozeb | thifluzamide |
| 202. | Fluconazole | Folpet | thifluzamide |
| 203. | Fluconazole | Copper salts | thifluzamide |
| 204. | Fluconazole | chlorothalonil | thifluzamide |
| 205. | Fluconazole | sulphur | thifluzamide |
| 206. | Fluconazole | Captan | thifluzamide |
| 207. | Fluconazole | Propineb | thifluzamide |
| 208. | Fluconazole | Maneb | thifluzamide |
| 209. | Fluconazole | Thiram | thifluzamide |
| 210. | Fluconazole | Zineb | thifluzamide |
| 211. | Fluconazole | mancozeb | pydiflumetofen |
| 212. | Fluconazole | Folpet | pydiflumetofen |
| 213. | Fluconazole | Copper salts | pydiflumetofen |
| 214. | Fluconazole | chlorothalonil | pydiflumetofen |
| 215. | Fluconazole | sulphur | pydiflumetofen |
| 216. | Fluconazole | Captan | pydiflumetofen |
| 217. | Fluconazole | Propineb | pydiflumetofen |
| 218. | Fluconazole | Maneb | pydiflumetofen |
| 219. | Fluconazole | Thiram | pydiflumetofen |
| 220. | Fluconazole | Zineb | pydiflumetofen |
| 221. | Fluconazole | mancozeb | isofetamid |
| 222. | Fluconazole | Folpet | isofetamid |
| 223. | Fluconazole | Copper salts | isofetamid |
| 224. | Fluconazole | chlorothalonil | isofetamid |
| 225. | Fluconazole | sulphur | isofetamid |
| 226. | Fluconazole | Captan | isofetamid |
| 227. | Fluconazole | Propineb | isofetamid |
| 228. | Fluconazole | Maneb | isofetamid |
| 229. | Fluconazole | Thiram | isofetamid |
| 230. | Fluconazole | Zineb | isofetamid |
| 231. | Fluconazole | mancozeb | cyproconazole |
| 232. | Fluconazole | Folpet | cyproconazole |
| 233. | Fluconazole | Copper salts | cyproconazole |
| 234. | Fluconazole | chlorothalonil | cyproconazole |
| 235. | Fluconazole | sulphur | cyproconazole |
| 236. | Fluconazole | Captan | cyproconazole |
| 237. | Fluconazole | Propineb | cyproconazole |
| 238. | Fluconazole | Maneb | cyproconazole |
| 239. | Fluconazole | Thiram | cyproconazole |
| 240. | Fluconazole | Zineb | cyproconazole |
| 241. | Fluconazole | mancozeb | difenoconazole |
| 242. | Fluconazole | Folpet | difenoconazole |
| 243. | Fluconazole | Copper salts | difenoconazole |
| 244. | Fluconazole | chlorothalonil | difenoconazole |
| 245. | Fluconazole | sulphur | difenoconazole |
| 246. | Fluconazole | Captan | difenoconazole |
| 247. | Fluconazole | Propineb | difenoconazole |
| 248. | Fluconazole | Maneb | difenoconazole |
| 249. | Fluconazole | Thiram | difenoconazole |
| 250. | Fluconazole | Zineb | difenoconazole |
| 251. | Fluconazole | mancozeb | epoxiconazole |
| 252. | Fluconazole | Folpet | epoxiconazole |
| 253. | Fluconazole | Copper salts | epoxiconazole |
| 254. | Fluconazole | chlorothalonil | epoxiconazole |
| 255. | Fluconazole | sulphur | epoxiconazole |
| 256. | Fluconazole | Captan | epoxiconazole |
| 257. | Fluconazole | Propineb | epoxiconazole |
| 258. | Fluconazole | Maneb | epoxiconazole |
| 259. | Fluconazole | Thiram | epoxiconazole |
| 260. | Fluconazole | Zineb | epoxiconazole |
| 261. | Fluconazole | mancozeb | hexaconazole |
| 262. | Fluconazole | Folpet | hexaconazole |
| 263. | Fluconazole | Copper salts | hexaconazole |
| 264. | Fluconazole | chlorothalonil | hexaconazole |
| 265. | Fluconazole | sulphur | hexaconazole |
| 266. | Fluconazole | Captan | hexaconazole |
| 267. | Fluconazole | Propineb | hexaconazole |
| 268. | Fluconazole | Maneb | hexaconazole |
| 269. | Fluconazole | Thiram | hexaconazole |
| 270. | Fluconazole | Zineb | hexaconazole |
| 271. | Fluconazole | mancozeb | tebuconazole |
| 272. | Fluconazole | Folpet | tebuconazole |
| 273. | Fluconazole | Copper salts | tebuconazole |
| 274. | Fluconazole | chlorothalonil | tebuconazole |
| 275. | Fluconazole | sulphur | tebuconazole |
| 276. | Fluconazole | Captan | tebuconazole |
| 277. | Fluconazole | Propineb | tebuconazole |
| 278. | Fluconazole | Maneb | tebuconazole |
| 279. | Fluconazole | Thiram | tebuconazole |
| 280. | Fluconazole | Zineb | tebuconazole |
| 281. | Fluconazole | mancozeb | tetraconazole |
| 282. | Fluconazole | Folpet | tetraconazole |
| 283. | Fluconazole | Copper salts | tetraconazole |
| 284. | Fluconazole | chlorothalonil | tetraconazole |
| 285. | Fluconazole | sulphur | tetraconazole |
| 286. | Fluconazole | Captan | tetraconazole |
| 287. | Fluconazole | Propineb | tetraconazole |
| 288. | Fluconazole | Maneb | tetraconazole |
| 289. | Fluconazole | Thiram | tetraconazole |
| 290. | Fluconazole | Zineb | tetraconazole |
| 291. | Fluconazole | mancozeb | prothioconazole |
| 292. | Fluconazole | Folpet | prothioconazole |
| 293. | Fluconazole | Copper salts | prothioconazole |
| 294. | Fluconazole | chlorothalonil | prothioconazole |
| 295. | Fluconazole | sulphur | prothioconazole |
| 296. | Fluconazole | Captan | prothioconazole |
| 297. | Fluconazole | Propineb | prothioconazole |
| 298. | Fluconazole | Maneb | prothioconazole |
| 299. | Fluconazole | Thiram | prothioconazole |
| 300. | Fluconazole | Zineb | prothioconazole |
| 301. | Fluconazole | mancozeb | prothioconazole |
| 302. | Fluconazole | Folpet | metalaxyl |
| 303. | Fluconazole | Copper salts | metalaxyl |
| 304. | Fluconazole | chlorothalonil | metalaxyl |
| 305. | Fluconazole | sulphur | metalaxyl |
| 306. | Fluconazole | Captan | metalaxyl |
| 307. | Fluconazole | Propineb | metalaxyl |
| 308. | Fluconazole | Maneb | metalaxyl |
| 309. | Fluconazole | Thiram | metalaxyl |
| 310. | Fluconazole | Zineb | metalaxyl |
| 311. | Fluconazole | mancozeb | metalaxyl-M |
| 312. | Fluconazole | Folpet | metalaxyl-M |
| 313. | Fluconazole | Copper salts | metalaxyl-M |
| 314. | Fluconazole | chlorothalonil | metalaxyl-M |
| 315. | Fluconazole | sulphur | metalaxyl-M |
| 316. | Fluconazole | Captan | metalaxyl-M |
| 317. | Fluconazole | Propineb | metalaxyl-M |
| 318. | Fluconazole | Maneb | metalaxyl-M |
| 319. | Fluconazole | Thiram | metalaxyl-M |
| 320. | Fluconazole | Zineb | metalaxyl-M |
| 321. | Fluconazole | mancozeb | benomyl |
| 322. | Fluconazole | Folpet | benomyl |
| 323. | Fluconazole | Copper salts | benomyl |
| 324. | Fluconazole | chlorothalonil | benomyl |
| 325. | Fluconazole | sulphur | benomyl |
| 326. | Fluconazole | Captan | benomyl |
| 327. | Fluconazole | Propineb | benomyl |
| 328. | Fluconazole | Maneb | benomyl |
| 329. | Fluconazole | Thiram | benomyl |
| 330. | Fluconazole | Zineb | benomyl |
| 331. | Fluconazole | mancozeb | carbendazim |
| 332. | Fluconazole | Folpet | carbendazim |
| 333. | Fluconazole | Copper salts | carbendazim |
| 334. | Fluconazole | chlorothalonil | carbendazim |
| 335. | Fluconazole | sulphur | carbendazim |
| 336. | Fluconazole | Captan | carbendazim |
| 337. | Fluconazole | Propineb | carbendazim |
| 338. | Fluconazole | Maneb | carbendazim |
| 339. | Fluconazole | Thiram | carbendazim |
| 340. | Fluconazole | Zineb | carbendazim |
| 341. | Fluconazole | mancozeb | thiophanate-methyl |
| 342. | Fluconazole | Folpet | thiophanate-methyl |
| 343. | Fluconazole | Copper salts | thiophanate-methyl |
| 344. | Fluconazole | chlorothalonil | thiophanate-methyl |
| 345. | Fluconazole | sulphur | thiophanate-methyl |
| 346. | Fluconazole | Captan | thiophanate-methyl |
| 347. | Fluconazole | Propineb | thiophanate-methyl |
| 348. | Fluconazole | Maneb | thiophanate-methyl |
| 349. | Fluconazole | Thiram | thiophanate-methyl |
| 350. | Fluconazole | Zineb | thiophanate-methyl |
| 351. | Fluconazole | mancozeb | zoxamide |
| 352. | Fluconazole | Folpet | zoxamide |
| 353. | Fluconazole | Copper salts | zoxamide |
| 354. | Fluconazole | chlorothalonil | zoxamide |
| 355. | Fluconazole | sulphur | zoxamide |
| 356. | Fluconazole | Captan | zoxamide |
| 357. | Fluconazole | Propineb | zoxamide |
| 358. | Fluconazole | Maneb | zoxamide |
| 359. | Fluconazole | Thiram | zoxamide |
| 360. | Fluconazole | Zineb | zoxamide |
| 361. | Fluconazole | mancozeb | fluopicolide |
| 362. | Fluconazole | Folpet | fluopicolide |
| 363. | Fluconazole | Copper salts | fluopicolide |
| 364. | Fluconazole | chlorothalonil | fluopicolide |
| 365. | Fluconazole | sulphur | fluopicolide |
| 366. | Fluconazole | Captan | fluopicolide |
| 367. | Fluconazole | Propineb | fluopicolide |
| 368. | Fluconazole | Maneb | fluopicolide |
| 369. | Fluconazole | Thiram | fluopicolide |
| 370. | Fluconazole | Zineb | fluopicolide |
| 371. | Fluconazole | mancozeb | phenamacril |
| 372. | Fluconazole | Folpet | phenamacril |
| 373. | Fluconazole | Copper salts | phenamacril |
| 374. | Fluconazole | chlorothalonil | phenamacril |
| 375. | Fluconazole | sulphur | phenamacril |
| 376. | Fluconazole | Captan | phenamacril |
| 377. | Fluconazole | Propineb | phenamacril |
| 378. | Fluconazole | Maneb | phenamacril |
| 379. | Fluconazole | Thiram | phenamacril |
| 380. | Fluconazole | Zineb | phenamacril |
| 381. | Fluconazole | mancozeb | cyazofamid |
| 382. | Fluconazole | Folpet | cyazofamid |
| 383. | Fluconazole | Copper salts | cyazofamid |
| 384. | Fluconazole | chlorothalonil | cyazofamid |
| 385. | Fluconazole | sulphur | cyazofamid |
| 386. | Fluconazole | Captan | cyazofamid |
| 387. | Fluconazole | Propineb | cyazofamid |
| 388. | Fluconazole | Maneb | cyazofamid |
| 389. | Fluconazole | Thiram | cyazofamid |
| 390. | Fluconazole | Zineb | cyazofamid |
| 391. | Fluconazole | mancozeb | amisulbrom |
| 392. | Fluconazole | Folpet | amisulbrom |
| 393. | Fluconazole | Copper salts | amisulbrom |
| 394. | Fluconazole | chlorothalonil | amisulbrom |
| 395. | Fluconazole | sulphur | amisulbrom |
| 396. | Fluconazole | Captan | amisulbrom |
| 397. | Fluconazole | Propineb | amisulbrom |
| 398. | Fluconazole | Maneb | amisulbrom |
| 399. | Fluconazole | Thiram | amisulbrom |
| 400. | Fluconazole | Zineb | amisulbrom |
| 401. | Fluconazole | mancozeb | tricyclazole |
| 402. | Fluconazole | Folpet | tricyclazole |
| 403. | Fluconazole | Copper salts | tricyclazole |
| 404. | Fluconazole | chlorothalonil | tricyclazole |
| 405. | Fluconazole | sulphur | Tricyclazole |
| 406. | Fluconazole | Captan | Tricyclazole |
| 407. | Fluconazole | Propineb | Tricyclazole |
| 408. | Fluconazole | Maneb | Tricyclazole |
| 409. | Fluconazole | Thiram | Tricyclazole |
| 410. | Fluconazole | Zineb | Tricyclazole |
| 411. | Fluconazole | mancozeb | oxathiapiprolin |
| 412. | Fluconazole | Folpet | oxathiapiprolin |
| 413. | Fluconazole | Copper salts | oxathiapiprolin |
| 414. | Fluconazole | chlorothalonil | oxathiapiprolin |
| 415. | Fluconazole | sulphur | oxathiapiprolin |
| 416. | Fluconazole | Captan | oxathiapiprolin |
| 417. | Fluconazole | Propineb | oxathiapiprolin |
| 418. | Fluconazole | Maneb | oxathiapiprolin |
| 419. | Fluconazole | Thiram | oxathiapiprolin |
| 420. | Fluconazole | Zineb | oxathiapiprolin |
| 421. | Fluconazole | mancozeb | picarbutrazox |
| 422. | Fluconazole | Folpet | picarbutrazox |
| 423. | Fluconazole | Copper salts | picarbutrazox |
| 424. | Fluconazole | chlorothalonil | picarbutrazox |
| 425. | Fluconazole | sulphur | picarbutrazox |
| 426. | Fluconazole | Captan | picarbutrazox |
| 427. | Fluconazole | Propineb | picarbutrazox |
| 428. | Fluconazole | Maneb | picarbutrazox |
| 429. | Fluconazole | Thiram | picarbutrazox |
| 430. | Fluconazole | Zineb | picarbutrazox |
| 431. | Fluconazole | mancozeb | azoxystrobin |
| 432. | Fluconazole | Folpet | azoxystrobin |
| 433. | Fluconazole | Copper salts | azoxystrobin |
| 434. | Fluconazole | chlorothalonil | azoxystrobin |
| 435. | Fluconazole | sulphur | azoxystrobin |
| 436. | Fluconazole | Captan | azoxystrobin |
| 437. | Fluconazole | Propineb | azoxystrobin |
| 438. | Fluconazole | Maneb | azoxystrobin |
| 439. | Fluconazole | Thiram | azoxystrobin |
| 440. | Fluconazole | Zineb | azoxystrobin |
| 441. | Fluconazole | mancozeb | picoxystrobin |
| 442. | Fluconazole | Folpet | picoxystrobin |
| 443. | Fluconazole | Copper salts | picoxystrobin |
| 444. | Fluconazole | chlorothalonil | picoxystrobin |
| 445. | Fluconazole | sulphur | picoxystrobin |
| 446. | Fluconazole | Captan | picoxystrobin |
| 447. | Fluconazole | Propineb | picoxystrobin |
| 448. | Fluconazole | Maneb | picoxystrobin |
| 449. | Fluconazole | Thiram | picoxystrobin |
| 450. | Fluconazole | Zineb | picoxystrobin |
| 451. | Fluconazole | mancozeb | pyraclostrobin |
| 452. | Fluconazole | Folpet | pyraclostrobin |
| 453. | Fluconazole | Copper salts | pyraclostrobin |
| 454. | Fluconazole | chlorothalonil | pyraclostrobin |
| 455. | Fluconazole | sulphur | pyraclostrobin |
| 456. | Fluconazole | Captan | pyraclostrobin |
| 457. | Fluconazole | Propineb | pyraclostrobin |
| 458. | Fluconazole | Maneb | pyraclostrobin |
| 459. | Fluconazole | Thiram | pyraclostrobin |
| 460. | Fluconazole | Zineb | pyraclostrobin |
| 461. | Fluconazole | mancozeb | kresoxim-methyl |
| 462. | Fluconazole | Folpet | kresoxim-methyl |
| 463. | Fluconazole | Copper salts | kresoxim-methyl |
| 464. | Fluconazole | chlorothalonil | kresoxim-methyl |
| 465. | Fluconazole | Sulphur | kresoxim-methyl |
| 466. | Fluconazole | Captan | kresoxim-methyl |
| 467. | Fluconazole | Propineb | kresoxim-methyl |
| 468. | Fluconazole | Maneb | kresoxim-methyl |
| 469. | Fluconazole | Thiram | kresoxim-methyl |
| 470. | Fluconazole | Zineb | kresoxim-methyl |
| 471. | Fluconazole | Mancozeb | trifloxystrobin |
| 472. | Fluconazole | Folpet | trifloxystrobin |
| 473. | Fluconazole | Copper salts | trifloxystrobin |
| 474. | Fluconazole | chlorothalonil | trifloxystrobin |
| 475. | Fluconazole | sulphur | trifloxystrobin |
| 476. | Fluconazole | Captan | trifloxystrobin |
| 477. | Fluconazole | Propineb | trifloxystrobin |
| 478. | Fluconazole | Maneb | trifloxystrobin |
| 479. | Fluconazole | Thiram | trifloxystrobin |
| 480. | Fluconazole | Zineb | trifloxystrobin |
| 481. | Fluconazole | mancozeb | Copper oxychloride |
| 482. | Fluconazole | Folpet | Copper oxychloride |
| 483. | Fluconazole | Copper salts | Copper oxychloride |
| 484. | Fluconazole | chlorothalonil | Copper oxychloride |
| 485. | Fluconazole | sulphur | Copper oxychloride |
| 486. | Fluconazole | Captan | Copper oxychloride |
| 487. | Fluconazole | Propineb | Copper oxychloride |
| 488. | Fluconazole | Maneb | Copper oxychloride |
| 489. | Fluconazole | Thiram | Copper oxychloride |
| 490. | Fluconazole | Zineb | Copper oxychloride |
| 491. | Fluconazole | mancozeb | Aminopyrifen |
| 492. | Fluconazole | Folpet | Aminopyrifen |
| 493. | Fluconazole | Copper salts | Aminopyrifen |
| 494. | Fluconazole | chlorothalonil | Aminopyrifen |
| 495. | Fluconazole | sulphur | Aminopyrifen |
| 496. | Fluconazole | Captan | Aminopyrifen |
| 497. | Fluconazole | Propineb | Aminopyrifen |
| 498. | Fluconazole | Maneb | Aminopyrifen |
| 499. | Fluconazole | Thiram | Aminopyrifen |
| 500. | Fluconazole | Zineb | Aminopyrifen |
| 501. | Fluconazole | mancozeb | Inpyrfluxam |
| 502. | Fluconazole | Folpet | Inpyrfluxam |
| 503. | Fluconazole | Copper salts | Inpyrfluxam |
| 504. | Fluconazole | chlorothalonil | Inpyrfluxam |
| 505. | Fluconazole | sulphur | Inpyrfluxam |
| 506. | Fluconazole | Captan | Inpyrfluxam |
| 507. | Fluconazole | Propineb | Inpyrfluxam |
| 508. | Fluconazole | Maneb | Inpyrfluxam |
| 509. | Fluconazole | Thiram | Inpyrfluxam |
| 510. | Fluconazole | Zineb | Inpyrfluxam |
| 511. | Fluconazole | mancozeb | Pyridachlometyl |
| 512. | Fluconazole | Folpet | Pyridachlometyl |
| 513. | Fluconazole | Copper salts | Pyridachlometyl |
| 514. | Fluconazole | chlorothalonil | Pyridachlometyl |
| 515. | Fluconazole | sulphur | Pyridachlometyl |
| 516. | Fluconazole | Captan | Pyridachlometyl |
| 517. | Fluconazole | Propineb | Pyridachlometyl |
| 518. | Fluconazole | Maneb | Pyridachlometyl |
| 519. | Fluconazole | Thiram | Pyridachlometyl |
| 520. | Fluconazole | Zineb | Pyridachlometyl |
| 521. | Fluconazole | mancozeb | Fluopimomide |
| 522. | Fluconazole | Folpet | Fluopimomide |
| 523. | Fluconazole | Copper salts | Fluopimomide |
| 524. | Fluconazole | chlorothalonil | Fluopimomide |
| 525. | Fluconazole | sulphur | Fluopimomide |
| 526. | Fluconazole | Captan | Fluopimomide |
| 527. | Fluconazole | Propineb | Fluopimomide |
| 528. | Fluconazole | Maneb | Fluopimomide |
| 529. | Fluconazole | Thiram | Fluopimomide |
| 530. | Fluconazole | Zineb | Fluopimomide |
| 531. | Fluconazole | mancozeb | Ipflufenoquin |
| 532. | Fluconazole | Folpet | Ipflufenoquin |
| 533. | Fluconazole | Copper salts | Ipflufenoquin |
| 534. | Fluconazole | chlorothalonil | Ipflufenoquin |
| 535. | Fluconazole | sulphur | Ipflufenoquin |
| 536. | Fluconazole | Captan | Ipflufenoquin |
| 537. | Fluconazole | Propineb | Ipflufenoquin |
| 538. | Fluconazole | Maneb | Ipflufenoquin |
| 539. | Fluconazole | Thiram | Ipflufenoquin |
| 540. | Fluconazole | Zineb | Ipflufenoquin |
| 541. | Fluconazole | mancozeb | Metyltetraprole |
| 542. | Fluconazole | Folpet | Metyltetraprole |
| 543. | Fluconazole | Copper salts | Metyltetraprole |
| 544. | Fluconazole | chlorothalonil | Metyltetraprole |
| 545. | Fluconazole | sulphur | Metyltetraprole |
| 546. | Fluconazole | Captan | Metyltetraprole |
| 547. | Fluconazole | Propineb | Metyltetraprole |
| 548. | Fluconazole | Maneb | Metyltetraprole |
| 549. | Fluconazole | Thiram | Metyltetraprole |
| 550. | Fluconazole | Zineb | Metyltetraprole |
| 551. | Fluconazole | mancozeb | Florylpicoxamid |
| 552. | Fluconazole | Folpet | Florylpicoxamid |
| 553. | Fluconazole | Copper salts | Florylpicoxamid |
| 554. | Fluconazole | chlorothalonil | Florylpicoxamid |
| 555. | Fluconazole | sulphur | Florylpicoxamid |
| 556. | Fluconazole | Captan | Florylpicoxamid |
| 557. | Fluconazole | Propineb | Florylpicoxamid |
| 558. | Fluconazole | Maneb | Florylpicoxamid |
| 559. | Fluconazole | Thiram | Florylpicoxamid |
| 560. | Fluconazole | Zineb | Florylpicoxamid |
| 561. | Fluconazole | mancozeb | Pyrapropoyne |
| 562. | Fluconazole | Folpet | Pyrapropoyne |
| 563. | Fluconazole | Copper salts | Pyrapropoyne |
| 564. | Fluconazole | chlorothalonil | Pyrapropoyne |
| 565. | Fluconazole | sulphur | Pyrapropoyne |
| 566. | Fluconazole | Captan | Pyrapropoyne |
| 567. | Fluconazole | Propineb | Pyrapropoyne |
| 568. | Fluconazole | Maneb | Pyrapropoyne |
| 569. | Fluconazole | Thiram | Pyrapropoyne |
| 570. | Fluconazole | Zineb | Pyrapropoyne |
| 571. | Fluconazole | mancozeb | Isoflucypram |
| 572. | Fluconazole | Folpet | Isoflucypram |
| 573. | Fluconazole | Copper salts | Isoflucypram |
| 574. | Fluconazole | chlorothalonil | Isoflucypram |
| 575. | Fluconazole | sulphur | Isoflucypram |
| 576. | Fluconazole | Captan | Isoflucypram |
| 577. | Fluconazole | Propineb | Isoflucypram |
| 578. | Fluconazole | Maneb | Isoflucypram |
| 579. | Fluconazole | Thiram | Isoflucypram |
| 580. | Fluconazole | Zineb | Isoflucypram |
| 581. | Fluconazole | mancozeb | Fenpicoxamid |
| 582. | Fluconazole | Folpet | Fenpicoxamid |
| 583. | Fluconazole | Copper salts | Fenpicoxamid |
| 584. | Fluconazole | chlorothalonil | Fenpicoxamid |
| 585. | Fluconazole | sulphur | Fenpicoxamid |
| 586. | Fluconazole | Captan | Fenpicoxamid |
| 587. | Fluconazole | Propineb | Fenpicoxamid |
| 588. | Fluconazole | Maneb | Fenpicoxamid |
| 589. | Fluconazole | Thiram | Fenpicoxamid |
| 590. | Fluconazole | Zineb | Fenpicoxamid |
| 591. | Fluconazole | mancozeb | Dichlobentiazox |
| 592. | Fluconazole | Folpet | Dichlobentiazox |
| 593. | Fluconazole | Copper salts | Dichlobentiazox |
| 594. | Fluconazole | chlorothalonil | Dichlobentiazox |
| 595. | Fluconazole | sulphur | Dichlobentiazox |
| 596. | Fluconazole | Captan | Dichlobentiazox |
| 597. | Fluconazole | Propineb | Dichlobentiazox |
| 598. | Fluconazole | Maneb | Dichlobentiazox |
| 599. | Fluconazole | Thiram | Dichlobentiazox |
| 600. | Fluconazole | Zineb | Dichlobentiazox |
| 601. | Fluconazole | mancozeb | Ipfentrifluconazole |
| 602. | Fluconazole | Folpet | Ipfentrifluconazole |
| 603. | Fluconazole | Copper salts | Ipfentrifluconazole |
| 604. | Fluconazole | chlorothalonil | Ipfentrifluconazole |
| 605. | Fluconazole | sulphur | Ipfentrifluconazole |
| 606. | Fluconazole | Captan | Ipfentrifluconazole |
| 607. | Fluconazole | Propineb | Ipfentrifluconazole |
| 608. | Fluconazole | Maneb | Ipfentrifluconazole |
| 609. | Fluconazole | Thiram | Ipfentrifluconazole |
| 610. | Fluconazole | Zineb | Ipfentrifluconazole |
| 611. | Fluconazole | mancozeb | Quinofumelin |
| 612. | Fluconazole | Folpet | Quinofumelin |
| 613. | Fluconazole | Copper salts | Quinofumelin |
| 614. | Fluconazole | chlorothalonil | Quinofumelin |
| 615. | Fluconazole | sulphur | Quinofumelin |
| 616. | Fluconazole | Captan | Quinofumelin |
| 617. | Fluconazole | Propineb | Quinofumelin |
| 618. | Fluconazole | Maneb | Quinofumelin |
| 619. | Fluconazole | Thiram | Quinofumelin |
| 620. | Fluconazole | Zineb | Quinofumelin |
| 621. | Fluconazole | mancozeb | Mefentrifluconazole |
| 622. | Fluconazole | Folpet | Mefentrifluconazole |
| 623. | Fluconazole | Copper salts | Mefentrifluconazole |
| 624. | Fluconazole | chlorothalonil | Mefentrifluconazole |
| 625. | Fluconazole | sulphur | Mefentrifluconazole |
| 626. | Fluconazole | Captan | Mefentrifluconazole |
| 627. | Fluconazole | Propineb | Mefentrifluconazole |
| 628. | Fluconazole | Maneb | Mefentrifluconazole |
| 629. | Fluconazole | Thiram | Mefentrifluconazole |
| 630. | Fluconazole | Zineb | Mefentrifluconazole |
| 631. | Ipfentrifluconazole | mancozeb | isopyrazam |
| 632. | Ipfentrifluconazole | Folpet | isopyrazam |
| 633. | Ipfentrifluconazole | Copper salts | isopyrazam |
| 634. | Ipfentrifluconazole | chlorothalonil | isopyrazam |
| 635. | Ipfentrifluconazole | sulphur | isopyrazam |
| 636. | Ipfentrifluconazole | Captan | isopyrazam |
| 637. | Ipfentrifluconazole | Propineb | isopyrazam |
| 638. | Ipfentrifluconazole | Maneb | isopyrazam |
| 639. | Ipfentrifluconazole | Thiram | isopyrazam |
| 640. | Ipfentrifluconazole | Zineb | isopyrazam |
| 641. | Ipfentrifluconazole | mancozeb | benzovindiflupyr |
| 642. | Ipfentrifluconazole | Folpet | benzovindiflupyr |
| 643. | Ipfentrifluconazole | Copper salts | benzovindiflupyr |
| 644. | Ipfentrifluconazole | chlorothalonil | benzovindiflupyr |
| 645. | Ipfentrifluconazole | sulphur | benzovindiflupyr |
| 646. | Ipfentrifluconazole | Captan | benzovindiflupyr |
| 647. | Ipfentrifluconazole | Propineb | benzovindiflupyr |
| 648. | Ipfentrifluconazole | Maneb | benzovindiflupyr |
| 649. | Ipfentrifluconazole | Thiram | benzovindiflupyr |
| 650. | Ipfentrifluconazole | Zineb | benzovindiflupyr |
| 651. | Ipfentrifluconazole | mancozeb | penthiopyrad |
| 652. | Ipfentrifluconazole | Folpet | penthiopyrad |
| 653. | Ipfentrifluconazole | Copper salts | penthiopyrad |
| 654. | Ipfentrifluconazole | chlorothalonil | penthiopyrad |
| 655. | Ipfentrifluconazole | sulphur | penthiopyrad |
| 656. | Ipfentrifluconazole | Captan | penthiopyrad |
| 657. | Ipfentrifluconazole | Propineb | penthiopyrad |
| 658. | Ipfentrifluconazole | Maneb | penthiopyrad |
| 659. | Ipfentrifluconazole | Thiram | penthiopyrad |
| 660. | Ipfentrifluconazole | Zineb | penthiopyrad |
| 661. | Ipfentrifluconazole | mancozeb | Fentine Hydroxide |
| 662. | Ipfentrifluconazole | Folpet | Fentine Hydroxide |
| 663. | Ipfentrifluconazole | Copper salts | Fentine Hydroxide |
| 664. | Ipfentrifluconazole | chlorothalonil | Fentine Hydroxide |
| 665. | Ipfentrifluconazole | sulphur | Fentine Hydroxide |
| 666. | Ipfentrifluconazole | Captan | Fentine Hydroxide |
| 667. | Ipfentrifluconazole | Propineb | Fentine Hydroxide |
| 668. | Ipfentrifluconazole | Maneb | Fentine Hydroxide |
| 669. | Ipfentrifluconazole | Thiram | Fentine Hydroxide |
| 670. | Ipfentrifluconazole | Zineb | Fentine Hydroxide |
| 671. | Ipfentrifluconazole | mancozeb | boscalid |
| 672. | Ipfentrifluconazole | Folpet | boscalid |
| 673. | Ipfentrifluconazole | Copper salts | boscalid |
| 674. | Ipfentrifluconazole | chlorothalonil | boscalid |
| 675. | Ipfentrifluconazole | sulphur | boscalid |
| 676. | Ipfentrifluconazole | Captan | boscalid |
| 677. | Ipfentrifluconazole | Propineb | boscalid |
| 678. | Ipfentrifluconazole | Maneb | boscalid |
| 679. | Ipfentrifluconazole | Thiram | boscalid |
| 680. | Ipfentrifluconazole | Zineb | boscalid |
| 681. | Ipfentrifluconazole | mancozeb | Fluindapyr |
| 682. | Ipfentrifluconazole | Folpet | Fluindapyr |
| 683. | Ipfentrifluconazole | Copper salts | Fluindapyr |
| 684. | Ipfentrifluconazole | chlorothalonil | Fluindapyr |
| 685. | Ipfentrifluconazole | Sulphur | Fluindapyr |
| 686. | Ipfentrifluconazole | Captan | Fluindapyr |
| 687. | Ipfentrifluconazole | Propineb | Fluindapyr |
| 688. | Ipfentrifluconazole | Maneb | Fluindapyr |
| 689. | Ipfentrifluconazole | Thiram | Fluindapyr |
| 690. | Ipfentrifluconazole | Zineb | Fluindapyr |
| 691. | Ipfentrifluconazole | mancozeb | bixafen |
| 692. | Ipfentrifluconazole | Folpet | bixafen |
| 693. | Ipfentrifluconazole | Copper salts | bixafen |
| 694. | Ipfentrifluconazole | chlorothalonil | bixafen |
| 695. | Ipfentrifluconazole | sulphur | bixafen |
| 696. | Ipfentrifluconazole | Captan | bixafen |
| 697. | Ipfentrifluconazole | Propineb | bixafen |
| 698. | Ipfentrifluconazole | Maneb | bixafen |
| 699. | Ipfentrifluconazole | Thiram | bixafen |
| 700. | Ipfentrifluconazole | Zineb | bixafen |
| 701. | Ipfentrifluconazole | mancozeb | fluxapyroxad |
| 702. | Ipfentrifluconazole | Folpet | fluxapyroxad |
| 703. | Ipfentrifluconazole | Copper salts | fluxapyroxad |
| 704. | Ipfentrifluconazole | chlorothalonil | fluxapyroxad |
| 705. | Ipfentrifluconazole | sulphur | fluxapyroxad |
| 706. | Ipfentrifluconazole | Captan | fluxapyroxad |
| 707. | Ipfentrifluconazole | Propineb | fluxapyroxad |
| 708. | Ipfentrifluconazole | Maneb | fluxapyroxad |
| 709. | Ipfentrifluconazole | Thiram | fluxapyroxad |
| 710. | Ipfentrifluconazole | Zineb | fluxapyroxad |
| 711. | Ipfentrifluconazole | mancozeb | furametpyr |
| 712. | Ipfentrifluconazole | Folpet | furametpyr |
| 713. | Ipfentrifluconazole | Copper salts | furametpyr |
| 714. | Ipfentrifluconazole | chlorothalonil | furametpyr |
| 715. | Ipfentrifluconazole | sulphur | furametpyr |
| 716. | Ipfentrifluconazole | Captan | furametpyr |
| 717. | Ipfentrifluconazole | Propineb | furametpyr |
| 718. | Ipfentrifluconazole | Maneb | furametpyr |
| 719. | Ipfentrifluconazole | Thiram | furametpyr |
| 720. | Ipfentrifluconazole | Zineb | furametpyr |
| 721. | Ipfentrifluconazole | mancozeb | penflufen |
| 722. | Ipfentrifluconazole | Folpet | penflufen |
| 723. | Ipfentrifluconazole | Copper salts | penflufen |
| 724. | Ipfentrifluconazole | chlorothalonil | penflufen |
| 725. | Ipfentrifluconazole | sulphur | penflufen |
| 726. | Ipfentrifluconazole | Captan | penflufen |
| 727. | Ipfentrifluconazole | Propineb | penflufen |
| 728. | Ipfentrifluconazole | Maneb | penflufen |
| 729. | Ipfentrifluconazole | Thiram | penflufen |
| 730. | Ipfentrifluconazole | Zineb | penflufen |
| 731. | Ipfentrifluconazole | mancozeb | 3-difluoromethyl-N- |
| | | | (7-fluoro-1,1,3- |
| | | | trimethyl-4-indanyl)- |
| | | | l-methyl-4- |
| | | | pyrazolecarboxamide |
| 732. | Ipfentrifluconazole | Folpet | 3-difluoromethyl-N- |
| | | | (7-fluoro-1,1,3- |
| | | | trimethyl-4-indanyl)- |
| | | | l-methyl-4- |
| | | | pyrazolecarboxamide |
| 733. | Ipfentrifluconazole | Copper salts | 3-difluoromethyl-N- |
| | | | (7-fluoro-1,1,3- |
| | | | trimethyl-4-indanyl)- |
| | | | l-methyl-4- |
| | | | pyrazolecarboxamide |
| 734. | Ipfentrifluconazole | chlorothalonil | 3-difluoromethyl-N- |
| | | | (7-fluoro-1,1,3- |
| | | | trimethyl-4-indanyl)- |
| | | | l-methyl-4- |
| | | | pyrazolecarboxamide |
| 735. | Ipfentrifluconazole | sulphur | 3-difluoromethyl-N- |
| | | | (7-fluoro-1,1,3- |
| | | | trimethyl-4-indanyl)- |
| | | | l-methyl-4- |
| | | | pyrazolecarboxamide |
| 736. | Ipfentrifluconazole | Captan | 3-difluoromethyl-N- |
| | | | (7-fluoro-1,1,3- |
| | | | trimethyl-4-indanyl)- |
| | | | l-methyl-4- |
| | | | pyrazolecarboxamide |
| 737. | Ipfentrifluconazole | Propineb | 3-difluoromethyl-N- |
| | | | (7-fluoro-1,1,3- |
| | | | trimethyl-4-indanyl)- |
| | | | l-methyl-4- |
| | | | pyrazolecarboxamide |
| 738. | Ipfentrifluconazole | Maneb | 3-difluoromethyl-N- |
| | | | (7-fluoro-1,1,3- |
| | | | trimethyl-4-indanyl)- |
| | | | l-methyl-4- |
| | | | pyrazolecarboxamide |
| 739. | Ipfentrifluconazole | Thiram | 3-difluoromethyl-N- |
| | | | (7-fluoro-1,1,3- |
| | | | trimethyl-4-indanyl)- |
| | | | l-methyl-4- |
| | | | pyrazolecarboxamide |
| 740. | Ipfentrifluconazole | Zineb | 3-difluoromethyl-N- |
| | | | (7-fluoro-1,1,3- |
| | | | trimethyl-4-indanyl)- |
| | | | l-methyl-4- |
| | | | pyrazolecarboxamide |
| 741. | Ipfentrifluconazole | mancozeb | sedaxane |
| 742. | Ipfentrifluconazole | Folpet | sedaxane |
| 743. | Ipfentrifluconazole | Copper salts | sedaxane |
| 744. | Ipfentrifluconazole | chlorothalonil | sedaxane |
| 745. | Ipfentrifluconazole | sulphur | sedaxane |
| 746. | Ipfentrifluconazole | Captan | sedaxane |
| 747. | Ipfentrifluconazole | Propineb | sedaxane |
| 748. | Ipfentrifluconazole | Maneb | sedaxane |
| 749. | Ipfentrifluconazole | Thiram | sedaxane |
| 750. | Ipfentrifluconazole | Zineb | sedaxane |
| 751. | Ipfentrifluconazole | mancozeb | benodanil |
| 752. | Ipfentrifluconazole | Folpet | benodanil |
| 753. | Ipfentrifluconazole | Copper salts | benodanil |
| 754. | Ipfentrifluconazole | chlorothalonil | benodanil |
| 755. | Ipfentrifluconazole | sulphur | benodanil |
| 756. | Ipfentrifluconazole | Captan | benodanil |
| 757. | Ipfentrifluconazole | Propineb | benodanil |
| 758. | Ipfentrifluconazole | Maneb | benodanil |
| 759. | Ipfentrifluconazole | Thiram | benodanil |
| 760. | Ipfentrifluconazole | Zineb | benodanil |
| 761. | Ipfentrifluconazole | mancozeb | flutolanil |
| 762. | Ipfentrifluconazole | Folpet | flutolanil |
| 763. | Ipfentrifluconazole | Copper salts | flutolanil |
| 764. | Ipfentrifluconazole | chlorothalonil | flutolanil |
| 765. | Ipfentrifluconazole | sulphur | flutolanil |
| 766. | Ipfentrifluconazole | Captan | flutolanil |
| 767. | Ipfentrifluconazole | Propineb | flutolanil |
| 768. | Ipfentrifluconazole | Maneb | flutolanil |
| 769. | Ipfentrifluconazole | Thiram | flutolanil |
| 770. | Ipfentrifluconazole | Zineb | flutolanil |
| 771. | Ipfentrifluconazole | mancozeb | mepronil |
| 772. | Ipfentrifluconazole | Folpet | mepronil |
| 773. | Ipfentrifluconazole | Copper salts | mepronil |
| 774. | Ipfentrifluconazole | chlorothalonil | mepronil |
| 775. | Ipfentrifluconazole | sulphur | mepronil |
| 776. | Ipfentrifluconazole | Captan | mepronil |
| 111. | Ipfentrifluconazole | Propineb | mepronil |
| 778. | Ipfentrifluconazole | Maneb | mepronil |
| 779. | Ipfentrifluconazole | Thiram | mepronil |
| 780. | Ipfentrifluconazole | Zineb | mepronil |
| 781. | Ipfentrifluconazole | mancozeb | isofetamid |
| 782. | Ipfentrifluconazole | Folpet | isofetamid |
| 783. | Ipfentrifluconazole | Copper salts | isofetamid |
| 784. | Ipfentrifluconazole | chlorothalonil | isofetamid |
| 785. | Ipfentrifluconazole | sulphur | isofetamid |
| 786. | Ipfentrifluconazole | Captan | isofetamid |
| 787. | Ipfentrifluconazole | Propineb | isofetamid |
| 788. | Ipfentrifluconazole | Maneb | isofetamid |
| 789. | Ipfentrifluconazole | Thiram | isofetamid |
| 790. | Ipfentrifluconazole | Zineb | isofetamid |
| 791. | Ipfentrifluconazole | mancozeb | fluopyram |
| 792. | Ipfentrifluconazole | Folpet | fluopyram |
| 793. | Ipfentrifluconazole | Copper salts | fluopyram |
| 794. | Ipfentrifluconazole | chlorothalonil | fluopyram |
| 795. | Ipfentrifluconazole | sulphur | fluopyram |
| 796. | Ipfentrifluconazole | Captan | fluopyram |
| 797. | Ipfentrifluconazole | Propineb | fluopyram |
| 798. | Ipfentrifluconazole | Maneb | fluopyram |
| 799. | Ipfentrifluconazole | Thiram | fluopyram |
| 800. | Ipfentrifluconazole | Zineb | fluopyram |
| 801. | Ipfentrifluconazole | mancozeb | fenfuram |
| 802. | Ipfentrifluconazole | Folpet | fenfuram |
| 803. | Ipfentrifluconazole | Copper salts | fenfuram |
| 804. | Ipfentrifluconazole | chlorothalonil | fenfuram |
| 805. | Ipfentrifluconazole | sulphur | fenfuram |
| 806. | Ipfentrifluconazole | Captan | fenfuram |
| 807. | Ipfentrifluconazole | Propineb | fenfuram |
| 808. | Ipfentrifluconazole | Maneb | fenfuram |
| 809. | Ipfentrifluconazole | Thiram | fenfuram |
| 810. | Ipfentrifluconazole | Zineb | fenfuram |
| 811. | Ipfentrifluconazole | mancozeb | carboxin |
| 812. | Ipfentrifluconazole | Folpet | carboxin |
| 813. | Ipfentrifluconazole | Copper salts | carboxin |
| 814. | Ipfentrifluconazole | chlorothalonil | carboxin |
| 815. | Ipfentrifluconazole | sulphur | carboxin |
| 816. | Ipfentrifluconazole | Captan | carboxin |
| 817. | Ipfentrifluconazole | Propineb | carboxin |
| 818. | Ipfentrifluconazole | Maneb | carboxin |
| 819. | Ipfentrifluconazole | Thiram | carboxin |
| 820. | Ipfentrifluconazole | Zineb | carboxin |
| 821. | Ipfentrifluconazole | mancozeb | oxycarboxin |
| 822. | Ipfentrifluconazole | Folpet | oxycarboxin |
| 823. | Ipfentrifluconazole | Copper salts | oxycarboxin |
| 824. | Ipfentrifluconazole | chlorothalonil | oxycarboxin |
| 825. | Ipfentrifluconazole | sulphur | oxycarboxin |
| 826. | Ipfentrifluconazole | Captan | oxycarboxin |
| 827. | Ipfentrifluconazole | Propineb | oxycarboxin |
| 828. | Ipfentrifluconazole | Maneb | oxycarboxin |
| 829. | Ipfentrifluconazole | Thiram | oxycarboxin |
| 830. | Ipfentrifluconazole | Zineb | oxycarboxin |
| 831. | Ipfentrifluconazole | mancozeb | thifluzamide |
| 832. | Ipfentrifluconazole | Folpet | thifluzamide |
| 833. | Ipfentrifluconazole | Copper salts | thifluzamide |
| 834. | Ipfentrifluconazole | chlorothalonil | thifluzamide |
| 835. | Ipfentrifluconazole | sulphur | thifluzamide |
| 836. | Ipfentrifluconazole | Captan | thifluzamide |
| 837. | Ipfentrifluconazole | Propineb | thifluzamide |
| 838. | Ipfentrifluconazole | Maneb | thifluzamide |
| 839. | Ipfentrifluconazole | Thiram | thifluzamide |
| 840. | Ipfentrifluconazole | Zineb | thifluzamide |
| 841. | Ipfentrifluconazole | mancozeb | pydiflumetofen |
| 842. | Ipfentrifluconazole | Folpet | pydiflumetofen |
| 843. | Ipfentrifluconazole | Copper salts | pydiflumetofen |
| 844. | Ipfentrifluconazole | chlorothalonil | pydiflumetofen |
| 845. | Ipfentrifluconazole | sulphur | pydiflumetofen |
| 846. | Ipfentrifluconazole | Captan | pydiflumetofen |
| 847. | Ipfentrifluconazole | Propineb | pydiflumetofen |
| 848. | Ipfentrifluconazole | Maneb | pydiflumetofen |
| 849. | Ipfentrifluconazole | Thiram | pydiflumetofen |
| 850. | Ipfentrifluconazole | Zineb | pydiflumetofen |
| 851. | Ipfentrifluconazole | mancozeb | isofetamid |
| 852. | Ipfentrifluconazole | Folpet | isofetamid |
| 853. | Ipfentrifluconazole | Copper salts | isofetamid |
| 854. | Ipfentrifluconazole | chlorothalonil | isofetamid |
| 855. | Ipfentrifluconazole | sulphur | isofetamid |
| 856. | Ipfentrifluconazole | Captan | isofetamid |
| 857. | Ipfentrifluconazole | Propineb | isofetamid |
| 858. | Ipfentrifluconazole | Maneb | isofetamid |
| 859. | Ipfentrifluconazole | Thiram | isofetamid |
| 860. | Ipfentrifluconazole | Zineb | isofetamid |
| 861. | Ipfentrifluconazole | mancozeb | cyproconazole |
| 862. | Ipfentrifluconazole | Folpet | cyproconazole |
| 863. | Ipfentrifluconazole | Copper salts | cyproconazole |
| 864. | Ipfentrifluconazole | chlorothalonil | cyproconazole |
| 865. | Ipfentrifluconazole | sulphur | cyproconazole |
| 866. | Ipfentrifluconazole | Captan | cyproconazole |
| 867. | Ipfentrifluconazole | Propineb | cyproconazole |
| 868. | Ipfentrifluconazole | Maneb | cyproconazole |
| 869. | Ipfentrifluconazole | Thiram | cyproconazole |
| 870. | Ipfentrifluconazole | Zineb | cyproconazole |
| 871. | Ipfentrifluconazole | mancozeb | difenoconazole |
| 872. | Ipfentrifluconazole | Folpet | difenoconazole |
| 873. | Ipfentrifluconazole | Copper salts | difenoconazole |
| 874. | Ipfentrifluconazole | chlorothalonil | difenoconazole |
| 875. | Ipfentrifluconazole | sulphur | difenoconazole |
| 876. | Ipfentrifluconazole | Captan | difenoconazole |
| 877. | Ipfentrifluconazole | Propineb | difenoconazole |
| 878. | Ipfentrifluconazole | Maneb | difenoconazole |
| 879. | Ipfentrifluconazole | Thiram | difenoconazole |
| 880. | Ipfentrifluconazole | Zineb | difenoconazole |
| 881. | Ipfentrifluconazole | mancozeb | epoxiconazole |
| 882. | Ipfentrifluconazole | Folpet | epoxiconazole |
| 883. | Ipfentrifluconazole | Copper salts | epoxiconazole |
| 884. | Ipfentrifluconazole | chlorothalonil | epoxiconazole |
| 885. | Ipfentrifluconazole | sulphur | epoxiconazole |
| 886. | Ipfentrifluconazole | Captan | epoxiconazole |
| 887. | Ipfentrifluconazole | Propineb | epoxiconazole |
| 888. | Ipfentrifluconazole | Maneb | epoxiconazole |
| 889. | Ipfentrifluconazole | Thiram | epoxiconazole |
| 890. | Ipfentrifluconazole | Zineb | epoxiconazole |
| 891. | Ipfentrifluconazole | mancozeb | hexaconazole |
| 892. | Ipfentrifluconazole | Folpet | hexaconazole |
| 893. | Ipfentrifluconazole | Copper salts | hexaconazole |
| 894. | Ipfentrifluconazole | chlorothalonil | hexaconazole |
| 895. | Ipfentrifluconazole | sulphur | hexaconazole |
| 896. | Ipfentrifluconazole | Captan | hexaconazole |
| 897. | Ipfentrifluconazole | Propineb | hexaconazole |
| 898. | Ipfentrifluconazole | Maneb | hexaconazole |
| 899. | Ipfentrifluconazole | Thiram | hexaconazole |
| 900. | Ipfentrifluconazole | Zineb | hexaconazole |
| 901. | Ipfentrifluconazole | mancozeb | tebuconazole |
| 902. | Ipfentrifluconazole | Folpet | tebuconazole |
| 903. | Ipfentrifluconazole | Copper salts | tebuconazole |
| 904. | Ipfentrifluconazole | chlorothalonil | tebuconazole |
| 905. | Ipfentrifluconazole | sulphur | tebuconazole |
| 906. | Ipfentrifluconazole | Captan | tebuconazole |
| 907. | Ipfentrifluconazole | Propineb | tebuconazole |
| 908. | Ipfentrifluconazole | Maneb | tebuconazole |
| 909. | Ipfentrifluconazole | Thiram | tebuconazole |
| 910. | Ipfentrifluconazole | Zineb | tebuconazole |
| 911. | Ipfentrifluconazole | mancozeb | tetraconazole |
| 912. | Ipfentrifluconazole | Folpet | tetraconazole |
| 913. | Ipfentrifluconazole | Copper salts | tetraconazole |
| 914. | Ipfentrifluconazole | chlorothalonil | tetraconazole |
| 915. | Ipfentrifluconazole | sulphur | tetraconazole |
| 916. | Ipfentrifluconazole | Captan | tetraconazole |
| 917. | Ipfentrifluconazole | Propineb | tetraconazole |
| 918. | Ipfentrifluconazole | Maneb | tetraconazole |
| 919. | Ipfentrifluconazole | Thiram | tetraconazole |
| 920. | Ipfentrifluconazole | Zineb | tetraconazole |
| 921. | Ipfentrifluconazole | mancozeb | prothioconazole |
| 922. | Ipfentrifluconazole | Folpet | prothioconazole |
| 923. | Ipfentrifluconazole | Copper salts | prothioconazole |
| 924. | Ipfentrifluconazole | chlorothalonil | prothioconazole |
| 925. | Ipfentrifluconazole | sulphur | prothioconazole |
| 926. | Ipfentrifluconazole | Captan | prothioconazole |
| 927. | Ipfentrifluconazole | Propineb | prothioconazole |
| 928. | Ipfentrifluconazole | Maneb | prothioconazole |
| 929. | Ipfentrifluconazole | Thiram | prothioconazole |
| 930. | Ipfentrifluconazole | Zineb | prothioconazole |
| 931. | Ipfentrifluconazole | mancozeb | prothioconazole |
| 932. | Ipfentrifluconazole | Folpet | metalaxyl |
| 933. | Ipfentrifluconazole | Copper salts | metalaxyl |
| 934. | Ipfentrifluconazole | chlorothalonil | metalaxyl |
| 935. | Ipfentrifluconazole | sulphur | metalaxyl |
| 936. | Ipfentrifluconazole | Captan | metalaxyl |
| 937. | Ipfentrifluconazole | Propineb | metalaxyl |
| 938. | Ipfentrifluconazole | Maneb | metalaxyl |
| 939. | Ipfentrifluconazole | Thiram | metalaxyl |
| 940. | Ipfentrifluconazole | Zineb | metalaxyl |
| 941. | Ipfentrifluconazole | mancozeb | metalaxyl-M |
| 942. | Ipfentrifluconazole | Folpet | metalaxyl-M |
| 943. | Ipfentrifluconazole | Copper salts | metalaxyl-M |
| 944. | Ipfentrifluconazole | chlorothalonil | metalaxyl-M |
| 945. | Ipfentrifluconazole | sulphur | metalaxyl-M |
| 946. | Ipfentrifluconazole | Captan | metalaxyl-M |
| 947. | Ipfentrifluconazole | Propineb | metalaxyl-M |
| 948. | Ipfentrifluconazole | Maneb | metalaxyl-M |
| 949. | Ipfentrifluconazole | Thiram | metalaxyl-M |
| 950. | Ipfentrifluconazole | Zineb | metalaxyl-M |
| 951. | Ipfentrifluconazole | mancozeb | benomyl |
| 952. | Ipfentrifluconazole | Folpet | benomyl |
| 953. | Ipfentrifluconazole | Copper salts | benomyl |
| 954. | Ipfentrifluconazole | chlorothalonil | benomyl |
| 955. | Ipfentrifluconazole | sulphur | benomyl |
| 956. | Ipfentrifluconazole | Captan | benomyl |
| 957. | Ipfentrifluconazole | Propineb | benomyl |
| 958. | Ipfentrifluconazole | Maneb | benomyl |
| 959. | Ipfentrifluconazole | Thiram | benomyl |
| 960. | Ipfentrifluconazole | Zineb | benomyl |
| 961. | Ipfentrifluconazole | mancozeb | carbendazim |
| 962. | Ipfentrifluconazole | Folpet | carbendazim |
| 963. | Ipfentrifluconazole | Copper salts | carbendazim |
| 964. | Ipfentrifluconazole | chlorothalonil | carbendazim |
| 965. | Ipfentrifluconazole | sulphur | carbendazim |
| 966. | Ipfentrifluconazole | Captan | carbendazim |
| 967. | Ipfentrifluconazole | Propineb | carbendazim |
| 968. | Ipfentrifluconazole | Maneb | carbendazim |
| 969. | Ipfentrifluconazole | Thiram | carbendazim |
| 970. | Ipfentrifluconazole | Zineb | carbendazim |
| 971. | Ipfentrifluconazole | mancozeb | thiophanate-methyl |
| 972. | Ipfentrifluconazole | Folpet | thiophanate-methyl |
| 973. | Ipfentrifluconazole | Copper salts | thiophanate-methyl |
| 974. | Ipfentrifluconazole | chlorothalonil | thiophanate-methyl |
| 975. | Ipfentrifluconazole | sulphur | thiophanate-methyl |
| 976. | Ipfentrifluconazole | Captan | thiophanate-methyl |
| 977. | Ipfentrifluconazole | Propineb | thiophanate-methyl |
| 978. | Ipfentrifluconazole | Maneb | thiophanate-methyl |
| 979. | Ipfentrifluconazole | Thiram | thiophanate-methyl |
| 980. | Ipfentrifluconazole | Zineb | thiophanate-methyl |
| 981. | Ipfentrifluconazole | mancozeb | zoxamide |
| 982. | Ipfentrifluconazole | Folpet | zoxamide |
| 983. | Ipfentrifluconazole | Copper salts | zoxamide |
| 984. | Ipfentrifluconazole | chlorothalonil | zoxamide |
| 985. | Ipfentrifluconazole | sulphur | zoxamide |
| 986. | Ipfentrifluconazole | Captan | zoxamide |
| 987. | Ipfentrifluconazole | Propineb | zoxamide |
| 988. | Ipfentrifluconazole | Maneb | zoxamide |
| 989. | Ipfentrifluconazole | Thiram | zoxamide |
| 990. | Ipfentrifluconazole | Zineb | zoxamide |
| 991. | Ipfentrifluconazole | mancozeb | fluopicolide |
| 992. | Ipfentrifluconazole | Folpet | fluopicolide |
| 993. | Ipfentrifluconazole | Copper salts | fluopicolide |
| 994. | Ipfentrifluconazole | chlorothalonil | fluopicolide |
| 995. | Ipfentrifluconazole | sulphur | fluopicolide |
| 996. | Ipfentrifluconazole | Captan | fluopicolide |
| 997. | Ipfentrifluconazole | Propineb | fluopicolide |
| 998. | Ipfentrifluconazole | Maneb | fluopicolide |
| 999. | Ipfentrifluconazole | Thiram | fluopicolide |
| 1000. | Ipfentrifluconazole | Zineb | fluopicolide |
| 1001. | Ipfentrifluconazole | mancozeb | phenamacril |
| 1002. | Ipfentrifluconazole | Folpet | phenamacril |
| 1003. | Ipfentrifluconazole | Copper salts | phenamacril |
| 1004. | Ipfentrifluconazole | chlorothalonil | phenamacril |
| 1005. | Ipfentrifluconazole | sulphur | phenamacril |
| 1006. | Ipfentrifluconazole | Captan | phenamacril |
| 1007. | Ipfentrifluconazole | Propineb | phenamacril |
| 1008. | Ipfentrifluconazole | Maneb | phenamacril |
| 1009. | Ipfentrifluconazole | Thiram | phenamacril |
| 1010. | Ipfentrifluconazole | Zineb | phenamacril |
| 1011. | Ipfentrifluconazole | mancozeb | cyazofamid |
| 1012. | Ipfentrifluconazole | Folpet | cyazofamid |
| 1013. | Ipfentrifluconazole | Copper salts | cyazofamid |
| 1014. | Ipfentrifluconazole | chlorothalonil | cyazofamid |
| 1015. | Ipfentrifluconazole | sulphur | cyazofamid |
| 1016. | Ipfentrifluconazole | Captan | cyazofamid |
| 1017. | Ipfentrifluconazole | Propineb | cyazofamid |
| 1018. | Ipfentrifluconazole | Maneb | cyazofamid |
| 1019. | Ipfentrifluconazole | Thiram | cyazofamid |
| 1020. | Ipfentrifluconazole | Zineb | cyazofamid |
| 1021. | Ipfentrifluconazole | mancozeb | amisulbrom |
| 1022. | Ipfentrifluconazole | Folpet | amisulbrom |
| 1023. | Ipfentrifluconazole | Copper salts | amisulbrom |
| 1024. | Ipfentrifluconazole | chlorothalonil | amisulbrom |
| 1025. | Ipfentrifluconazole | sulphur | amisulbrom |
| 1026. | Ipfentrifluconazole | Captan | amisulbrom |
| 1027. | Ipfentrifluconazole | Propineb | amisulbrom |
| 1028. | Ipfentrifluconazole | Maneb | amisulbrom |
| 1029. | Ipfentrifluconazole | Thiram | amisulbrom |
| 1030. | Ipfentrifluconazole | Zineb | amisulbrom |
| 1031. | Ipfentrifluconazole | mancozeb | tricyclazole |
| 1032. | Ipfentrifluconazole | Folpet | tricyclazole |
| 1033. | Ipfentrifluconazole | Copper salts | tricyclazole |
| 1034. | Ipfentrifluconazole | chlorothalonil | tricyclazole |
| 1035. | Ipfentrifluconazole | sulphur | Tricyclazole |
| 1036. | Ipfentrifluconazole | Captan | Tricyclazole |
| 1037. | Ipfentrifluconazole | Propineb | Tricyclazole |
| 1038. | Ipfentrifluconazole | Maneb | Tricyclazole |
| 1039. | Ipfentrifluconazole | Thiram | Tricyclazole |
| 1040. | Ipfentrifluconazole | Zineb | Tricyclazole |
| 1041. | Ipfentrifluconazole | mancozeb | oxathiapiprolin |
| 1042. | Ipfentrifluconazole | Folpet | oxathiapiprolin |
| 1043. | Ipfentrifluconazole | Copper salts | oxathiapiprolin |
| 1044. | Ipfentrifluconazole | chlorothalonil | oxathiapiprolin |
| 1045. | Ipfentrifluconazole | sulphur | oxathiapiprolin |
| 1046. | Ipfentrifluconazole | Captan | oxathiapiprolin |
| 1047. | Ipfentrifluconazole | Propineb | oxathiapiprolin |
| 1048. | Ipfentrifluconazole | Maneb | oxathiapiprolin |
| 1049. | Ipfentrifluconazole | Thiram | oxathiapiprolin |
| 1050. | Ipfentrifluconazole | Zineb | oxathiapiprolin |
| 1051. | Ipfentrifluconazole | mancozeb | picarbutrazox |
| 1052. | Ipfentrifluconazole | Folpet | picarbutrazox |
| 1053. | Ipfentrifluconazole | Copper salts | picarbutrazox |
| 1054. | Ipfentrifluconazole | chlorothalonil | picarbutrazox |
| 1055. | Ipfentrifluconazole | sulphur | picarbutrazox |
| 1056. | Ipfentrifluconazole | Captan | picarbutrazox |
| 1057. | Ipfentrifluconazole | Propineb | picarbutrazox |
| 1058. | Ipfentrifluconazole | Maneb | picarbutrazox |
| 1059. | Ipfentrifluconazole | Thiram | picarbutrazox |
| 1060. | Ipfentrifluconazole | Zineb | picarbutrazox |
| 1061. | Ipfentrifluconazole | mancozeb | azoxystrobin |
| 1062. | Ipfentrifluconazole | Folpet | azoxystrobin |
| 1063. | Ipfentrifluconazole | Copper salts | azoxystrobin |
| 1064. | Ipfentrifluconazole | chlorothalonil | azoxystrobin |
| 1065. | Ipfentrifluconazole | sulphur | azoxystrobin |
| 1066. | Ipfentrifluconazole | Captan | azoxystrobin |
| 1067. | Ipfentrifluconazole | Propineb | azoxystrobin |
| 1068. | Ipfentrifluconazole | Maneb | azoxystrobin |
| 1069. | Ipfentrifluconazole | Thiram | azoxystrobin |
| 1070. | Ipfentrifluconazole | Zineb | azoxystrobin |
| 1071. | Ipfentrifluconazole | mancozeb | picoxystrobin |
| 1072. | Ipfentrifluconazole | Folpet | picoxystrobin |
| 1073. | Ipfentrifluconazole | Copper salts | picoxystrobin |
| 1074. | Ipfentrifluconazole | chlorothalonil | picoxystrobin |
| 1075. | Ipfentrifluconazole | sulphur | picoxystrobin |
| 1076. | Ipfentrifluconazole | Captan | picoxystrobin |
| 1077. | Ipfentrifluconazole | Propineb | picoxystrobin |
| 1078. | Ipfentrifluconazole | Maneb | picoxystrobin |
| 1079. | Ipfentrifluconazole | Thiram | picoxystrobin |
| 1080. | Ipfentrifluconazole | Zineb | picoxystrobin |
| 1081. | Ipfentrifluconazole | mancozeb | pyraclostrobin |
| 1082. | Ipfentrifluconazole | Folpet | pyraclostrobin |
| 1083. | Ipfentrifluconazole | Copper salts | pyraclostrobin |
| 1084. | Ipfentrifluconazole | chlorothalonil | pyraclostrobin |
| 1085. | Ipfentrifluconazole | sulphur | pyraclostrobin |
| 1086. | Ipfentrifluconazole | Captan | pyraclostrobin |
| 1087. | Ipfentrifluconazole | Propineb | pyraclostrobin |
| 1088. | Ipfentrifluconazole | Maneb | pyraclostrobin |
| 1089. | Ipfentrifluconazole | Thiram | pyraclostrobin |
| 1090. | Ipfentrifluconazole | Zineb | pyraclostrobin |
| 1091. | Ipfentrifluconazole | mancozeb | kresoxim-methyl |
| 1092. | Ipfentrifluconazole | Folpet | kresoxim-methyl |
| 1093. | Ipfentrifluconazole | Copper salts | kresoxim-methyl |
| 1094. | Ipfentrifluconazole | chlorothalonil | kresoxim-methyl |
| 1095. | Ipfentrifluconazole | Sulphur | kresoxim-methyl |
| 1096. | Ipfentrifluconazole | Captan | kresoxim-methyl |
| 1097. | Ipfentrifluconazole | Propineb | kresoxim-methyl |
| 1098. | Ipfentrifluconazole | Maneb | kresoxim-methyl |
| 1099. | Ipfentrifluconazole | Thiram | kresoxim-methyl |
| 1100. | Ipfentrifluconazole | Zineb | kresoxim-methyl |
| 1101. | Ipfentrifluconazole | Mancozeb | trifloxystrobin |
| 1102. | Ipfentrifluconazole | Folpet | trifloxystrobin |
| 1103. | Ipfentrifluconazole | Copper salts | trifloxystrobin |
| 1104. | Ipfentrifluconazole | chlorothalonil | trifloxystrobin |
| 1105. | Ipfentrifluconazole | sulphur | trifloxystrobin |
| 1106. | Ipfentrifluconazole | Captan | trifloxystrobin |
| 1107. | Ipfentrifluconazole | Propineb | trifloxystrobin |
| 1108. | Ipfentrifluconazole | Maneb | trifloxystrobin |
| 1109. | Ipfentrifluconazole | Thiram | trifloxystrobin |
| 1110. | Ipfentrifluconazole | Zineb | trifloxystrobin |
| 1111. | Ipfentrifluconazole | mancozeb | Copper oxychloride |
| 1112. | Ipfentrifluconazole | Folpet | Copper oxychloride |
| 1113. | Ipfentrifluconazole | Copper salts | Copper oxychloride |
| 1114. | Ipfentrifluconazole | chlorothalonil | Copper oxychloride |
| 1115. | Ipfentrifluconazole | sulphur | Copper oxychloride |
| 1116. | Ipfentrifluconazole | Captan | Copper oxychloride |
| 1117. | Ipfentrifluconazole | Propineb | Copper oxychloride |
| 1118. | Ipfentrifluconazole | Maneb | Copper oxychloride |
| 1119. | Ipfentrifluconazole | Thiram | Copper oxychloride |
| 1120. | Ipfentrifluconazole | Zineb | Copper oxychloride |
| 1121. | Ipfentrifluconazole | mancozeb | Aminopyrifen |
| 1122. | Ipfentrifluconazole | Folpet | Aminopyrifen |
| 1123. | Ipfentrifluconazole | Copper salts | Aminopyrifen |
| 1124. | Ipfentrifluconazole | chlorothalonil | Aminopyrifen |
| 1125. | Ipfentrifluconazole | sulphur | Aminopyrifen |
| 1126. | Ipfentrifluconazole | Captan | Aminopyrifen |
| 1127. | Ipfentrifluconazole | Propineb | Aminopyrifen |
| 1128. | Ipfentrifluconazole | Maneb | Aminopyrifen |
| 1129. | Ipfentrifluconazole | Thiram | Aminopyrifen |
| 1130. | Ipfentrifluconazole | Zineb | Aminopyrifen |
| 1131. | Ipfentrifluconazole | mancozeb | Inpyrfluxam |
| 1132. | Ipfentrifluconazole | Folpet | Inpyrfluxam |
| 1133. | Ipfentrifluconazole | Copper salts | Inpyrfluxam |
| 1134. | Ipfentrifluconazole | chlorothalonil | Inpyrfluxam |
| 1135. | Ipfentrifluconazole | sulphur | Inpyrfluxam |
| 1136. | Ipfentrifluconazole | Captan | Inpyrfluxam |
| 1137. | Ipfentrifluconazole | Propineb | Inpyrfluxam |
| 1138. | Ipfentrifluconazole | Maneb | Inpyrfluxam |
| 1139. | Ipfentrifluconazole | Thiram | Inpyrfluxam |
| 1140. | Ipfentrifluconazole | Zineb | Inpyrfluxam |
| 1141. | Ipfentrifluconazole | mancozeb | Pyridachlometyl |
| 1142. | Ipfentrifluconazole | Folpet | Pyridachlometyl |
| 1143. | Ipfentrifluconazole | Copper salts | Pyridachlometyl |
| 1144. | Ipfentrifluconazole | chlorothalonil | Pyridachlometyl |
| 1145. | Ipfentrifluconazole | sulphur | Pyridachlometyl |
| 1146. | Ipfentrifluconazole | Captan | Pyridachlometyl |
| 1147. | Ipfentrifluconazole | Propineb | Pyridachlometyl |
| 1148. | Ipfentrifluconazole | Maneb | Pyridachlometyl |
| 1149. | Ipfentrifluconazole | Thiram | Pyridachlometyl |
| 1150. | Ipfentrifluconazole | Zineb | Pyridachlometyl |
| 1151. | Ipfentrifluconazole | mancozeb | Fluopimomide |
| 1152. | Ipfentrifluconazole | Folpet | Fluopimomide |
| 1153. | Ipfentrifluconazole | Copper salts | Fluopimomide |
| 1154. | Ipfentrifluconazole | chlorothalonil | Fluopimomide |
| 1155. | Ipfentrifluconazole | sulphur | Fluopimomide |
| 1156. | Ipfentrifluconazole | Captan | Fluopimomide |
| 1157. | Ipfentrifluconazole | Propineb | Fluopimomide |
| 1158. | Ipfentrifluconazole | Maneb | Fluopimomide |
| 1159. | Ipfentrifluconazole | Thiram | Fluopimomide |
| 1160. | Ipfentrifluconazole | Zineb | Fluopimomide |
| 1161. | Ipfentrifluconazole | mancozeb | Ipflufenoquin |
| 1162. | Ipfentrifluconazole | Folpet | Ipflufenoquin |
| 1163. | Ipfentrifluconazole | Copper salts | Ipflufenoquin |
| 1164. | Ipfentrifluconazole | chlorothalonil | Ipflufenoquin |
| 1165. | Ipfentrifluconazole | sulphur | Ipflufenoquin |
| 1166. | Ipfentrifluconazole | Captan | Ipflufenoquin |
| 1167. | Ipfentrifluconazole | Propineb | Ipflufenoquin |
| 1168. | Ipfentrifluconazole | Maneb | Ipflufenoquin |
| 1169. | Ipfentrifluconazole | Thiram | Ipflufenoquin |
| 1170. | Ipfentrifluconazole | Zineb | Ipflufenoquin |
| 1171. | Ipfentrifluconazole | mancozeb | Metyltetraprole |
| 1172. | Ipfentrifluconazole | Folpet | Metyltetraprole |
| 1173. | Ipfentrifluconazole | Copper salts | Metyltetraprole |
| 1174. | Ipfentrifluconazole | chlorothalonil | Metyltetraprole |
| 1175. | Ipfentrifluconazole | sulphur | Metyltetraprole |
| 1176. | Ipfentrifluconazole | Captan | Metyltetraprole |
| 1177. | Ipfentrifluconazole | Propineb | Metyltetraprole |
| 1178. | Ipfentrifluconazole | Maneb | Metyltetraprole |
| 1179. | Ipfentrifluconazole | Thiram | Metyltetraprole |
| 1180. | Ipfentrifluconazole | Zineb | Metyltetraprole |
| 1181. | Ipfentrifluconazole | mancozeb | Florylpicoxamid |
| 1182. | Ipfentrifluconazole | Folpet | Florylpicoxamid |
| 1183. | Ipfentrifluconazole | Copper salts | Florylpicoxamid |
| 1184. | Ipfentrifluconazole | chlorothalonil | Florylpicoxamid |
| 1185. | Ipfentrifluconazole | sulphur | Florylpicoxamid |
| 1186. | Ipfentrifluconazole | Captan | Florylpicoxamid |
| 1187. | Ipfentrifluconazole | Propineb | Florylpicoxamid |
| 1188. | Ipfentrifluconazole | Maneb | Florylpicoxamid |
| 1189. | Ipfentrifluconazole | Thiram | Florylpicoxamid |
| 1190. | Ipfentrifluconazole | Zineb | Florylpicoxamid |
| 1191. | Ipfentrifluconazole | mancozeb | Pyrapropoyne |
| 1192. | Ipfentrifluconazole | Folpet | Pyrapropoyne |
| 1193. | Ipfentrifluconazole | Copper salts | Pyrapropoyne |
| 1194. | Ipfentrifluconazole | chlorothalonil | Pyrapropoyne |
| 1195. | Ipfentrifluconazole | sulphur | Pyrapropoyne |
| 1196. | Ipfentrifluconazole | Captan | Pyrapropoyne |
| 1197. | Ipfentrifluconazole | Propineb | Pyrapropoyne |
| 1198. | Ipfentrifluconazole | Maneb | Pyrapropoyne |
| 1199. | Ipfentrifluconazole | Thiram | Pyrapropoyne |
| 1200. | Ipfentrifluconazole | Zineb | Pyrapropoyne |
| 1201. | Ipfentrifluconazole | mancozeb | Isoflucypram |
| 1202. | Ipfentrifluconazole | Folpet | Isoflucypram |
| 1203. | Ipfentrifluconazole | Copper salts | Isoflucypram |
| 1204. | Ipfentrifluconazole | chlorothalonil | Isoflucypram |
| 1205. | Ipfentrifluconazole | sulphur | Isoflucypram |
| 1206. | Ipfentrifluconazole | Captan | Isoflucypram |
| 1207. | Ipfentrifluconazole | Propineb | Isoflucypram |
| 1208. | Ipfentrifluconazole | Maneb | Isoflucypram |
| 1209. | Ipfentrifluconazole | Thiram | Isoflucypram |
| 1210. | Ipfentrifluconazole | Zineb | Isoflucypram |
| 1211. | Ipfentrifluconazole | mancozeb | Fenpicoxamid |
| 1212. | Ipfentrifluconazole | Folpet | Fenpicoxamid |
| 1213. | Ipfentrifluconazole | Copper salts | Fenpicoxamid |
| 1214. | Ipfentrifluconazole | chlorothalonil | Fenpicoxamid |
| 1215. | Ipfentrifluconazole | sulphur | Fenpicoxamid |
| 1216. | Ipfentrifluconazole | Captan | Fenpicoxamid |
| 1217. | Ipfentrifluconazole | Propineb | Fenpicoxamid |
| 1218. | Ipfentrifluconazole | Maneb | Fenpicoxamid |
| 1219. | Ipfentrifluconazole | Thiram | Fenpicoxamid |
| 1220. | Ipfentrifluconazole | Zineb | Fenpicoxamid |
| 1221. | Ipfentrifluconazole | mancozeb | Dichlobentiazox |
| 1222. | Ipfentrifluconazole | Folpet | Dichlobentiazox |
| 1223. | Ipfentrifluconazole | Copper salts | Dichlobentiazox |
| 1224. | Ipfentrifluconazole | chlorothalonil | Dichlobentiazox |
| 1225. | Ipfentrifluconazole | sulphur | Dichlobentiazox |
| 1226. | Ipfentrifluconazole | Captan | Dichlobentiazox |
| 1227. | Ipfentrifluconazole | Propineb | Dichlobentiazox |
| 1228. | Ipfentrifluconazole | Maneb | Dichlobentiazox |
| 1229. | Ipfentrifluconazole | Thiram | Dichlobentiazox |
| 1230. | Ipfentrifluconazole | Zineb | Dichlobentiazox |
| 1231. | Ipfentrifluconazole | mancozeb | Quinofumelin |
| 1232. | Ipfentrifluconazole | Folpet | Quinofumelin |
| 1233. | Ipfentrifluconazole | Copper salts | Quinofumelin |
| 1234. | Ipfentrifluconazole | chlorothalonil | Quinofumelin |
| 1235. | Ipfentrifluconazole | sulphur | Quinofumelin |
| 1236. | Ipfentrifluconazole | Captan | Quinofumelin |
| 1237. | Ipfentrifluconazole | Propineb | Quinofumelin |
| 1238. | Ipfentrifluconazole | Maneb | Quinofumelin |
| 1239. | Ipfentrifluconazole | Thiram | Quinofumelin |
| 1240. | Ipfentrifluconazole | Zineb | Quinofumelin |
| 1241. | Ipfentrifluconazole | mancozeb | Mefentrilpfentrifluconazole |
| 1242. | Ipfentrifluconazole | Folpet | Mefentrilpfentrifluconazole |
| 1243. | Ipfentrifluconazole | Copper salts | Mefentrilpfentrifluconazole |
| 1244. | Ipfentrifluconazole | chlorothalonil | Mefentrilpfentrifluconazole |
| 1245. | Ipfentrifluconazole | sulphur | Mefentrilpfentrifluconazole |
| 1246. | Ipfentrifluconazole | Captan | Mefentrilpfentrifluconazole |
| 1247. | Ipfentrifluconazole | Propineb | Mefentrilpfentrifluconazole |
| 1248. | Ipfentrifluconazole | Maneb | Mefentrilpfentrifluconazole |
| 1249. | Ipfentrifluconazole | Thiram | Mefentrilpfentrifluconazole |
| 1250. | Ipfentrifluconazole | Zineb | Mefentrilpfentrifluconazole |
| 1251. | Mefentrifluconazole | mancozeb | isopyrazam |
| 1252. | Mefentrifluconazole | Folpet | isopyrazam |
| 1253. | Mefentrifluconazole | Copper salts | isopyrazam |
| 1254. | Mefentrifluconazole | chlorothalonil | isopyrazam |
| 1255. | Mefentrifluconazole | sulphur | isopyrazam |
| 1256. | Mefentrifluconazole | Captan | isopyrazam |
| 1257. | Mefentrifluconazole | Propineb | isopyrazam |
| 1258. | Mefentrifluconazole | Maneb | isopyrazam |
| 1259. | Mefentrifluconazole | Thiram | isopyrazam |
| 1260. | Mefentrifluconazole | Zineb | isopyrazam |
| 1261. | Mefentrifluconazole | mancozeb | benzovindiflupyr |
| 1262. | Mefentrifluconazole | Folpet | benzovindiflupyr |
| 1263. | Mefentrifluconazole | Copper salts | benzovindiflupyr |
| 1264. | Mefentrifluconazole | chlorothalonil | benzovindiflupyr |
| 1265. | Mefentrifluconazole | sulphur | benzovindiflupyr |
| 1266. | Mefentrifluconazole | Captan | benzovindiflupyr |
| 1267. | Mefentrifluconazole | Propineb | benzovindiflupyr |
| 1268. | Mefentrifluconazole | Maneb | benzovindiflupyr |
| 1269. | Mefentrifluconazole | Thiram | benzovindiflupyr |
| 1270. | Mefentrifluconazole | Zineb | benzovindiflupyr |
| 1271. | Mefentrifluconazole | mancozeb | penthiopyrad |
| 1272. | Mefentrifluconazole | Folpet | penthiopyrad |
| 1273. | Mefentrifluconazole | Copper salts | penthiopyrad |
| 1274. | Mefentrifluconazole | chlorothalonil | penthiopyrad |
| 1275. | Mefentrifluconazole | sulphur | penthiopyrad |
| 1276. | Mefentrifluconazole | Captan | penthiopyrad |
| 1277. | Mefentrifluconazole | Propineb | penthiopyrad |
| 1278. | Mefentrifluconazole | Maneb | penthiopyrad |
| 1279. | Mefentrifluconazole | Thiram | penthiopyrad |
| 1280. | Mefentrifluconazole | Zineb | penthiopyrad |
| 1281. | Mefentrifluconazole | mancozeb | Fentine Hydroxide |
| 1282. | Mefentrifluconazole | Folpet | Fentine Hydroxide |
| 1283. | Mefentrifluconazole | Copper salts | Fentine Hydroxide |
| 1284. | Mefentrifluconazole | chlorothalonil | Fentine Hydroxide |
| 1285. | Mefentrifluconazole | sulphur | Fentine Hydroxide |
| 1286. | Mefentrifluconazole | Captan | Fentine Hydroxide |
| 1287. | Mefentrifluconazole | Propineb | Fentine Hydroxide |
| 1288. | Mefentrifluconazole | Maneb | Fentine Hydroxide |
| 1289. | Mefentrifluconazole | Thiram | Fentine Hydroxide |
| 1290. | Mefentrifluconazole | Zineb | Fentine Hydroxide |
| 1291. | Mefentrifluconazole | mancozeb | boscalid |
| 1292. | Mefentrifluconazole | Folpet | boscalid |
| 1293. | Mefentrifluconazole | Copper salts | boscalid |
| 1294. | Mefentrifluconazole | chlorothalonil | boscalid |
| 1295. | Mefentrifluconazole | sulphur | boscalid |
| 1296. | Mefentrifluconazole | Captan | boscalid |
| 1297. | Mefentrifluconazole | Propineb | boscalid |
| 1298. | Mefentrifluconazole | Maneb | boscalid |
| 1299. | Mefentrifluconazole | Thiram | boscalid |
| 1300. | Mefentrifluconazole | Zineb | boscalid |
| 1301. | Mefentrifluconazole | mancozeb | Fluindapyr |
| 1302. | Mefentrifluconazole | Folpet | Fluindapyr |
| 1303. | Mefentrifluconazole | Copper salts | Fluindapyr |
| 1304. | Mefentrifluconazole | chlorothalonil | Fluindapyr |
| 1305. | Mefentrifluconazole | Sulphur | Fluindapyr |
| 1306. | Mefentrifluconazole | Captan | Fluindapyr |
| 1307. | Mefentrifluconazole | Propineb | Fluindapyr |
| 1308. | Mefentrifluconazole | Maneb | Fluindapyr |
| 1309. | Mefentrifluconazole | Thiram | Fluindapyr |
| 1310. | Mefentrifluconazole | Zineb | Fluindapyr |
| 1311. | Mefentrifluconazole | mancozeb | bixafen |
| 1312. | Mefentrifluconazole | Folpet | bixafen |
| 1313. | Mefentrifluconazole | Copper salts | bixafen |
| 1314. | Mefentrifluconazole | chlorothalonil | bixafen |
| 1315. | Mefentrifluconazole | sulphur | bixafen |
| 1316. | Mefentrifluconazole | Captan | bixafen |
| 1317. | Mefentrifluconazole | Propineb | bixafen |
| 1318. | Mefentrifluconazole | Maneb | bixafen |
| 1319. | Mefentrifluconazole | Thiram | bixafen |
| 1320. | Mefentrifluconazole | Zineb | bixafen |
| 1321. | Mefentrifluconazole | mancozeb | fluxapyroxad |
| 1322. | Mefentrifluconazole | Folpet | fluxapyroxad |
| 1323. | Mefentrifluconazole | Copper salts | fluxapyroxad |
| 1324. | Mefentrifluconazole | chlorothalonil | fluxapyroxad |
| 1325. | Mefentrifluconazole | sulphur | fluxapyroxad |
| 1326. | Mefentrifluconazole | Captan | fluxapyroxad |
| 1327. | Mefentrifluconazole | Propineb | fluxapyroxad |
| 1328. | Mefentrifluconazole | Maneb | fluxapyroxad |
| 1329. | Mefentrifluconazole | Thiram | fluxapyroxad |
| 1330. | Mefentrifluconazole | Zineb | fluxapyroxad |
| 1331. | Mefentrifluconazole | mancozeb | furametpyr |
| 1332. | Mefentrifluconazole | Folpet | furametpyr |
| 1333. | Mefentrifluconazole | Copper salts | furametpyr |
| 1334. | Mefentrifluconazole | chlorothalonil | furametpyr |
| 1335. | Mefentrifluconazole | sulphur | furametpyr |
| 1336. | Mefentrifluconazole | Captan | furametpyr |
| 1337. | Mefentrifluconazole | Propineb | furametpyr |
| 1338. | Mefentrifluconazole | Maneb | furametpyr |
| 1339. | Mefentrifluconazole | Thiram | furametpyr |
| 1340. | Mefentrifluconazole | Zineb | furametpyr |
| 1341. | Mefentrifluconazole | mancozeb | penflufen |
| 1342. | Mefentrifluconazole | Folpet | penflufen |
| 1343. | Mefentrifluconazole | Copper salts | penflufen |
| 1344. | Mefentrifluconazole | chlorothalonil | penflufen |
| 1345. | Mefentrifluconazole | sulphur | penflufen |
| 1346. | Mefentrifluconazole | Captan | penflufen |
| 1347. | Mefentrifluconazole | Propineb | penflufen |
| 1348. | Mefentrifluconazole | Maneb | penflufen |
| 1349. | Mefentrifluconazole | Thiram | penflufen |
| 1350. | Mefentrifluconazole | Zineb | penflufen |
| 1351. | Mefentrifluconazole | mancozeb | 3-difluoromethyl-N- |
| | | | (7-fluoro-1,1,3- |
| | | | trimethyl-4-indanyl)- |
| | | | l-methyl-4- |
| | | | pyrazolecarboxamide |
| 1352. | Mefentrifluconazole | Folpet | 3-difluoromethyl-N- |
| | | | (7-fluoro-1,1,3- |
| | | | trimethyl-4-indanyl)- |
| | | | l-methyl-4- |
| | | | pyrazolecarboxamide |
| 1353. | Mefentrifluconazole | Copper salts | 3-difluoromethyl-N- |
| | | | (7-fluoro-1,1,3- |
| | | | trimethyl-4-indanyl)- |
| | | | l-methyl-4- |
| | | | pyrazolecarboxamide |
| 1354. | Mefentrifluconazole | chlorothalonil | 3-difluoromethyl-N- |
| | | | (7-fluoro-1,1,3- |
| | | | trimethyl-4-indanyl)- |
| | | | l-methyl-4- |
| | | | pyrazolecarboxamide |
| 1355. | Mefentrifluconazole | sulphur | 3-difluoromethyl-N- |
| | | | (7-fluoro-1,1,3- |
| | | | trimethyl-4-indanyl)- |
| | | | l-methyl-4- |
| | | | pyrazolecarboxamide |
| 1356. | Mefentrifluconazole | Captan | 3-difluoromethyl-N- |
| | | | (7-fluoro-1,1,3- |
| | | | trimethyl-4-indanyl)- |
| | | | l-methyl-4- |
| | | | pyrazolecarboxamide |
| 1357. | Mefentrifluconazole | Propineb | 3-difluoromethyl-N- |
| | | | (7-fluoro-1,1,3- |
| | | | trimethyl-4-indanyl)- |
| | | | l-methyl-4- |
| | | | pyrazolecarboxamide |
| 1358. | Mefentrifluconazole | Maneb | 3-difluoromethyl-N- |
| | | | (7-fluoro-1,1,3- |
| | | | trimethyl-4-indanyl)- |
| | | | l-methyl-4- |
| | | | pyrazolecarboxamide |
| 1359. | Mefentrifluconazole | Thiram | 3-difluoromethyl-N- |
| | | | (7-fluoro-1,1,3- |
| | | | trimethyl-4-indanyl)- |
| | | | l-methyl-4- |
| | | | pyrazolecarboxamide |
| 1360. | Mefentrifluconazole | Zineb | 3-difluoromethyl-N- |
| | | | (7-fluoro-1,1,3- |
| | | | trimethyl-4-indanyl)- |
| | | | l-methyl-4- |
| | | | pyrazolecarboxamide |
| 1361. | Mefentrifluconazole | mancozeb | sedaxane |
| 1362. | Mefentrifluconazole | Folpet | sedaxane |
| 1363. | Mefentrifluconazole | Copper salts | sedaxane |
| 1364. | Mefentrifluconazole | chlorothalonil | sedaxane |
| 1365. | Mefentrifluconazole | sulphur | sedaxane |
| 1366. | Mefentrifluconazole | Captan | sedaxane |
| 1367. | Mefentrifluconazole | Propineb | sedaxane |
| 1368. | Mefentrifluconazole | Maneb | sedaxane |
| 1369. | Mefentrifluconazole | Thiram | sedaxane |
| 1370. | Mefentrifluconazole | Zineb | sedaxane |
| 1371. | Mefentrifluconazole | mancozeb | benodanil |
| 1372. | Mefentrifluconazole | Folpet | benodanil |
| 1373. | Mefentrifluconazole | Copper salts | benodanil |
| 1374. | Mefentrifluconazole | chlorothalonil | benodanil |
| 1375. | Mefentrifluconazole | sulphur | benodanil |
| 1376. | Mefentrifluconazole | Captan | benodanil |
| 1377. | Mefentrifluconazole | Propineb | benodanil |
| 1378. | Mefentrifluconazole | Maneb | benodanil |
| 1379. | Mefentrifluconazole | Thiram | benodanil |
| 1380. | Mefentrifluconazole | Zineb | benodanil |
| 1381. | Mefentrifluconazole | mancozeb | flutolanil |
| 1382. | Mefentrifluconazole | Folpet | flutolanil |
| 1383. | Mefentrifluconazole | Copper salts | flutolanil |
| 1384. | Mefentrifluconazole | chlorothalonil | flutolanil |
| 1385. | Mefentrifluconazole | sulphur | flutolanil |
| 1386. | Mefentrifluconazole | Captan | flutolanil |
| 1387. | Mefentrifluconazole | Propineb | flutolanil |
| 1388. | Mefentrifluconazole | Maneb | flutolanil |
| 1389. | Mefentrifluconazole | Thiram | flutolanil |
| 1390. | Mefentrifluconazole | Zineb | flutolanil |
| 1391. | Mefentrifluconazole | mancozeb | mepronil |
| 1392. | Mefentrifluconazole | Folpet | mepronil |
| 1393. | Mefentrifluconazole | Copper salts | mepronil |
| 1394. | Mefentrifluconazole | chlorothalonil | mepronil |
| 1395. | Mefentrifluconazole | sulphur | mepronil |
| 1396. | Mefentrifluconazole | Captan | mepronil |
| 1397. | Mefentrifluconazole | Propineb | mepronil |
| 1398. | Mefentrifluconazole | Maneb | mepronil |
| 1399. | Mefentrifluconazole | Thiram | mepronil |
| 1400. | Mefentrifluconazole | Zineb | mepronil |
| 1401. | Mefentrifluconazole | mancozeb | isofetamid |
| 1402. | Mefentrifluconazole | Folpet | isofetamid |
| 1403. | Mefentrifluconazole | Copper salts | isofetamid |
| 1404. | Mefentrifluconazole | chlorothalonil | isofetamid |
| 1405. | Mefentrifluconazole | sulphur | isofetamid |
| 1406. | Mefentrifluconazole | Captan | isofetamid |
| 1407. | Mefentrifluconazole | Propineb | isofetamid |
| 1408. | Mefentrifluconazole | Maneb | isofetamid |
| 1409. | Mefentrifluconazole | Thiram | isofetamid |
| 1410. | Mefentrifluconazole | Zineb | isofetamid |
| 1411. | Mefentrifluconazole | mancozeb | fluopyram |
| 1412. | Mefentrifluconazole | Folpet | fluopyram |
| 1413. | Mefentrifluconazole | Copper salts | fluopyram |
| 1414. | Mefentrifluconazole | chlorothalonil | fluopyram |
| 1415. | Mefentrifluconazole | sulphur | fluopyram |
| 1416. | Mefentrifluconazole | Captan | fluopyram |
| 1417. | Mefentrifluconazole | Propineb | fluopyram |
| 1418. | Mefentrifluconazole | Maneb | fluopyram |
| 1419. | Mefentrifluconazole | Thiram | fluopyram |
| 1420. | Mefentrifluconazole | Zineb | fluopyram |
| 1421. | Mefentrifluconazole | mancozeb | fenfuram |
| 1422. | Mefentrifluconazole | Folpet | fenfuram |
| 1423. | Mefentrifluconazole | Copper salts | fenfuram |
| 1424. | Mefentrifluconazole | chlorothalonil | fenfuram |
| 1425. | Mefentrifluconazole | sulphur | fenfuram |
| 1426. | Mefentrifluconazole | Captan | fenfuram |
| 1427. | Mefentrifluconazole | Propineb | fenfuram |
| 1428. | Mefentrifluconazole | Maneb | fenfuram |
| 1429. | Mefentrifluconazole | Thiram | fenfuram |
| 1430. | Mefentrifluconazole | Zineb | fenfuram |
| 1431. | Mefentrifluconazole | mancozeb | carboxin |
| 1432. | Mefentrifluconazole | Folpet | carboxin |
| 1433. | Mefentrifluconazole | Copper salts | carboxin |
| 1434. | Mefentrifluconazole | chlorothalonil | carboxin |
| 1435. | Mefentrifluconazole | sulphur | carboxin |
| 1436. | Mefentrifluconazole | Captan | carboxin |
| 1437. | Mefentrifluconazole | Propineb | carboxin |
| 1438. | Mefentrifluconazole | Maneb | carboxin |
| 1439. | Mefentrifluconazole | Thiram | carboxin |
| 1440. | Mefentrifluconazole | Zineb | carboxin |
| 1441. | Mefentrifluconazole | mancozeb | oxycarboxin |
| 1442. | Mefentrifluconazole | Folpet | oxycarboxin |
| 1443. | Mefentrifluconazole | Copper salts | oxycarboxin |
| 1444. | Mefentrifluconazole | chlorothalonil | oxycarboxin |
| 1445. | Mefentrifluconazole | sulphur | oxycarboxin |
| 1446. | Mefentrifluconazole | Captan | oxycarboxin |
| 1447. | Mefentrifluconazole | Propineb | oxycarboxin |
| 1448. | Mefentrifluconazole | Maneb | oxycarboxin |
| 1449. | Mefentrifluconazole | Thiram | oxycarboxin |
| 1450. | Mefentrifluconazole | Zineb | oxycarboxin |
| 1451. | Mefentrifluconazole | mancozeb | thifluzamide |
| 1452. | Mefentrifluconazole | Folpet | thifluzamide |
| 1453. | Mefentrifluconazole | Copper salts | thifluzamide |
| 1454. | Mefentrifluconazole | chlorothalonil | thifluzamide |
| 1455. | Mefentrifluconazole | sulphur | thifluzamide |
| 1456. | Mefentrifluconazole | Captan | thifluzamide |
| 1457. | Mefentrifluconazole | Propineb | thifluzamide |
| 1458. | Mefentrifluconazole | Maneb | thifluzamide |
| 1459. | Mefentrifluconazole | Thiram | thifluzamide |
| 1460. | Mefentrifluconazole | Zineb | thifluzamide |
| 1461. | Mefentrifluconazole | mancozeb | pydiflumetofen |
| 1462. | Mefentrifluconazole | Folpet | pydiflumetofen |
| 1463. | Mefentrifluconazole | Copper salts | pydiflumetofen |
| 1464. | Mefentrifluconazole | chlorothalonil | pydiflumetofen |
| 1465. | Mefentrifluconazole | sulphur | pydiflumetofen |
| 1466. | Mefentrifluconazole | Captan | pydiflumetofen |
| 1467. | Mefentrifluconazole | Propineb | pydiflumetofen |
| 1468. | Mefentrifluconazole | Maneb | pydiflumetofen |
| 1469. | Mefentrifluconazole | Thiram | pydiflumetofen |
| 1470. | Mefentrifluconazole | Zineb | pydiflumetofen |
| 1471. | Mefentrifluconazole | mancozeb | isofetamid |
| 1472. | Mefentrifluconazole | Folpet | isofetamid |
| 1473. | Mefentrifluconazole | Copper salts | isofetamid |
| 1474. | Mefentrifluconazole | chlorothalonil | isofetamid |
| 1475. | Mefentrifluconazole | sulphur | isofetamid |
| 1476. | Mefentrifluconazole | Captan | isofetamid |
| 1477. | Mefentrifluconazole | Propineb | isofetamid |
| 1478. | Mefentrifluconazole | Maneb | isofetamid |
| 1479. | Mefentrifluconazole | Thiram | isofetamid |
| 1480. | Mefentrifluconazole | Zineb | isofetamid |
| 1481. | Mefentrifluconazole | mancozeb | cyproconazole |
| 1482. | Mefentrifluconazole | Folpet | cyproconazole |
| 1483. | Mefentrifluconazole | Copper salts | cyproconazole |
| 1484. | Mefentrifluconazole | chlorothalonil | cyproconazole |
| 1485. | Mefentrifluconazole | sulphur | cyproconazole |
| 1486. | Mefentrifluconazole | Captan | cyproconazole |
| 1487. | Mefentrifluconazole | Propineb | cyproconazole |
| 1488. | Mefentrifluconazole | Maneb | cyproconazole |
| 1489. | Mefentrifluconazole | Thiram | cyproconazole |
| 1490. | Mefentrifluconazole | Zineb | cyproconazole |
| 1491. | Mefentrifluconazole | mancozeb | difenoconazole |
| 1492. | Mefentrifluconazole | Folpet | difenoconazole |
| 1493. | Mefentrifluconazole | Copper salts | difenoconazole |
| 1494. | Mefentrifluconazole | chlorothalonil | difenoconazole |
| 1495. | Mefentrifluconazole | sulphur | difenoconazole |
| 1496. | Mefentrifluconazole | Captan | difenoconazole |
| 1497. | Mefentrifluconazole | Propineb | difenoconazole |
| 1498. | Mefentrifluconazole | Maneb | difenoconazole |
| 1499. | Mefentrifluconazole | Thiram | difenoconazole |
| 1500. | Mefentrifluconazole | Zineb | difenoconazole |
| 1501. | Mefentrifluconazole | mancozeb | epoxiconazole |
| 1502. | Mefentrifluconazole | Folpet | epoxiconazole |
| 1503. | Mefentrifluconazole | Copper salts | epoxiconazole |
| 1504. | Mefentrifluconazole | chlorothalonil | epoxiconazole |
| 1505. | Mefentrifluconazole | sulphur | epoxiconazole |
| 1506. | Mefentrifluconazole | Captan | epoxiconazole |
| 1507. | Mefentrifluconazole | Propineb | epoxiconazole |
| 1508. | Mefentrifluconazole | Maneb | epoxiconazole |
| 1509. | Mefentrifluconazole | Thiram | epoxiconazole |
| 1510. | Mefentrifluconazole | Zineb | epoxiconazole |
| 1511. | Mefentrifluconazole | mancozeb | hexaconazole |
| 1512. | Mefentrifluconazole | Folpet | hexaconazole |
| 1513. | Mefentrifluconazole | Copper salts | hexaconazole |
| 1514. | Mefentrifluconazole | chlorothalonil | hexaconazole |
| 1515. | Mefentrifluconazole | sulphur | hexaconazole |
| 1516. | Mefentrifluconazole | Captan | hexaconazole |
| 1517. | Mefentrifluconazole | Propineb | hexaconazole |
| 1518. | Mefentrifluconazole | Maneb | hexaconazole |
| 1519. | Mefentrifluconazole | Thiram | hexaconazole |
| 1520. | Mefentrifluconazole | Zineb | hexaconazole |
| 1521. | Mefentrifluconazole | mancozeb | tebuconazole |
| 1522. | Mefentrifluconazole | Folpet | tebuconazole |
| 1523. | Mefentrifluconazole | Copper salts | tebuconazole |
| 1524. | Mefentrifluconazole | chlorothalonil | tebuconazole |
| 1525. | Mefentrifluconazole | sulphur | tebuconazole |
| 1526. | Mefentrifluconazole | Captan | tebuconazole |
| 1527. | Mefentrifluconazole | Propineb | tebuconazole |
| 1528. | Mefentrifluconazole | Maneb | tebuconazole |
| 1529. | Mefentrifluconazole | Thiram | tebuconazole |
| 1530. | Mefentrifluconazole | Zineb | tebuconazole |
| 1531. | Mefentrifluconazole | mancozeb | tetraconazole |
| 1532. | Mefentrifluconazole | Folpet | tetraconazole |
| 1533. | Mefentrifluconazole | Copper salts | tetraconazole |
| 1534. | Mefentrifluconazole | chlorothalonil | tetraconazole |
| 1535. | Mefentrifluconazole | sulphur | tetraconazole |
| 1536. | Mefentrifluconazole | Captan | tetraconazole |
| 1537. | Mefentrifluconazole | Propineb | tetraconazole |
| 1538. | Mefentrifluconazole | Maneb | tetraconazole |
| 1539. | Mefentrifluconazole | Thiram | tetraconazole |
| 1540. | Mefentrifluconazole | Zineb | tetraconazole |
| 1541. | Mefentrifluconazole | mancozeb | prothioconazole |
| 1542. | Mefentrifluconazole | Folpet | prothioconazole |
| 1543. | Mefentrifluconazole | Copper salts | prothioconazole |
| 1544. | Mefentrifluconazole | chlorothalonil | prothioconazole |
| 1545. | Mefentrifluconazole | sulphur | prothioconazole |
| 1546. | Mefentrifluconazole | Captan | prothioconazole |
| 1547. | Mefentrifluconazole | Propineb | prothioconazole |
| 1548. | Mefentrifluconazole | Maneb | prothioconazole |
| 1549. | Mefentrifluconazole | Thiram | prothioconazole |
| 1550. | Mefentrifluconazole | Zineb | prothioconazole |
| 1551. | Mefentrifluconazole | mancozeb | prothioconazole |
| 1552. | Mefentrifluconazole | Folpet | metalaxyl |
| 1553. | Mefentrifluconazole | Copper salts | metalaxyl |
| 1554. | Mefentrifluconazole | chlorothalonil | metalaxyl |
| 1555. | Mefentrifluconazole | sulphur | metalaxyl |
| 1556. | Mefentrifluconazole | Captan | metalaxyl |
| 1557. | Mefentrifluconazole | Propineb | metalaxyl |
| 1558. | Mefentrifluconazole | Maneb | metalaxyl |
| 1559. | Mefentrifluconazole | Thiram | metalaxyl |
| 1560. | Mefentrifluconazole | Zineb | metalaxyl |
| 1561. | Mefentrifluconazole | mancozeb | metalaxyl-M |
| 1562. | Mefentrifluconazole | Folpet | metalaxyl-M |
| 1563. | Mefentrifluconazole | Copper salts | metalaxyl-M |
| 1564. | Mefentrifluconazole | chlorothalonil | metalaxyl-M |
| 1565. | Mefentrifluconazole | sulphur | metalaxyl-M |
| 1566. | Mefentrifluconazole | Captan | metalaxyl-M |
| 1567. | Mefentrifluconazole | Propineb | metalaxyl-M |
| 1568. | Mefentrifluconazole | Maneb | metalaxyl-M |
| 1569. | Mefentrifluconazole | Thiram | metalaxyl-M |
| 1570. | Mefentrifluconazole | Zineb | metalaxyl-M |
| 1571. | Mefentrifluconazole | mancozeb | benomyl |
| 1572. | Mefentrifluconazole | Folpet | benomyl |
| 1573. | Mefentrifluconazole | Copper salts | benomyl |
| 1574. | Mefentrifluconazole | chlorothalonil | benomyl |
| 1575. | Mefentrifluconazole | sulphur | benomyl |
| 1576. | Mefentrifluconazole | Captan | benomyl |
| 1577. | Mefentrifluconazole | Propineb | benomyl |
| 1578. | Mefentrifluconazole | Maneb | benomyl |
| 1579. | Mefentrifluconazole | Thiram | benomyl |
| 1580. | Mefentrifluconazole | Zineb | benomyl |
| 1581. | Mefentrifluconazole | mancozeb | carbendazim |
| 1582. | Mefentrifluconazole | Folpet | carbendazim |
| 1583. | Mefentrifluconazole | Copper salts | carbendazim |
| 1584. | Mefentrifluconazole | chlorothalonil | carbendazim |
| 1585. | Mefentrifluconazole | sulphur | carbendazim |
| 1586. | Mefentrifluconazole | Captan | carbendazim |
| 1587. | Mefentrifluconazole | Propineb | carbendazim |
| 1588. | Mefentrifluconazole | Maneb | carbendazim |
| 1589. | Mefentrifluconazole | Thiram | carbendazim |
| 1590. | Mefentrifluconazole | Zineb | carbendazim |
| 1591. | Mefentrifluconazole | mancozeb | thiophanate-methyl |
| 1592. | Mefentrifluconazole | Folpet | thiophanate-methyl |
| 1593. | Mefentrifluconazole | Copper salts | thiophanate-methyl |
| 1594. | Mefentrifluconazole | chlorothalonil | thiophanate-methyl |
| 1595. | Mefentrifluconazole | sulphur | thiophanate-methyl |
| 1596. | Mefentrifluconazole | Captan | thiophanate-methyl |
| 1597. | Mefentrifluconazole | Propineb | thiophanate-methyl |
| 1598. | Mefentrifluconazole | Maneb | thiophanate-methyl |
| 1599. | Mefentrifluconazole | Thiram | thiophanate-methyl |
| 1600. | Mefentrifluconazole | Zineb | thiophanate-methyl |
| 1601. | Mefentrifluconazole | mancozeb | zoxamide |
| 1602. | Mefentrifluconazole | Folpet | zoxamide |
| 1603. | Mefentrifluconazole | Copper salts | zoxamide |
| 1604. | Mefentrifluconazole | chlorothalonil | zoxamide |
| 1605. | Mefentrifluconazole | sulphur | zoxamide |
| 1606. | Mefentrifluconazole | Captan | zoxamide |
| 1607. | Mefentrifluconazole | Propineb | zoxamide |
| 1608. | Mefentrifluconazole | Maneb | zoxamide |
| 1609. | Mefentrifluconazole | Thiram | zoxamide |
| 1610. | Mefentrifluconazole | Zineb | zoxamide |
| 1611. | Mefentrifluconazole | mancozeb | fluopicolide |
| 1612. | Mefentrifluconazole | Folpet | fluopicolide |
| 1613. | Mefentrifluconazole | Copper salts | fluopicolide |
| 1614. | Mefentrifluconazole | chlorothalonil | fluopicolide |
| 1615. | Mefentrifluconazole | sulphur | fluopicolide |
| 1616. | Mefentrifluconazole | Captan | fluopicolide |
| 1617. | Mefentrifluconazole | Propineb | fluopicolide |
| 1618. | Mefentrifluconazole | Maneb | fluopicolide |
| 1619. | Mefentrifluconazole | Thiram | fluopicolide |
| 1620. | Mefentrifluconazole | Zineb | fluopicolide |
| 1621. | Mefentrifluconazole | mancozeb | phenamacril |
| 1622. | Mefentrifluconazole | Folpet | phenamacril |
| 1623. | Mefentrifluconazole | Copper salts | phenamacril |
| 1624. | Mefentrifluconazole | chlorothalonil | phenamacril |
| 1625. | Mefentrifluconazole | sulphur | phenamacril |
| 1626. | Mefentrifluconazole | Captan | phenamacril |
| 1627. | Mefentrifluconazole | Propineb | phenamacril |
| 1628. | Mefentrifluconazole | Maneb | phenamacril |
| 1629. | Mefentrifluconazole | Thiram | phenamacril |
| 1630. | Mefentrifluconazole | Zineb | phenamacril |
| 1631. | Mefentrifluconazole | mancozeb | cyazofamid |
| 1632. | Mefentrifluconazole | Folpet | cyazofamid |
| 1633. | Mefentrifluconazole | Copper salts | cyazofamid |
| 1634. | Mefentrifluconazole | chlorothalonil | cyazofamid |
| 1635. | Mefentrifluconazole | sulphur | cyazofamid |
| 1636. | Mefentrifluconazole | Captan | cyazofamid |
| 1637. | Mefentrifluconazole | Propineb | cyazofamid |
| 1638. | Mefentrifluconazole | Maneb | cyazofamid |
| 1639. | Mefentrifluconazole | Thiram | cyazofamid |
| 1640. | Mefentrifluconazole | Zineb | cyazofamid |
| 1641. | Mefentrifluconazole | mancozeb | amisulbrom |
| 1642. | Mefentrifluconazole | Folpet | amisulbrom |
| 1643. | Mefentrifluconazole | Copper salts | amisulbrom |
| 1644. | Mefentrifluconazole | chlorothalonil | amisulbrom |
| 1645. | Mefentrifluconazole | sulphur | amisulbrom |
| 1646. | Mefentrifluconazole | Captan | amisulbrom |
| 1647. | Mefentrifluconazole | Propineb | amisulbrom |
| 1648. | Mefentrifluconazole | Maneb | amisulbrom |
| 1649. | Mefentrifluconazole | Thiram | amisulbrom |
| 1650. | Mefentrifluconazole | Zineb | amisulbrom |
| 1651. | Mefentrifluconazole | mancozeb | tricyclazole |
| 1652. | Mefentrifluconazole | Folpet | tricyclazole |
| 1653. | Mefentrifluconazole | Copper salts | tricyclazole |
| 1654. | Mefentrifluconazole | chlorothalonil | tricyclazole |
| 1655. | Mefentrifluconazole | sulphur | Tricyclazole |
| 1656. | Mefentrifluconazole | Captan | Tricyclazole |
| 1657. | Mefentrifluconazole | Propineb | Tricyclazole |
| 1658. | Mefentrifluconazole | Maneb | Tricyclazole |
| 1659. | Mefentrifluconazole | Thiram | Tricyclazole |
| 1660. | Mefentrifluconazole | Zineb | Tricyclazole |
| 1661. | Mefentrifluconazole | mancozeb | oxathiapiprolin |
| 1662. | Mefentrifluconazole | Folpet | oxathiapiprolin |
| 1663. | Mefentrifluconazole | Copper salts | oxathiapiprolin |
| 1664. | Mefentrifluconazole | chlorothalonil | oxathiapiprolin |
| 1665. | Mefentrifluconazole | sulphur | oxathiapiprolin |
| 1666. | Mefentrifluconazole | Captan | oxathiapiprolin |
| 1667. | Mefentrifluconazole | Propineb | oxathiapiprolin |
| 1668. | Mefentrifluconazole | Maneb | oxathiapiprolin |
| 1669. | Mefentrifluconazole | Thiram | oxathiapiprolin |
| 1670. | Mefentrifluconazole | Zineb | oxathiapiprolin |
| 1671. | Mefentrifluconazole | mancozeb | picarbutrazox |
| 1672. | Mefentrifluconazole | Folpet | picarbutrazox |
| 1673. | Mefentrifluconazole | Copper salts | picarbutrazox |
| 1674. | Mefentrifluconazole | chlorothalonil | picarbutrazox |
| 1675. | Mefentrifluconazole | sulphur | picarbutrazox |
| 1676. | Mefentrifluconazole | Captan | picarbutrazox |
| 1677. | Mefentrifluconazole | Propineb | picarbutrazox |
| 1678. | Mefentrifluconazole | Maneb | picarbutrazox |
| 1679. | Mefentrifluconazole | Thiram | picarbutrazox |
| 1680. | Mefentrifluconazole | Zineb | picarbutrazox |
| 1681. | Mefentrifluconazole | mancozeb | azoxystrobin |
| 1682. | Mefentrifluconazole | Folpet | azoxystrobin |
| 1683. | Mefentrifluconazole | Copper salts | azoxystrobin |
| 1684. | Mefentrifluconazole | chlorothalonil | azoxystrobin |
| 1685. | Mefentrifluconazole | sulphur | azoxystrobin |
| 1686. | Mefentrifluconazole | Captan | azoxystrobin |
| 1687. | Mefentrifluconazole | Propineb | azoxystrobin |
| 1688. | Mefentrifluconazole | Maneb | azoxystrobin |
| 1689. | Mefentrifluconazole | Thiram | azoxystrobin |
| 1690. | Mefentrifluconazole | Zineb | azoxystrobin |
| 1691. | Mefentrifluconazole | mancozeb | picoxystrobin |
| 1692. | Mefentrifluconazole | Folpet | picoxystrobin |
| 1693. | Mefentrifluconazole | Copper salts | picoxystrobin |
| 1694. | Mefentrifluconazole | chlorothalonil | picoxystrobin |
| 1695. | Mefentrifluconazole | sulphur | picoxystrobin |
| 1696. | Mefentrifluconazole | Captan | picoxystrobin |
| 1697. | Mefentrifluconazole | Propineb | picoxystrobin |
| 1698. | Mefentrifluconazole | Maneb | picoxystrobin |
| 1699. | Mefentrifluconazole | Thiram | picoxystrobin |
| 1700. | Mefentrifluconazole | Zineb | picoxystrobin |
| 1701. | Mefentrifluconazole | mancozeb | pyraclostrobin |
| 1702. | Mefentrifluconazole | Folpet | pyraclostrobin |
| 1703. | Mefentrifluconazole | Copper salts | pyraclostrobin |
| 1704. | Mefentrifluconazole | chlorothalonil | pyraclostrobin |
| 1705. | Mefentrifluconazole | sulphur | pyraclostrobin |
| 1706. | Mefentrifluconazole | Captan | pyraclostrobin |
| 1707. | Mefentrifluconazole | Propineb | pyraclostrobin |
| 1708. | Mefentrifluconazole | Maneb | pyraclostrobin |
| 1709. | Mefentrifluconazole | Thiram | pyraclostrobin |
| 1710. | Mefentrifluconazole | Zineb | pyraclostrobin |
| 1711. | Mefentrifluconazole | mancozeb | kresoxim-methyl |
| 1712. | Mefentrifluconazole | Folpet | kresoxim-methyl |
| 1713. | Mefentrifluconazole | Copper salts | kresoxim-methyl |
| 1714. | Mefentrifluconazole | chlorothalonil | kresoxim-methyl |
| 1715. | Mefentrifluconazole | Sulphur | kresoxim-methyl |
| 1716. | Mefentrifluconazole | Captan | kresoxim-methyl |
| 1717. | Mefentrifluconazole | Propineb | kresoxim-methyl |
| 1718. | Mefentrifluconazole | Maneb | kresoxim-methyl |
| 1719. | Mefentrifluconazole | Thiram | kresoxim-methyl |
| 1720. | Mefentrifluconazole | Zineb | kresoxim-methyl |
| 1721. | Mefentrifluconazole | Mancozeb | trifloxystrobin |
| 1722. | Mefentrifluconazole | Folpet | trifloxystrobin |
| 1723. | Mefentrifluconazole | Copper salts | trifloxystrobin |
| 1724. | Mefentrifluconazole | chlorothalonil | trifloxystrobin |
| 1725. | Mefentrifluconazole | sulphur | trifloxystrobin |
| 1726. | Mefentrifluconazole | Captan | trifloxystrobin |
| 1727. | Mefentrifluconazole | Propineb | trifloxystrobin |
| 1728. | Mefentrifluconazole | Maneb | trifloxystrobin |
| 1729. | Mefentrifluconazole | Thiram | trifloxystrobin |
| 1730. | Mefentrifluconazole | Zineb | trifloxystrobin |
| 1731. | Mefentrifluconazole | mancozeb | Copper oxychloride |
| 1732. | Mefentrifluconazole | Folpet | Copper oxychloride |
| 1733. | Mefentrifluconazole | Copper salts | Copper oxychloride |
| 1734. | Mefentrifluconazole | chlorothalonil | Copper oxychloride |
| 1735. | Mefentrifluconazole | sulphur | Copper oxychloride |
| 1736. | Mefentrifluconazole | Captan | Copper oxychloride |
| 1737. | Mefentrifluconazole | Propineb | Copper oxychloride |
| 1738. | Mefentrifluconazole | Maneb | Copper oxychloride |
| 1739. | Mefentrifluconazole | Thiram | Copper oxychloride |
| 1740. | Mefentrifluconazole | Zineb | Copper oxychloride |
| 1741. | Mefentrifluconazole | mancozeb | Aminopyrifen |
| 1742. | Mefentrifluconazole | Folpet | Aminopyrifen |
| 1743. | Mefentrifluconazole | Copper salts | Aminopyrifen |
| 1744. | Mefentrifluconazole | chlorothalonil | Aminopyrifen |
| 1745. | Mefentrifluconazole | sulphur | Aminopyrifen |
| 1746. | Mefentrifluconazole | Captan | Aminopyrifen |
| 1747. | Mefentrifluconazole | Propineb | Aminopyrifen |
| 1748. | Mefentrifluconazole | Maneb | Aminopyrifen |
| 1749. | Mefentrifluconazole | Thiram | Aminopyrifen |
| 1750. | Mefentrifluconazole | Zineb | Aminopyrifen |
| 1751. | Mefentrifluconazole | mancozeb | Inpyrfluxam |
| 1752. | Mefentrifluconazole | Folpet | Inpyrfluxam |
| 1753. | Mefentrifluconazole | Copper salts | Inpyrfluxam |
| 1754. | Mefentrifluconazole | chlorothalonil | Inpyrfluxam |
| 1755. | Mefentrifluconazole | sulphur | Inpyrfluxam |
| 1756. | Mefentrifluconazole | Captan | Inpyrfluxam |
| 1757. | Mefentrifluconazole | Propineb | Inpyrfluxam |
| 1758. | Mefentrifluconazole | Maneb | Inpyrfluxam |
| 1759. | Mefentrifluconazole | Thiram | Inpyrfluxam |
| 1760. | Mefentrifluconazole | Zineb | Inpyrfluxam |
| 1761. | Mefentrifluconazole | mancozeb | Pyridachlometyl |
| 1762. | Mefentrifluconazole | Folpet | Pyridachlometyl |
| 1763. | Mefentrifluconazole | Copper salts | Pyridachlometyl |
| 1764. | Mefentrifluconazole | chlorothalonil | Pyridachlometyl |
| 1765. | Mefentrifluconazole | sulphur | Pyridachlometyl |
| 1766. | Mefentrifluconazole | Captan | Pyridachlometyl |
| 1767. | Mefentrifluconazole | Propineb | Pyridachlometyl |
| 1768. | Mefentrifluconazole | Maneb | Pyridachlometyl |
| 1769. | Mefentrifluconazole | Thiram | Pyridachlometyl |
| 1770. | Mefentrifluconazole | Zineb | Pyridachlometyl |
| 1771. | Mefentrifluconazole | mancozeb | Fluopimomide |
| 1772. | Mefentrifluconazole | Folpet | Fluopimomide |
| 1773. | Mefentrifluconazole | Copper salts | Fluopimomide |
| 1774. | Mefentrifluconazole | chlorothalonil | Fluopimomide |
| 1775. | Mefentrifluconazole | sulphur | Fluopimomide |
| 1776. | Mefentrifluconazole | Captan | Fluopimomide |
| 1777. | Mefentrifluconazole | Propineb | Fluopimomide |
| 1778. | Mefentrifluconazole | Maneb | Fluopimomide |
| 1779. | Mefentrifluconazole | Thiram | Fluopimomide |
| 1780. | Mefentrifluconazole | Zineb | Fluopimomide |
| 1781. | Mefentrifluconazole | mancozeb | Ipflufenoquin |
| 1782. | Mefentrifluconazole | Folpet | Ipflufenoquin |
| 1783. | Mefentrifluconazole | Copper salts | Ipflufenoquin |
| 1784. | Mefentrifluconazole | chlorothalonil | Ipflufenoquin |
| 1785. | Mefentrifluconazole | sulphur | Ipflufenoquin |
| 1786. | Mefentrifluconazole | Captan | Ipflufenoquin |
| 1787. | Mefentrifluconazole | Propineb | Ipflufenoquin |
| 1788. | Mefentrifluconazole | Maneb | Ipflufenoquin |
| 1789. | Mefentrifluconazole | Thiram | Ipflufenoquin |
| 1790. | Mefentrifluconazole | Zineb | Ipflufenoquin |
| 1791. | Mefentrifluconazole | mancozeb | Metyltetraprole |
| 1792. | Mefentrifluconazole | Folpet | Metyltetraprole |
| 1793. | Mefentrifluconazole | Copper salts | Metyltetraprole |
| 1794. | Mefentrifluconazole | chlorothalonil | Metyltetraprole |
| 1795. | Mefentrifluconazole | sulphur | Metyltetraprole |
| 1796. | Mefentrifluconazole | Captan | Metyltetraprole |
| 1797. | Mefentrifluconazole | Propineb | Metyltetraprole |
| 1798. | Mefentrifluconazole | Maneb | Metyltetraprole |
| 1799. | Mefentrifluconazole | Thiram | Metyltetraprole |
| 1800. | Mefentrifluconazole | Zineb | Metyltetraprole |
| 1801. | Mefentrifluconazole | mancozeb | Florylpicoxamid |
| 1802. | Mefentrifluconazole | Folpet | Florylpicoxamid |
| 1803. | Mefentrifluconazole | Copper salts | Florylpicoxamid |
| 1804. | Mefentrifluconazole | chlorothalonil | Florylpicoxamid |
| 1805. | Mefentrifluconazole | sulphur | Florylpicoxamid |
| 1806. | Mefentrifluconazole | Captan | Florylpicoxamid |
| 1807. | Mefentrifluconazole | Propineb | Florylpicoxamid |
| 1808. | Mefentrifluconazole | Maneb | Florylpicoxamid |
| 1809. | Mefentrifluconazole | Thiram | Florylpicoxamid |
| 1810. | Mefentrifluconazole | Zineb | Florylpicoxamid |
| 1811. | Mefentrifluconazole | mancozeb | Pyrapropoyne |
| 1812. | Mefentrifluconazole | Folpet | Pyrapropoyne |
| 1813. | Mefentrifluconazole | Copper salts | Pyrapropoyne |
| 1814. | Mefentrifluconazole | chlorothalonil | Pyrapropoyne |
| 1815. | Mefentrifluconazole | sulphur | Pyrapropoyne |
| 1816. | Mefentrifluconazole | Captan | Pyrapropoyne |
| 1817. | Mefentrifluconazole | Propineb | Pyrapropoyne |
| 1818. | Mefentrifluconazole | Maneb | Pyrapropoyne |
| 1819. | Mefentrifluconazole | Thiram | Pyrapropoyne |
| 1820. | Mefentrifluconazole | Zineb | Pyrapropoyne |
| 1821. | Mefentrifluconazole | mancozeb | Isoflucypram |
| 1822. | Mefentrifluconazole | Folpet | Isoflucypram |
| 1823. | Mefentrifluconazole | Copper salts | Isoflucypram |
| 1824. | Mefentrifluconazole | chlorothalonil | Isoflucypram |
| 1825. | Mefentrifluconazole | sulphur | Isoflucypram |
| 1826. | Mefentrifluconazole | Captan | Isoflucypram |
| 1827. | Mefentrifluconazole | Propineb | Isoflucypram |
| 1828. | Mefentrifluconazole | Maneb | Isoflucypram |
| 1829. | Mefentrifluconazole | Thiram | Isoflucypram |
| 1830. | Mefentrifluconazole | Zineb | Isoflucypram |
| 1831. | Mefentrifluconazole | mancozeb | Fenpicoxamid |
| 1832. | Mefentrifluconazole | Folpet | Fenpicoxamid |
| 1833. | Mefentrifluconazole | Copper salts | Fenpicoxamid |
| 1834. | Mefentrifluconazole | chlorothalonil | Fenpicoxamid |
| 1835. | Mefentrifluconazole | sulphur | Fenpicoxamid |
| 1836. | Mefentrifluconazole | Captan | Fenpicoxamid |
| 1837. | Mefentrifluconazole | Propineb | Fenpicoxamid |
| 1838. | Mefentrifluconazole | Maneb | Fenpicoxamid |
| 1839. | Mefentrifluconazole | Thiram | Fenpicoxamid |
| 1840. | Mefentrifluconazole | Zineb | Fenpicoxamid |
| 1841. | Mefentrifluconazole | mancozeb | Dichlobentiazox |
| 1842. | Mefentrifluconazole | Folpet | Dichlobentiazox |
| 1843. | Mefentrifluconazole | Copper salts | Dichlobentiazox |
| 1844. | Mefentrifluconazole | chlorothalonil | Dichlobentiazox |
| 1845. | Mefentrifluconazole | sulphur | Dichlobentiazox |
| 1846. | Mefentrifluconazole | Captan | Dichlobentiazox |
| 1847. | Mefentrifluconazole | Propineb | Dichlobentiazox |
| 1848. | Mefentrifluconazole | Maneb | Dichlobentiazox |
| 1849. | Mefentrifluconazole | Thiram | Dichlobentiazox |
| 1850. | Mefentrifluconazole | Zineb | Dichlobentiazox |
| 1851. | Mefentrifluconazole | mancozeb | Quinofumelin |
| 1852. | Mefentrifluconazole | Folpet | Quinofumelin |
| 1853. | Mefentrifluconazole | Copper salts | Quinofumelin |
| 1854. | Mefentrifluconazole | chlorothalonil | Quinofumelin |
| 1855. | Mefentrifluconazole | sulphur | Quinofumelin |
| 1856. | Mefentrifluconazole | Captan | Quinofumelin |
| 1857. | Mefentrifluconazole | Propineb | Quinofumelin |
| 1858. | Mefentrifluconazole | Maneb | Quinofumelin |
| 1859. | Mefentrifluconazole | Thiram | Quinofumelin |
| 1860. | Mefentrifluconazole | Zineb | Quinofumelin |
| 1861. | Mefentrifluconazole | mancozeb | Ipfentrifluconazole |
| 1862. | Mefentrifluconazole | Folpet | Ipfentrifluconazole |
| 1863. | Mefentrifluconazole | Copper salts | Ipfentrifluconazole |
| 1864. | Mefentrifluconazole | chlorothalonil | Ipfentrifluconazole |
| 1865. | Mefentrifluconazole | sulphur | Ipfentrifluconazole |
| 1866. | Mefentrifluconazole | Captan | Ipfentrifluconazole |
| 1867. | Mefentrifluconazole | Propineb | Ipfentrifluconazole |
| 1868. | Mefentrifluconazole | Maneb | Ipfentrifluconazole |
| 1869. | Mefentrifluconazole | Thiram | Ipfentrifluconazole |
| 1870. | Mefentrifluconazole | Zineb | Ipfentrifluconazole |

Another aspect of the present invention can provide fungicidal compositions comprising:
a) at least one azole fungicide, the azole fungicide being an imidazole fungicide or a triazole fungicide, wherein:
   said imidazole fungicide is selected from the group consisting of bifonazole, butoconazole, clotrimazole, econazole, fenticonazole, isoconazole, ketoconazole, luliconazole, miconazole, omoconazole, oxiconazole, sertaconazole, sulconazole and tioconazole;
   said triazole fungicide is selected from albaconazole, efinaconazole, epoxiconazole, fluconazole, isavuconazole, itraconazole, posaconazole, propiconazole, ravuconazole, terconazole, voriconazole, mefentrifluconazole and Ipfentrifluconazole;
   and
b) at least one multisite contact fungicide; and
c) at least a third systemic fungicide.

In an embodiment, the multi-site fungicide, third fungicidally active ingredient may be selected according to any one of the preferred embodiments described hereinabove.

In an embodiment, the present invention may provide a composition comprising:

(a) Fluconazole;

(b) at least one multisite contact fungicide;

(c) at least a third systemic fungicide; and

(d) at least one agrochemically acceptable excipient.

In an embodiment, the present invention may provide a composition comprising:

(a) mefentrifluconazole;

(b) at least one multisite contact fungicide;

(c) at least a third systemic fungicide; and

(d) at least one agrochemically acceptable excipient.

In an embodiment, the present invention may provide a composition comprising:

(a) Ipfentrifluconazole;

(b) at least one multisite contact fungicide;

(c) at least a third systemic fungicide; and

(d) at least one agrochemically acceptable excipient.

The amount of a composition according to the invention to be applied, will depend on various factors, such as the subject of the treatment, such as, for example plants, soil or seeds, the type of treatment, such as, for example spraying, dusting or seed dressing, the purpose of the treatment, such as, for example prophylactic or therapeutic disease control, in case of disease control the type of fungi to be controlled or the application time. This amount of the combinations of the present invention to be applied can be readily deduced by a skilled agronomist.

In another preferred embodiment, the present invention may provide compositions comprising:
(a) Fluconazole;
(b) Mancozeb; and
(c) Fentine hydrochloride.
   said fungicides being combined in agrochemically acceptable amounts.

In another preferred embodiment, the present invention may provide compositions comprising:
(a) Fluconazole;
(b) Mancozeb; and
(c) pyraclostrobin
   said fungicides being combined in agrochemically acceptable amounts.

In another preferred embodiment, the present invention may provide compositions comprising:
(a) Fluconazole;
(b) Mancozeb; and
(c) Azoxystrobin.
   said fungicides being combined in agrochemically acceptable amounts.

In another preferred embodiment, the present invention may provide compositions comprising:
(a) Fluconazole;
(b) Mancozeb; and
(c) Cyproconazole.
   said fungicides being combined in agrochemically acceptable amounts.

In another preferred embodiment, the present invention may provide compositions comprising:
(a) Fluconazole;
(b) Mancozeb; and
(c) Benzovindiflupyr.
   said fungicides being combined in agrochemically acceptable amounts.

In another preferred embodiment, the present invention may provide compositions comprising:
(a) Fluconazole;
(b) Chlorothalonil; and
(c) Benzovindiflupyr.
   said fungicides being combined in agrochemically acceptable amounts.

In another preferred embodiment, the present invention may provide compositions comprising:
(a) Fluconazole;
(b) Mancozeb; and
(c) Copper Oxychloride.
   said fungicides being combined in agrochemically acceptable amounts.

In another preferred embodiment, the present invention may provide compositions comprising:
(a) Fluconazole;
(b) Mancozeb; and
(c) Tebuconazole.
   said fungicides being combined in agrochemically acceptable amounts.

In another preferred embodiment, the present invention may provide compositions comprising:
(a) Fluconazole;
(b) Mancozeb; and
(c) trifloxystrobin.
   said fungicides being combined in agrochemically acceptable amounts.

In another preferred embodiment, the present invention may provide compositions comprising:
(a) Fluconazole;
(b) Mancozeb; and
(c) Fluxapyroxad.
   said fungicides being combined in agrochemically acceptable amounts.

In another preferred embodiment, the present invention may provide compositions comprising:
(a) Fluconazole;
(b) Mancozeb; and
(c) boscalid.
   said fungicides being combined in agrochemically acceptable amounts.

In another preferred embodiment, the present invention may provide compositions comprising:
(a) Fluconazole;
(b) Mancozeb; and
(c) Benzovindiflyupyr.
   said fungicides being combined in agrochemically acceptable amounts.

In another preferred embodiment, the present invention may provide compositions comprising:
(a) Fluconazole;
(b) Mancozeb; and
(c) Bixafen.
   said fungicides being combined in agrochemically acceptable amounts.

In another preferred embodiment, the present invention may provide compositions comprising:
(a) Fluconazole;
(b) Mancozeb; and
(c) Prothioconazole.
   said fungicides being combined in agrochemically acceptable amounts.

In another preferred embodiment, the present invention may provide compositions comprising:
(a) mefentrifluconazole;
(b) Mancozeb; and
(c) Fentine hydrochloride.
   said fungicides being combined in agrochemically acceptable amounts.

In another preferred embodiment, the present invention may provide compositions comprising:
(a) Mefentrifluconazole;
(b) Mancozeb; and
(c) pyraclostrobin
   said fungicides being combined in agrochemically acceptable amounts.

In another preferred embodiment, the present invention may provide compositions comprising:
(a) Mefentrifluconazole;
(b) Mancozeb; and
(c) Azoxystrobin.
   said fungicides being combined in agrochemically acceptable amounts.

In another preferred embodiment, the present invention may provide compositions comprising:
(a) Mefentrifluconazole;
(b) Mancozeb; and
(c) Cyproconazole.
   said fungicides being combined in agrochemically acceptable amounts.

In another preferred embodiment, the present invention may provide compositions comprising:
(a) Mefentrifluconazole;
(b) Mancozeb; and
(c) Benzovindiflupyr.
   said fungicides being combined in agrochemically acceptable amounts.

In another preferred embodiment, the present invention may provide compositions comprising:
(a) Mefentrifluconazole;
(b) Chlorothalonil; and
(c) Benzovindiflupyr.
   said fungicides being combined in agrochemically acceptable amounts.

In another preferred embodiment, the present invention may provide compositions comprising:
(a) Mefentrifluconazole;
(b) Mancozeb; and
(c) Copper Oxychloride.
   said fungicides being combined in agrochemically acceptable amounts.

In another preferred embodiment, the present invention may provide compositions comprising:
(a) Mefentrifluconazole;
(b) Mancozeb; and
(c) Tebuconazole.
   said fungicides being combined in agrochemically acceptable amounts.

In another preferred embodiment, the present invention may provide compositions comprising:
(a) Mefentrifluconazole;
(b) Mancozeb; and
(c) trifloxystrobin.
   said fungicides being combined in agrochemically acceptable amounts.

In another preferred embodiment, the present invention may provide compositions comprising:
(a) Mefentrifluconazole;
(b) Mancozeb; and
(c) Fluxapyroxad.
   said fungicides being combined in agrochemically acceptable amounts.

In another preferred embodiment, the present invention may provide compositions comprising:
(a) Mefentrifluconazole;
(b) Mancozeb; and
(c) boscalid.
   said fungicides being combined in agrochemically acceptable amounts.

In another preferred embodiment, the present invention may provide compositions comprising:
(a) Mefentrifluconazole;
(b) Mancozeb; and\
(c) Benzovindiflyupyr.
   said fungicides being combined in agrochemically acceptable amounts.

In another preferred embodiment, the present invention may provide compositions comprising:
(a) Mefentrifluconazole;
(b) Mancozeb; and
(c) Bixafen.
   said fungicides being combined in agrochemically acceptable amounts.

In another preferred embodiment, the present invention may provide compositions comprising:
(a) Mefentrifluconazole;
(b) Mancozeb; and
(c) Prothioconazole.
   said fungicides being combined in agrochemically acceptable amounts.

In another preferred embodiment, the present invention may provide compositions comprising:
(a) ipfentrifluconazole;
(b) Mancozeb; and
(c) Fentine hydrochloride.
   said fungicides being combined in agrochemically acceptable amounts.

In another preferred embodiment, the present invention may provide compositions comprising:
(a) Ipfentrifluconazole;
(b) Mancozeb; and
(c) pyraclostrobin
   said fungicides being combined in agrochemically acceptable amounts.

In another preferred embodiment, the present invention may provide compositions comprising:
(a) Ipfentrifluconazole;
(b) Mancozeb; and
(c) Azoxystrobin.
   said fungicides being combined in agrochemically acceptable amounts.

In another preferred embodiment, the present invention may provide compositions comprising:
(a) Ipfentrifluconazole;
(b) Mancozeb; and
(c) Cyproconazole.
   said fungicides being combined in agrochemically acceptable amounts.

In another preferred embodiment, the present invention may provide compositions comprising:
(a) Ipfentrifluconazole;
(b) Mancozeb; and
(c) Benzovindiflupyr.
   said fungicides being combined in agrochemically acceptable amounts.

In another preferred embodiment, the present invention may provide compositions comprising:
(a) Ipfentrifluconazole;
(b) Chlorothalonil; and
(c) Benzovindiflupyr.
   said fungicides being combined in agrochemically acceptable amounts.

In another preferred embodiment, the present invention may provide compositions comprising:
(a) Ipfentrifluconazole;
(b) Mancozeb; and
(c) Copper Oxychloride.
   said fungicides being combined in agrochemically acceptable amounts.

I

n another preferred embodiment, the present invention may provide compositions comprising:
(a) Ipfentrifluconazole;
(b) Mancozeb; and
(c) Tebuconazole.
   said fungicides being combined in agrochemically acceptable amounts.

In another preferred embodiment, the present invention may provide compositions comprising:
(a) Ipfentrifluconazole;
(b) Mancozeb; and
(c) trifloxystrobin.
   said fungicides being combined in agrochemically acceptable amounts.

In another preferred embodiment, the present invention may provide compositions comprising:
(a) Ipfentrifluconazole;
(b) Mancozeb; and
(c) Fluxapyroxad.
   said fungicides being combined in agrochemically acceptable amounts.

In another preferred embodiment, the present invention may provide compositions comprising:
(a) Ipfentrifluconazole;
(b) Mancozeb; and
(c) boscalid.
   said fungicides being combined in agrochemically acceptable amounts.

In another preferred embodiment, the present invention may provide compositions comprising:
(a) Ipfentrifluconazole;
(b) Mancozeb; and
(c) Benzovindiflyupyr.
   said fungicides being combined in agrochemically acceptable amounts.

In another preferred embodiment, the present invention may provide compositions comprising:
(a) Ipfentrifluconazole;
(b) Mancozeb; and
(c) Bixafen.
   said fungicides being combined in agrochemically acceptable amounts.

In another preferred embodiment, the present invention may provide compositions comprising:
(a) Ipfentrifluconazole;
(b) Mancozeb; and
(c) Prothioconazole.
   said fungicides being combined in agrochemically acceptable amounts.

An embodiment of the present invention comprises:
(a) at least one azole fungicide, the azole fungicide being an imidazole fungicide or a triazole fungicide, wherein said imidazole fungicide is selected from the group consisting of bifonazole, butoconazole, clotrimazole, econazole, fenticonazole, isoconazole, ketoconazole, luliconazole, miconazole, omoconazole, oxiconazole, sertaconazole, sulconazole and tioconazole; and said triazole fungicide is selected from albaconazole, efinaconazole, fluconazole, isavuconazole, itraconazole, posaconazole, propiconazole, ravuconazole, terconazole, voriconazole, mefentrifluconazole and Ipfentrifluconazole;
(b) mancozeb; and
(c) fentin hydroxide.

In an embodiment, the preferred azole fungicide is fluconazole.

Therefore, an embodiment of the present invention comprises:
(a) fluconazole;
(b) mancozeb;
(c) fentin hydroxide.

An embodiment of the present invention comprises:
(a) fluconazole in an amount of about 50-200 g/Ha;
(b) mancozeb in an amount of about 300-1000 g/Ha; and
(c) fentin hydroxide in an amount of about 300-1000 g/Ha.

An embodiment of the present invention comprises:
(a) at least one azole fungicide, the azole fungicide being an imidazole fungicide or a triazole fungicide, wherein said imidazole fungicide is selected from the group consisting of bifonazole, butoconazole, clotrimazole, econazole, fenticonazole, isoconazole, ketoconazole, luliconazole, miconazole, omoconazole, oxiconazole, sertaconazole, sulconazole and tioconazole; and said triazole fungicide is selected from albaconazole, efinaconazole, fluconazole, isavuconazole, itraconazole, posaconazole, propiconazole, ravuconazole, terconazole and voriconazole;
(b) mancozeb;
(c) fentin hydroxide; and
(d) pyraclostrobin.

In an embodiment, the preferred azole fungicide is fluconazole.

Therefore, an embodiment of the present invention comprises:
(a) fluconazole;
(b) mancozeb;
(c) fentin hydroxide; and
(d) pyraclostrobin.

An embodiment of the present invention comprises:
(a) fluconazole in an amount of about 50-200 g/Ha;
(b) mancozeb in an amount of about 300-1000 g/Ha;
(c) fentin hydroxide in an amount of about 3000-1000 g/Ha; and
(d) pyraclostrobin in an amount of about 30-150 g/Ha.

Another embodiment of the present invention comprises:
(a) fluconazole in an amount of about 30-50 g/Ha;
(b) mancozeb in an amount of about 500-700 g/Ha; and
(c) tebuconazole in an amount of about 30-40 g/Ha.

Another embodiment of the present invention comprises:
(a) fluconazole in an amount of about 30-50 g/Ha;
(b) mancozeb in an amount of about 500-700 g/Ha; and
(c) benzovindiflupyr in an amount of about 30-60 g/Ha.

Another embodiment of the present invention comprises:
(a) fluconazole in an amount of about 30-50 g/Ha;
(b) chlorothalonil in an amount of about 300-500 g/Ha; and
(c) benzovindiflupyr in an amount of about 30-60 g/Ha.

Another embodiment of the present invention comprises:
(a) fluconazole in an amount of about 30-50 g/Ha;
(b) copper oxychloride in an amount of about 200-300 g/Ha; and
(c) benzovindiflupyr in an amount of about 30-60 g/Ha.

Another embodiment of the present invention comprises:
(a) fluconazole in an amount of about 40-60 g/Ha;
(b) mancozeb in an amount of about 500-700 g/Ha; and
(c) azoxystrobin in an amount of about 50-100 g/Ha.

In an embodiment, the total amount of Fluconazole in the composition may typically be in the range of 0.1 to 99% by weight, preferably 0.2 to 90% by weight. The total amount of multi-site fungicide in the composition may be in the range of 0.1 to 99% by weight. The total amount of third fungicide in the composition may be in the range of 0.1 to 99% by weight.

In an embodiment, the total amount of mefentrifluconazole in the composition may typically be in the range of 0.1 to 99% by weight, preferably 0.2 to 90% by weight. The total amount of multi-site fungicide in the composition may be in the range of 0.1 to 99% by weight. The total amount of third fungicide in the composition may be in the range of 0.1 to 99% by weight.

In an embodiment, the total amount of Ipfentrifluconazole in the composition may typically be in the range of 0.1 to 99% by weight, preferably 0.2 to 90% by weight. The total amount of multi-site fungicide in the composition may be in the range of 0.1 to 99% by weight. The total amount of third fungicide in the composition may be in the range of 0.1 to 99% by weight.

In an embodiment, the constituent fungicides of the combination of the present invention may be admixed in ratio of (1-80):(1-80):(1-80) of the Fluconazole; multi-site fungicide and the third fungicide respectively.

In an embodiment, the constituents of the composition of the present invention may be tank mixed and sprayed at the locus of the infection, or may be alternatively be mixed with surfactants and then sprayed.

In an embodiment, the constituents of the composition of the present invention may be used for foliar application, ground or applications to plant propagation materials.

In an embodiment, the compositions of the present invention may typically be produce by mixing the actives in the composition with an inert carrier, and adding surfactants and other adjuvants and carriers as needed and formulated into solid, or liquid formulations, including but not limited to wettable powders, granules, dusts, Soluble (liquid) concentrates, suspension concentrates, oil in water emulsion, water in oil emulsion, emulsifiable concentrates, capsule suspensions, ZC formulations, oil dispersions or other known formulation types. The composition may also be used for treatment of a plant propagation material such as seeds etc.

Examples of the solid carrier used in formulation include fine powders or granules such as minerals such as kaolin clay, attapulgite clay, bentonite, montmorillonite, acid white clay, pyrophyllite, talc, diatomaceous earth and calcite, natural organic materials such as corn rachis powder and walnut husk powder, synthetic organic materials such as urea, salts such as calcium carbonate and ammonium sulfate, synthetic inorganic materials such as synthetic hydrated silicon oxide, and as a liquid carrier, aromatic hydrocarbons such as xylene, alkylbenzene and methylnaphthalene, alcohols such as 2-propanol, ethyleneglycol, propylene glycol, and ethylene glycol monoethyl ether, ketones such as acetone, cyclohexanone and isophorone, vegetable oil such as soybean oil and cotton seed oil, petroleum aliphatic hydrocarbons, esters, dimethylsulfoxide, acetonitrile and water.

Examples of the surfactant include anionic surfactants such as alkyl sulfate ester salts, alkylaryl sulfonate salts, dialkyl sulfosuccinate salts, polyoxyethylene alkylaryl ether phosphate ester salts, lignosulfonate salts and naphthalene sulfonate formaldehyde polycondensates, and nonionic surfactants such as polyoxyethylene alkyl aryl ethers, polyoxyethylene alkylpolyoxypropylene block copolymers and sorbitan fatty acid esters and cationic surfactants such as alkyltrimethylammonium salts.

Examples of the other formulation auxiliary agents include water-soluble polymers such as polyvinyl alcohol and polyvinylpyrrolidone, polysaccharides such as Arabic gum, alginic acid and the salt thereof, CMC (carboxymethyl-cellulose), Xanthan gum, inorganic materials such as aluminum magnesium silicate and alumina sol, preservatives, coloring agents and stabilization agents such as PAP (acid phosphate isopropyl) and BHT.

The compositions according to the present invention is effective for the following plant diseases:

Disease in rice: Blast (Magnaporthe grisea), Helminthosporium leaf spot (Cochliobolus miyabeanus), sheath blight (Rhizoctonia solani), and bakanae disease (Gibberella fujikuroi).

Diseases in wheat: powdery mildew (Erysiphe graminis), Fusariuin head blight (Fusarium graminearum, F. avenacerum, F. culmorum, Microdochium nivale), rust (Puccinia striiformis, P. graminis, P. recondita), pink snow mold (Micronectriella nivale), Typhula snow blight (Typhula sp.), loose smut (Ustilago tritici), bunt (Tilletia caries), eyespot (Pseudocercosporella herpotrichoides), leaf blotch (Mycosphaerella graminicola), glume blotch (Stagonospora nodorum), septoria, and yellow spot (Pyrenophora tritici-repentis).

Diseases of barley: powdery mildew (Erysiphe graminis), Fusarium head blight (Fusarium graminearum, F. avenacerum, F. culmorum, Microdochium nivale), rust (Puccinia striiformis, P. graminis, P. hordei), loose smut (Ustilago nuda), scald (Rhynchosporium secalis), net blotch (Pyrenophora teres), spot blotch (Cochliobolus sativus), leaf stripe (Pyrenophora graminea), and Rhizoctonia damping-off (Rhizoctonia solani).

Diseases in corn: smut (Ustilago maydis), brown spot (Cochliobolus heterostrophus), copper spot (Gloeocercospora sorghi), southern rust (Puccinia polysora), gray leaf spot (Cercospora zeae-maydis), white spot (Phaeosphaeria mydis and/or Pantoea ananatis) and Rhizoctonia damping-off (Rhizoctonia solani).

Diseases of citrus: melanose (Diaporthe citri), scab (Elsinoe fawcetti), penicillium rot (Penicillium digitatum, P. italicum), and brown rot (Phytophthora parasitica, Phytophthora citrophthora).

Diseases of apple: blossom blight (Monilinia mali), canker (Valsa ceratosperma), powdery mildew (Podosphaera leucotricha), Alternaria leaf spot (Alternaria alternata apple pathotype), scab (Venturia inaequalis), powdery mildew, bitter rot (Colletotrichum acutatum), crown rot (Phytophtora cactorum), blotch (Diplocarpon mali), and ring rot (Botryosphaeria berengeriana).

Diseases of pear: scab (Venturia nashicola, V. pirina), powdery mildew, black spot (Alternaria alternata Japanese pear pathotype), rust (Gymnosporangium haraeanum), and phytophthora fruit rot (Phytophtora cactorum).

Diseases of peach: brown rot (Monilinia fructicola), powdery mildew, scab (Cladosporium carpophilum), and phomopsis rot (Phomopsis sp.).

Diseases of grape: anthracnose (Elsinoe ampelina), ripe rot (Glomerella cingulata), powdery mildew (Uncinula necator), rust (Phakopsora ampelopsidis), black rot (Guignardia bidwellii), botrytis, and downy mildew (Plasmopara viticola).

Diseases of Japanese persimmon: anthracnose (Gloeosporium kaki), and leaf spot (Cercospora kaki, Mycosphaerella nawae).

Diseases of gourd: anthracnose (Colletotrichum lagenarium), powdery mildew (Sphaerotheca fuliginea), gummy stem blight (Mycosphaerella melonis), Fusarium wilt (Fusarium oxysporum), downy mildew (Pseudoperonospora cubensis), Phytophthora rot (Phytophthora sp.), and damping-off (Pythium sp).

Diseases of tomato: early blight (Alternaria solani), leaf mold (Cladosporium fulvum), and late blight (Phytophthora infestans).

Diseases of eggplant: brown spot (Phomopsis vexans), and powdery mildew (Erysiphe cichoracearum) Diseases of cruciferous vegetables: Alternaria leaf spot (Alternaria japonica), white spot (Cercosporella brassicae), clubroot (Plasmodiophora brassicae), and downy mildew (Peronospora parasitica).

Diseases of onion: rust (Puccinia allii), and downy mildew (Peronospora destructor).

Diseases of soybean: purple seed stain (Cercospora kikuchii), sphaceloma scad (Elsinoe glycines), pod and stem blight (Diaporthe phaseolorum var. sojae), septoria brown spot (Septoria glycines), frogeye leaf spot (Cercospora sojina), rust (Phakopsora pachyrhizi), Yellow rust, brown stem rot (Phytophthora sojae), and Rhizoctonia damping-off (Rhizoctonia solani).

Diseases of kidney bean: anthracnose (Colletotrichum lindemthianum). Diseases of peanut: leaf spot (Cercospora personata), brown leaf spot (Cercospora arachidicola) and southern blight (Sclerotium rolfsii).

Diseases of garden pea: powdery mildew (Erysiphe pisi), and root rot (Fusarium solani f. sp. pisi).

Diseases of potato: early blight (Alternaria solani), late blight (Phytophthora infestans), pink rot (Phytophthora erythroseptica), and powdery scab (Spongospora subterranean f. sp. subterranea).

Diseases of strawberry: powdery mildew (Sphaerotheca humuli), and anthracnose (Glomerella cingulata).

Diseases of tea: net blister blight (Exobasidium reticulatum), white scab (Elsinoe leucospila), gray blight (Pestalotiopsis sp.), and anthracnose (Colletotrichum theae-sinensis).

Diseases of tobacco: brown spot (Alternaria longipes), powdery mildew (Erysiphe cichoracearum), anthracnose (Colletotrichum tabacum), downy mildew (Peronospora tabacina), and black shank (Phytophthora nicotianae).

Diseases of rapeseed: sclerotinia rot (Sclerotinia sclerotiorum), and Rhizoctonia damping-off (Rhizoctonia solani). Diseases of cotton: Rhizoctonia damping-off (Rhizoctonia solani).

Diseases of sugar beat: Cercospora leaf spot (Cercospora beticola), leaf blight (Thanatephorus cucumeris), Root rot (Thanatephorus cucumeris), and Aphanomyces root rot (Aphanomyces cochlioides).

Diseases of rose: black spot (Diplocarpon rosae), powdery mildew (Sphaerotheca pannosa), and downy mildew (Peronospora sparsa). Diseases of chrysanthemum and asteraceous plants: downy mildew (Bremia lactucae), leaf blight (Septoria chrysanthemi-indici), and white rust (Puccinia horiana).

Diseases of various groups: diseases caused by Pythium spp. (Pythium aphanidermatum, Pythium debarianum, Pythium graminicola, Pythium irregulare, Pythium ultimum), gray mold, (Botrytis cinerea), and Sclerotinia rot (Sclerotinia sclerotiorum).

Disease of Japanese radish: Alternaria leaf spot (Alternaria brassicicola).

Diseases of turfgrass: dollar spot (Sclerotinia homeocarpa), and brown patch and large patch (Rhizoctonia solani).

Disease of banana: Black sigatoka (Mycosphaerella fijiensis), Yellow sigatoka (Mycosphaerella musicola).

Disease of sunflower: downy mildew (Plasmopara halstedii).

Seed diseases or diseases in the early stages of the growth of various plants caused by Aspergillus spp., Penicillium spp., Fusarium spp., Gibberella spp., Tricoderma spp., Thielaviopsis spp., Rhizopus spp., Mucor spp., Corticium spp., Phoma spp., Rhizoctonia spp. and Diplodia spp.

Viral diseases of various plants mediated by Polymixa spp. or Olpidium spp. and so on.

The compositions of the present invention can be used in agricultural lands such as fields, paddy fields, lawns and orchards or in non-agricultural lands. The present invention may be used to control diseases in agricultural lands for cultivating the plants without any phytotoxicity to the plant.

Examples of the crops on which the present compositions may be used include but are not limited to corn, rice, wheat, barley, rye, oat, sorghum, cotton, soybean, peanut, buckwheat, beet, rapeseed, sunflower, sugar cane, tobacco, etc., vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc. , trees other than fruit trees, tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

In another aspect, the present invention provides a method of controlling fungi at a locus, said method comprising applying to the locus at which said fungal control is desired, a fungicidal combination comprising:
a) at least one azole fungicide, the azole fungicide being an imidazole fungicide or a triazole fungicide, wherein:
   said imidazole fungicide is selected from the group consisting of bifonazole, butoconazole, clotrimazole, econazole, fenticonazole, isoconazole, ketoconazole, luliconazole, miconazole, omoconazole, oxiconazole, sertaconazole, sulconazole and tioconazole;
   said triazole fungicide is selected from albaconazole, efinaconazole, epoxiconazole, fluconazole, isavuconazole, itraconazole, posaconazole, propiconazole, ravuconazole, terconazole, voriconazole, mefentrifluconazole and Ipfentrifluconazole;
   and
b) at least one multisite contact fungicide; and
c) at least a third systemic fungicide.

The combinations of the present invention may be sold as a pre-mix composition or a kit of parts such that individual actives may be mixed before spraying. Alternatively, the kit of parts may contain an azole fungicide and the dithiocarbamate fungicide pre-mixed and the third active may be admixed with an adjuvant such that the two components may be tank mixed before spraying.

In an embodiment the present invention may provide a kit-of-parts comprising:
a) a first container comprising fluconazole;
b) a second container comprising a multisite contact fungicide;
c) a third container comprising a third systemic fungicide.
d) an instruction manual instructing user to admix the contents of three containers.

In an embodiment the present invention may provide a kit-of-parts comprising:
a) a first container comprising mefentrifluconazole;
b) a second container comprising a multisite contact fungicide;
c) a third container comprising a third systemic fungicide.
d) an instruction manual instructing user to admix the contents of three containers.

In an embodiment the present invention may provide a kit-of-parts comprising:
a) a first container comprising Ipfentrifluconazole;
b) a second container comprising a multisite contact fungicide;
c) a third container comprising a third systemic fungicide.
d) an instruction manual instructing user to admix the contents of three containers.

The composition of the present invention maybe applied simultaneously as a tank mix or a formulation or may be applied sequentially. The application may be made to the soil before emergence of the plants, either pre-planting or post-planting. The application may be made as a foliar spray at different timings during crop development, with either one or two applications early or late post-emergence.

The compositions according to the invention can be applied before or after infection of the useful plants or the propagation material thereof by the fungi.

As will be demonstrated in the examples, the addition of a dithiocarbamate fungicide to a combination of azole fungicide with the third systemic fungicide greatly improved the disease control as well as improved yield and demonstrated a synergistic effect. The lower the mixture performance in the disease control, the greater the additional benefit of the multisite contact fungicide when added to the combinations and compositions of the present invention.

The instant invention is more specifically explained by examples given above. However, it should be understood that the scope of the present invention is not limited by the examples in any manner. It will be appreciated by any person skilled in this art that the present invention includes the given examples and further can be modified and altered without departing from the novel teachings and advantages of the invention which are intended to be included within the scope of the invention.

The inventors conducted invitro test to test the bioefficacy and comparative performance of fluconazole and its combinations with different active ingredients.

Method of Preparation:
Various Fungal strains were isolated from severely infected plants in the field. The pathogen was sub-cultured and pure isolate was stored in incubator at 26±2 oC till its use for the experiment.
Potato Dextrose Agar (PDA) (Hi-Media) was used in the experiment as nutrient culture media for growth of the fungus.
As per dose calculation, treatments stock solutions of fluconazole alone and with different a.i. combinations and solo were prepared freshly in 100 ml glass bottle on the day of testing.
PDA medium was prepared aseptically in 250 ml conical flask (Borosil) and added with specific concentrations of different stock solutions before it is solidified (at 55° c).
Flasks were then horizontally swirled gently for proper homogenisation of treatment solution in culture media. Poisoned culture media (culture media+active ingredient solution) is ready to test further.
Petri-plates were labelled as per treatment codes and repeated in triplicates.
The poisoned medium was poured into 90 mm petri-plates uniformly with approximately 20 ml volume/plate. Poured plates were kept till poisoned media solidifies.
Mycelial discs were punched on pre-grown pathogen (4 days old) using 6 mm sterilised cork borer.
Petri-plates with solidified poisoned media were inoculated with the punched out mycelial disc keeping it at the centre upside down (mycelia touching the media).
Inoculated Petri-plates were incubated at 26±2 oC laying upside down.
At the full growth of control plates (90 mm) the growth of mycelium (in cm) was measured twice as horizontal and vertical diameter.
Percent inhibition of mycelial growth over control was calculated using the following formula.

$$Percent inhibition over control = \frac{( Dc - Dt )}{Dc} \times 100$$

Where,
Dc=Average diameter of fungal growth in control.
Dt=Average diameter of fungal growth in treatment.
   Synergy of combinations were calculated as per colby's formula.

### EXAMPLE 1

### In-Vitro Bio-Efficacy of Fluconazole Alone and Mixed with Other Active Ingredients Against Alternaria Solani of Tomato

| | | Pooled | | | | |
|---|---|---|---|---|---|---|
| | | Mean | Inhibition | | | |
| | | Colony | over | | | |
| | | diameter | control | | Observed - | |
| Treatment | Treatments details | (cm) | (%) | Expected | Expected | Conclusion |
| T1 | Fluconazole 60% WG | 0.6 | 93.3 | | | |
| | (100) | | | | | |
| T2 | Azoxystrobin 23% SC | 6.5 | 28.1 | | | |
| | (57.5) | | | | | |
| T3 | Boscalid 50% WG | 3.1 | 66.1 | | | |
| | (100) | | | | | |
| T4 | Chlorothalonil 72% | 3.9 | 57.2 | | | |
| | SC (600) | | | | | |
| T5 | Fluconazole 60% | 0 | 100 | 97 | 3 | Synergistic |
| | WG + Chlorothalonil | | | | | |
| | 72% SC (200 + 1200) | | | | | |
| T6 | Fluconazole 60% WG + | 0 | 100 | 97.7 | 2.3 | Synergistic |
| | Boscalid 50% WG | | | | | |
| | (200 + 200) | | | | | |
| T7 | Fluconazole 60% WG + | 0.2 | 97.6 | 95 | 2.6 | Synergistic |
| | Azoxystrobin 23% SC | | | | | |
| | (200 + 230) | | | | | |
| T8 | Fluconazole 60% WG + | 0 | 100 | 95.1 | 4.9 | Synergistic |
| | Azoxystrobin 23% SC | | | | | |
| | (200 + 230) | | | | | |
| T9 | Fluconazole 60% WG + | 0 | 100 | | | Synergistic |
| | Chlorothalonil 72% SC + | | | | | |
| | Azoxystrobin 50% WG | | | | | |
| | (200 + 1200 + 230) | | | | | |
| T10 | Fluconazole 60% WG + | 0 | 100 | | | Synergistic |
| | Chlorothalonil 72% SC + | | | | | |
| | Boscalid 23% SC (200 + | | | | | |
| | 1200 + 100) | | | | | |
| T11 | Sterile Distilled water | 9.0 | 0.0 | | | |

### EXAMPLE 2

### In Vitro Bio-Efficacy of Fluconazole Alone and Mixed with Other Active Ingredients Against Colletotrichum Capsici of Chilli

| | | Pooled | | | | |
|---|---|---|---|---|---|---|
| | | Mean | Inhibition | | | |
| | | Colony | over | | | |
| | | diameter | control | | Observed - | |
| Treatment. | Treatments* | (cm) | (%) | Expected | Expected | Conclusion |
| T1 | Fluconazole 60% WG | 6.8 | 24.4 | | | |
| | (50) | | | | | |
| T2 | Boscalid 50% WG (50) | 5.9 | 34.1 | | | |
| T3 | Chlorothalonil 72% SC | 5.6 | 37.6 | | | |
| | (300) | | | | | |
| T4 | Fluconazole 60% WG + | 2.2 | 75.4 | 52.2 | 23.2 | Synergistic |
| | Chlorothalonil 72% SC | | | | | |
| | (100 + 600) | | | | | |
| T5 | Fluconazole 60% WG + | 2.6 | 71.1 | 52.2 | 18.9 | Synergistic |
| | Chlorothalonil 72% SC | | | | | |
| | (200 + 1200) | | | | | |
| T6 | Fluconazole 60% WG + | 1.8 | 79.6 | 50.1 | 29.5 | Synergistic |
| | Boscalid 50% WG | | | | | |
| | (200 + 200) | | | | | |
| T7 | Fluconazole 60% WG + | 2.4 | 73.9 | 50.1 | 23.8 | Synergistic |
| | Boscalid 50% WG | | | | | |
| | (200 + 200) | | | | | |
| T8 | Fluconazole 60% WG + | 1.5 | 83.0 | | | Synergistic |
| | Mancozeb 75% WG + | | | | | |
| | Boscalid 50% WG | | | | | |
| | (50 + 375 + 50) | | | | | |
| T9 | Fluconazole 60% WG + | 1.3 | 86.1 | | | Synergistic |
| | Mancozeb 75% WG + | | | | | |
| | Boscalid 50% WG | | | | | |
| | (100 + 750 + 100) | | | | | |
| T10 | Fluconazole 60% WG + | 0.0 | 100.0 | | | Synergistic |
| | Mancozeb 75% WG + | | | | | |
| | Boscalid 50% WG | | | | | |
| | (200 + 1500 + 200) | | | | | |
| T11 | Fluconazole 60% WG + | 0.0 | 100.0 | | | Synergistic |
| | Mancozeb 75% WG + | | | | | |
| | Prothioconazole 48% | | | | | |
| | SC (100 + 750 + 170) | | | | | |
| T11 | Sterile Distilled water | 9.0 | 0.0 | | | |

### EXAMPLE 3

### In Vitro Bio-Efficacy of Fluconazole Alone and Mixed with Other Active Ingredients Against Rhizoctonia Solani of Paddy

| | | Pooled | | | | |
|---|---|---|---|---|---|---|
| | | Mean | Inhibition | | | |
| | | Colony | over | | | |
| | | diameter | control | | Observed - | |
| Sr. No. | Treatments* | (cm) | (%) | Expected | Expected | Conclusion |
| T1 | Fluconazole 60% WG | 3.0 | 66.7 | | | |
| | (50) | | | | | |
| T2 | Azoxystrobin 23% SC | 8.0 | 11.7 | | | |
| | (57.5) | | | | | |
| T3 | Boscalid 50% WG | 2.1 | 76.9 | | | |
| | (50) | | | | | |
| T4 | Chlorothalonil 72% | 2.6 | 71.1 | | | |
| | SC (300) | | | | | |
| T5 | Fluconazole 60% WG + | 0.6 | 93.3 | 90.3 | 3 | Synergistic |
| | Chlorothalonil 72% SC | | | | | |
| | (100 + 600) | | | | | |
| T6 | Fluconazole 60% WG + | 0.6 | 93.3 | 92.3 | 1 | Synergistic |
| | Boscalid 50% WG | | | | | |
| | (200 + 200) | | | | | |
| T7 | Fluconazole 60% WG + | 1.2 | 86.9 | 70.5 | 16.4 | Synergistic |
| | Azoxystrobin 23% SC | | | | | |
| | (200 + 230) | | | | | |
| T8 | Fluconazole 60% WG + | 0.7 | 92.4 | 90.3 | 2.1 | Synergistic |
| | Chlorothalonil 72% SC | | | | | |
| | (200 + 1200) | | | | | |
| T9 | Fluconazole 60% WG + | 1.4 | 84.4 | 70.5 | 13.9 | Synergistic |
| | Azoxystrobin 23% SC | | | | | |
| | (200 + 230) | | | | | |
| T10 | Fluconazole 60% WG + | 1.4 | 84.1 | | | Synergistic |
| | Chlorothalonil 72% SC + | | | | | |
| | Azoxystrobin 23% SC | | | | | |
| | (50 + 300 + 57.5) | | | | | |
| T11 | Fluconazole 60% WG + | 0.6 | 93.1 | | | Synergistic |
| | Chlorothalonil 72% SC + | | | | | |
| | Azoxystrobin 23% SC | | | | | |
| | (100 + 600 + 115) | | | | | |
| T12 | Fluconazole 60% WG + | 0.0 | 100.0 | | | Synergistic |
| | Chlorothalonil 72% SC + | | | | | |
| | Azoxystrobin 23% SC | | | | | |
| | (200 + 1200 + 230) | | | | | |
| T13 | Fluconazole 60% WG + | 0.0 | 100.0 | | | Synergistic |
| | Mancozeb 75% WG + | | | | | |
| | Boscalid 50% WG | | | | | |
| | (50 + 375 + 50) | | | | | |
| T14 | Fluconazole 60% WG + | 0.0 | 100.0 | | | Synergistic |
| | Mancozeb 75% WG + | | | | | |
| | Boscalid 50% WG | | | | | |
| | (100 + 750 + 100) | | | | | |
| T15 | Sterile Distilled water | 9.0 | 0.0 | | | |

1. A fungicidal combination comprising:
a) at least one azole fungicide, the azole fungicide being an imidazole fungicide or a triazole fungicide, wherein:
said imidazole fungicide is selected from bifonazole, butoconazole, clotrimazole, econazole, fenticonazole, isoconazole, ketoconazole, luliconazole, miconazole, omoconazole, oxiconazole, sertaconazole, sulconazole, and tioconazole;
said triazole fungicide is selected from albaconazole, efinaconazole, epoxiconazole, fluconazole, isavuconazole, itraconazole, posaconazole, propiconazole, ravuconazole, terconazole, voriconazole, mefentrifluconazole, and ipfentrifluconazole;
b) at least one multisite contact fungicide; and
c) at least a third systemic fungicide.

2. The fungicidal combination as claimed in claim 1, wherein the azole fungicide is fluconazole, mefentrifluconazole, and ipfentrifluconazole.

3. The fungicidal combination as claimed in claim 1, wherein the multisite contact fungicide is selected from dithiocarbamates, phthalimides, chloronitriles, inorganic fungicides, sulfamides, bis-guanidines, triazines, quinones, quinoxalines, dicoarboxamides, and mixtures thereof.

4. The fungicidal combination as claimed in claim 3, wherein
the dithiocarbamate fungicide is asamobam, asomate, azithiram, carbamorph, cufraneb, cuprobam, disulfiram, ferbam, metam, nabam, tecoram, thiram, urbacide, ziram, dazomet, etem, milneb, mancopper, mancozeb, maneb, metiram, polycarbamate, propineb, or zineb;
the phthalimide fungicide is captan, captafol, or folpet;
the chloronitrile fungicide is chlorothalonil;
the sulfamide fungicide is dichlofluanid, or tolylfluanid,
the bis-euanidine fungicide is guazatine, or iminoctadine;
the triazine fungicide is anilazine;
the quinone fungicide is dithianon;
the quinoxaline fungicide is quinomethionate, or chlorquinox;
the dicarboxamide fungicide is fluoroimide; and
the inorganic fungicide is copper (II) hydroxide, copper oxychloride, copper (II) sulfate, basic copper sulfate, Bordeaux mixture, copper salicylate C₇H₄0₃.Cu, cuprous oxide CU₂O, or sulphur.

5. The fungicidal combination as claimed in claim 1, wherein the third systemic fungicide is a nucleic acid synthesis inhibitor, a cytoskeleton and motor protein inhibitor, an amino acid and protein synthesis inhibitor, a respiration process inhibitor, a signal transduction inhibitor, a lipid synthesis and membrane integrity distruptor, a sterol biosynthesis inhibitor, a melanin synthesis inhibitor, a cell wall biosynthesis inhibitor, a melanin synthesis inhibitor, a host plant defense inductors, a fungicide with unknown modes of action, a fungicide with no classification, an ergosterol biosynthesis inhibitors, a Quinone outside (Qo) inhibitor fungicide, or a biological fungicide with multiple mode of action.

6. The fungicidal combination as claimed in claim 5, wherein
the nucleic acid synthesis inhibitor fungicide is benalaxyl, benalaxyl-M (kiralaxyl), furalaxyl, metalaxyl, metalaxyl-M (mefenoxam), oxadixyl, ofurace, bupirimate, dimethirimol, ethirimol, hymexazole, octhilinone, or oxolinic acid;
the cytoskeleton and motor protein inhibitor is benomyl carbendazim, fuberidazole, thiabendazole, thiophanate, thiophanate-methyl, diethofencarb, zoxamide, ethaboxam, pencycuron, fluopicolide, or phenamacril;
the respiration process inhibitor fungicides is diflumetorim, tolfenpyrad, benodanil, flutolanil, mepronil, isofetamid, fluopyram, fenfuram, carboxin, oxycarboxin, thifluzamide, benzovindiflupyr, bixafen, fluindapyr, fluxapyroxad, furametpyr, inpyrfluxam, isopyrazam, penflufen, penthiopyrad, sedaxane, isoflucypram, pydiflumetofen, boscalid and pyraziflumid, azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, dimoxystrobin, fenaminostrobin, mctominostrobin, trifloxystrobin, famoxadone, fluoxastrobin, fenamidone, pyribencarb, famoxadone, fenamidone, pyribencarb, an N-methoxy-(phenyl-ethyl)-pyrazole-carboxamide, diflumetorim, cyazofamid, amisulbrom, fenpicoxamid binapacryl, meptyldinocap, dinocap, fluazinam, ferimzone, fentin acetate, fentin chloride, fentin hydroxide, silthiofam, or ametoctradin;
the amino acid and protein synthesis inhibitor fungicide is cyprodinil, mepanipyrim, pyrimethanil, blasticidin-S, kasugamycin, streptomycin, or oxytetracycline;
the signal transduction inhibitor fungicide is quinoxyfen, proquinazid, fenpiclonil, fludioxonil, chlozolinate, dimethachlone, iprodione, procvmidone, or vinclozolin;
the lipid synthesis and membrane integrity disruptor is edifenphos, iprobenfos, pyrazophos, isoprothiolane, biphenyl, chloroneb, dicloran, quintozene (PCNB), tecnazene (TCNB), tolclofos-methyl. etridiazole, iodocarb, propamocarb, or prothiocarb;
the sterol biosynthesis inhibitor is azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, metconazole, myclobutanil, penconazole, propiconazole, simeconazole, tebuconazole, tetraconazole, triadimefon, triadimenol, triticonazole, fenarimol, nuarimol imazalil, oxpoconazole, pefurazoate, prochloraz, triflumizole, aldimorph, dodemorph, fenpropimorph, tridemorph, fenpropidin, piperalin, spiroxamine, fenhexamid, fenpyrazamine, pyributicarb, naftifine, or terbinafine;
the cell wall biosynthesis inhibitor fungicide is polyoxin, dimethomorph, flumorph, pyrimorph, benthiavalicarb, iprovalicarb, valifenalate, or mandipropamid;
the melanin synthesis inhibitor fungicide is fthalide, pyroquilon, tricyclazole, carpropamid, diclocymet, fenoxanil, or tolprocarb
the host plant defense inductor fungicide is acibenzolar-S-methyl, probenazole, tiadinil, isotianil, or laminarin;
the fungicide with unknown mode of action is cymoxanil, foestyl-Al, phosphorous acid or a salt thereof, teclofthalam, triazoxide, flusulfamide, diclomezine, methasulfocarb, cyflufenamid, metrafenone, pyriofenone, dodine, flutianil, ferimzone, oxathiapiprolin, tebufloquin, picarbutrazox, validamycin, mineral oil, organic oils, or potassium bicarbonate;
the ergosterol biosynthesis inhibitor is prothioconazole, tebuconazole, hexaconazole, cyroconazole, or epoxiconazole; and
the Quinone outside (Qo) inhibitor fungicide is azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, dimoxystrobin, fenaminostrobin, metominostrobin, trifloxystrobin, famoxadone, fluoxastrobin, fenamidone, or pyribencarb.

7. The fungicidal combination as claimed in claim 1, wherein fluconazole, the multi-site fungicide and the third fungicide are present in a ratio of (1-80):(1-80):(1-80).

8. A fungicidal composition comprising:
a. at least one azole fungicide, the azole fungicide being an imidazole fungicide or a triazole fungicide, wherein:
said imidazole fungicide is selected from bifonazole, butoconazole, clotrimazole, econazole, fenticonazole, isoconazole, ketoconazole, luliconazole, miconazole, omoconazole, oxiconazole, sertaconazole, sulconazole, and tioconazole;
said triazole fungicide is selected from albaconazole, efinaconazole, epoxiconazole, fluconazole, isavuconazole, itraconazole, posaconazole, propiconazole, ravuconazole, terconazole, voriconazole mefentrifluconazole, and ipfentrifluconazole;
b. at least one multisite contact fungicide; and
c. at least a third systemic fungicide.

9. The fungicidal composition as claimed in claim 8, wherein the multisite contact fungicide is selected from dithiocarbamates, phthalimides, chloronitriles, inorganic fungicides, sulfamides, bis-guanidines, triazines, quinones, quinoxalines, dicoarboxamides, and mixtures thereof.

10. The fungicidal composition as claimed in claim 9, wherein
the dithiocarbamate fungicide is asamobam, asomate, azithiram, carbamorph, cufraneb, cuprobam, disulfiram, ferbam, metam, nabam, tecoram, thiram, or urbacide, ziram, dazomet, etem, milneb, mancopper, mancozeb, maneb, metiram, polycarbamate, propineb, or zineb;
the phthalimide fungicide is captan, captafol, or folpet;
the chloronitrile fungicide is chlorothalonil;
the sulfamide fungicide is dichlofluanid, or tolylfluanid;
the bis-guanidine fungicide is guazatine, or iminoctadine;
the triazine fungicide is anilazine;
the quinone fungicide is dithianon;
the quinoxaline fungicide is quinomethionate, or chlorquinox;
the dicarboxamide fungicide is fluoroimide; and
the inorganic fungicide is copper (II) hydroxide, copper oxychloride, copper (II) sulfate, basic copper sulfate, Bordeaux mixture, copper salicylate C₇H₄0₃.Cu, cuprous oxide CU₂O, or sulphur.

11. The fungicidal composition as claimed in claim 8, wherein third systemic fungicide is selected from a nucleic acid synthesis inhibitor, a cytoskeleton and motor protein inhibitor, an amino acids and protein synthesis inhibitor, a respiration process inhibitor, a signal transduction inhibitor, a lipid synthesis and membrane integrity disruptor, a sterol biosynthesis inhibitor, a melanin synthesis inhibitor, a cell wall biosynthesis inhibitor, a host plant defense inductor, a fungicides with unknown modes of action, a fungicide with no classification, an ergosterol biosynthesis inhibitors, a Quinone outside (Qo) inhibitor fungicide, or a biological with multiple mode of action.

12. The fungicidal composition as claimed in claim 11, wherein
the nucleic acid synthesis inhibitor fungicide is benalaxyl, benalaxyl-M (kiralaxyl), furalaxyl, metalaxyl, metalaxyl-M (mefenoxam), oxadixyl, ofurace, bupirimate, dimethirimol, ethirimol, hymexazole, octhilinone, or oxolinic acid;
the cytoskeleton and motor protein inhibitor is benomyl, carbendazim, fuberidazole, thiabendazole, thiophanate, thiophanate-methyl, diethofencarb, zoxamide, ethaboxam, pencycuron, fluopicolide, or phenamacril;
the respiration process inhibitor fungicide is diflumetorim, tolfenpyrad, benodanil, flutolanil, mepronil, isofetamid, fluopyram, fenfuram, carboxin, oxycarboxin, thifluzamide, benzovindiflupyr, bixafen, fluindapyr, fluxapyroxad, furametpyr, inpyrfluxam, isopyrazam, penflufen, penthiopyrad, sedaxane, isoflucypram, pydiflumetofen, boscalid and pyraziflumid; azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, dimoxystrobin, fenaminostrobin, mctominostrobin, trifloxystrobin, famoxadone, fluoxastrobin, fenamidone, pyribencarb, famoxadone, fenamidone, pyribencarb, an N-methoxy-(phenyl-ethyl)-pyrazole-carboxamide, diflumetorim, cyazofamid, amisulbrom, fenpicoxamid, binapacryl, meptyldinocap, dinocap, 2 fluazinam, ferimzone, fentin acetate, fentin chloride, fentin hydroxide, silthiofam, or ametoctradin;
the amino acid and protein synthesis inhibitor fungicide is cyprodinil, mepanipyrim, pyrimethanil, blasticidin-S, kasugamycin, streptomycin, or oxytetracycline;
the signal transduction inhibitor fungicide is quinoxyfen, proquinazid, fenpiclonil, fludioxonil, chlozolinate, dimethachlone, iprodione, procymidone, or vinclozolin;
the lipid synthesis and membrane integrity disruptoris edifenphos, iprobenfos, pyrazophos, isoprothiolane, biphenyl, chloroneb, dicloran, quintozene (PCNB), tecnazene (TCNB), tolclofos-methyl etridiazole, iodocarb, propamocarb, or;
the sterol biosynthesis inhibitor is azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, Ipconazole, metconazole, myclobutanil, penconazole, Propiconazole, simeconazole, tebuconazole, tetraconazole, triadimefon, triadimenol, triticonazole, prothioconazole, triforine, pyrifenox, pyrisoxazole, fenarimol, nuarimol, imazalil, oxpoconazole, pefurazoate, prochloraz, triflumizole, aldimorph, dodemorph, fenpropimorph, tridemorph, fenpropidin, piperalin, spiroxamine, fenhexamid, fenpyrazamine, pyributicarb, naftifine, or terbinafine;
the cell wall biosynthesis inhibitor fungicide is polyoxin, dimethomorph, flumorph, pyrimorph, benthiavalicarb, iprovalicarb, valifenalate, or mandipropamid;
the melanin synthesis inhibitor fungicide is fthalide, pyroquilon, tricyclazole, carpropamid, diclocymet, fenoxanil, tolprocarb;
the host plant defence inductors fungicide is acibenzolar-S-methyl, probenazole, tiadinil, isotianil, or laminarin;
the fungicide with unknown mode of action is cymoxanil, foestyl-Al, phosphorous acid or a salt thereof, teclofthalam, triazoxide, flusulfamide, diclomezine, methasulfocarb, cyflufenamid, metrafenone, pyriofenone, dodine, flutianil, ferimzone, oxathiapiprolin, tebufloquin, picarbutrazox, validamycin, mineral oil, organic oil, or potassium bicarbonate;
the ergosterol biosynthesis inhibitor is prothioconazole, tebuconazole, hexaconazole, cyroconazole, or epoxiconazole;
the Quinone outside (Qo) inhibitor fungicide is azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, dimoxystrobin, fenaminostrobin, metominostrobin, trifloxystrobin, famoxadone, fluoxastrobin, fcnamidone, or pyribencarb.

13. A fungicidal composition comprising:
(a) fluconazole, mefentrifluconazole, or ipfentrifluconazole;
(b) at least one multisite contact fungicide;
(c) at least a third systemic fungicide; and
(d) at least one agrochemically acceptable excipient.

14. (canceled)

15. (canceled)

16. A method of controlling fungi at a locus, wherein said method comprises applying to the locus, the fungicidal combination of claim 1.

17. A kit-of-parts comprising:
(a) a first container comprising fluconazole, mefentrifluconazole, or ipfentrifluconazole;
(b) a second container comprising a multisite contact fungicide;
(c) a third container comprising a third systemic fungicide; and
(d) an instruction manual instructing user to admix the contents of three containers.

18. (canceled)

19. (canceled)

20. A fungicidal combination comprising
a) fluconazole, mefentrifluconazole, or ipfentrifluconazole;
b) at least one multisite contact fungicide, said multi-site fungicide being selected from the group consisting of dithiocarbamates, phthalimides, chloronitriles, inorganic fungicides, sulfamides, bis-guanidines, triazines, quinones, quinoxalines, dicoarboxamides, and mixtures thereof, wherein:
the dithiocarbamate fungicide is asamobam, asomate, azithiram, carbamorph, cufraneb, cuprobam, disulfiram, ferbam, metam, nabam, tecoram, thiram, urbacide, ziram, dazomet, etem, milneb, mancopper, mancozeb, maneb, metiram, polycarbamate, propineb, or zineb;
the phthalimide fungicide is captan, captafol, or folpet,
the chloronitrile fungicide is chlorothalonil;
the sulfamide fungicide is dichlofluanid or tolylfluanid;
the bis-guanidine fungicide is guazatine or iminoctadine;
the triazine fungicide is anilazine;
the quinone fungicide is dithianon;
the quinoxaline fungicide is quinomethionate or chlorquinox;
the dicarboxamide fungicide is fluoroimide;
the inorganic fungicide is copper (II) hydroxide, copper oxychloride, copper (II) sulfate, basic copper sulfate, Bordeaux mixture, copper salicylate C₇H₄0₃.Cu, cuprous oxide CU₂O, or
sulphur; and
c) at least a third systemic fungicide selected from a quinone outside inhibitor, a quinone inside inhibitor, a demthylation inhibitor, and a succinate dehydrogenase inhibitor; wherein:
(i) the quinone outside inhibitor is fenamidone, famoxadone, azoxystrobin, mandestrobin, coumoxystrobin, enoxastrobin, flufenoxystrobin, pyraoxystrobin, dimoxystrobin, enestrobin, fluoxastrobin, kresoxim-methyl, metominostrobin, orysastrobin, picoxystrobin, pyrametostrobin, triclopyricarb, fenaminstrobin, pyraclostrobin, or trifloxystrobin;
(ii) the demethylation inhibitor is triflumizole, triforine, pyridinitrile, pyrifenox, fenarimol, nuarimol, triarimol, climbazole, clotrimazole, imazalil, oxpoconazole, prochloraz, prochloraz-manganese, triflumizole, azaconazole, bitertanol, bromuconazole, cyproconazole, diclobutrazol, difenoconazole, diniconazole, diniconazole-M, epoxiconazole, etaconazole, fenbuconazole, fluotrimazole, fluquinconazole, flusilazole, flutriafol, furconazole, furconazole-cis, hexaconazole, imibenconazole, ipconazole, metconazole, myclobutanil, pencoconazole, propiconazole, prothioconazole, quinconazole, simeconazole, tebuconazole, tetraconazole, mefentrifluconazole triadimefon, triadimenol, triticonazole, uniconazole, perfurazoate, or uniconazole-P;
(iii)the quinone inside inhibitor is cyazofamid, or amisulbrom; and
(iv)the a succinate dehydrogenase inhibitor is benodanil, flutolanil, mepronil, fluopyram, fenfuram, carboxin, oxycarboxin, thifluzamide, bixafen, fluxapyroxad, furametpyr, isopyrazam, penflufen, penthiopyrad, sedaxane, aminopyrifen, or boscalid.

21. (canceled)

22. (canceled)
